(19) United States
(12) Patent Application Publication
(10) Pub. No.: US 2026/0281087 A1
(43) Pub. Date: Sep. 17, 2026

(54) SYSTEM

(71) Applicant: SoftBank Group Corp., Tokyo (JP)

(72) Inventor: Kensuke NAGAI, Tokyo (JP)

(73) Assignee: SoftBank Group Corp., Tokyo (JP)

(21) Appl. No.: 19/553,555

(22) Filed: Mar. 2, 2026

Related U.S. Application Data
(60) Provisional application No. 63/769,975, filed on Mar. 11, 2025.

(51) Int. Cl. H04L 9/40; G06F 9/50; G06F 11/20; H04L 9/32

(52) U.S. Cl. CPC H04L 63/0428; G06F 9/5083; G06F 11/2025; H04L 9/321; G06F 2201/805

(57) ABSTRACT

A system includes a processor that is configured to implement a distributed network type artificial intelligence protocol in which each edge terminal functions as a node and is mutually connected, divide processing of a high-performance artificial intelligence into a plurality of smaller tasks and distribute the smaller tasks to a plurality of the nodes within a network, distribute the tasks efficiently to the nodes based on processing capabilities and load states of the nodes by executing a load balancing algorithm, aggregate results of the tasks processed by the nodes and generate a final output based on the aggregated results, ensure data security and privacy, and ensure availability of the network by providing redundancy and failover functionality.

### CROSS-REFERENCE TO RELATED APPLICATION

This application claims the benefit of U.S. Provisional Application No. 63/769,975, filed on Mar. 11, 2025, pursuant to 35 U.S.C. § 119 (e), the entire contents of which are incorporated herein by reference.

### BACKGROUND

### Technical Field

The present disclosure relates to a system.

### Related Art

Japanese Patent Application Laid-Open (JP-A) No. 2022-180282 discloses a persona chatbot control method executed by at least one processor. The method includes steps of: receiving a user utterance, adding the user utterance to a prompt including a description of a chatbot character and an associated instruction sentence, encoding the prompt, and inputting the encoded prompt to a language model to generate a chatbot utterance responding to the user utterance.

Conventional centralized artificial intelligence (AI) systems require large-scale, centralized computing resources, such as data centers or cloud servers, to execute high-performance AI models. As the number of users and AI requests increases globally, centralized architectures suffer from resource bottlenecks, increased latency, high communication costs, and a single point of failure. Consequently, it becomes difficult to provide high-performance AI functions simultaneously and stably to a large number of users, including users at the edge of the network.

In addition, in environments where a large number of heterogeneous edge terminals are deployed, such as mobile devices, IoT devices, and field sensors, conventional architectures do not effectively utilize the distributed processing capabilities of such terminals. As a result, valuable computational resources at the edge remain underutilized, while centralized servers become overloaded. This imbalance leads to degraded quality of service, delayed AI responses, and inefficient use of overall system resources.

Furthermore, the distribution of AI processing across multiple nodes introduces additional technical challenges related to task assignment, dynamic load balancing, result integration, and maintenance of security, privacy, and availability. Existing systems often lack mechanisms that can, in a unified manner, divide AI processing into appropriate granular tasks, distribute those tasks based on real-time resource states of nodes, integrate results efficiently, and at the same time ensure secure communication, data privacy, redundancy, and failover. Therefore, there is a need for a system that can reliably implement a distributed network type AI protocol while addressing these issues.

### SUMMARY

In order to solve the above-described problems, an aspect of the present invention provides a system comprising a processor, wherein the processor is configured to implement a distributed network type artificial intelligence protocol in which each edge terminal functions as a node and is mutually connected, to divide processing of a high-performance artificial intelligence into a plurality of smaller tasks and distribute the smaller tasks to a plurality of the nodes within a network, to distribute the tasks efficiently to the nodes based on processing capabilities and load states of the nodes by executing a load balancing algorithm, to aggregate results of the tasks processed by the nodes and generate a final output based on the aggregated results, to ensure data security and privacy, and to ensure availability of the network by providing redundancy and failover functionality.

In one embodiment, the processor is configured to assign to each node an Internet Protocol address and a port number for directly communicating with other nodes and establishing connections between the nodes, and to cause each node to periodically transmit a heartbeat message to perform liveness confirmation of the other nodes. As a result, a peer-to-peer type network is dynamically constructed and maintained, enabling each node to participate as an active processing entity while the overall network topology is monitored in real time.

In another embodiment, the processor is configured to analyze a computation graph of an artificial intelligence model, divide the processing into tasks based on dependencies in the computation graph, distribute the divided tasks to the nodes within the network using a task queue, and allow each node to acquire a task from the task queue when the node requests a task. In addition, the processor is configured to collect resource information including at least a CPU usage, a memory usage, and a network bandwidth of each node and distribute the tasks efficiently using at least one of a round-robin method and a resource-based scheduling algorithm. By these means, the system adaptively assigns tasks to heterogeneous nodes according to their current resource states, thereby improving utilization of distributed resources, reducing processing latency, and maintaining balanced load across the network while securing the integrity and availability of AI processing.

The term “system” refers to an arrangement of one or more hardware and/or software components that cooperate to perform the distributed artificial intelligence processing described in the claims.

The term “processor” refers to one or more processing units, such as a central processing unit (CPU), graphics processing unit (GPU), digital signal processor (DSP), microcontroller, or any combination thereof, that executes instructions to perform the functions recited in the claims.

The term “distributed network type artificial intelligence protocol” refers to a set of rules, procedures, and data formats that enable artificial intelligence processing to be divided, communicated, executed, and coordinated across a plurality of mutually connected nodes in a network.

The term “edge terminal” refers to a computing device located at or near the periphery of a network, such as a mobile device, IoT device, sensor node, or user terminal, that participates as a node in the distributed network and provides processing, communication, or storage capabilities.

The term “node” refers to a logical or physical entity in the network, including an edge terminal or other computing device, that has an assigned network address and participates in the distributed artificial intelligence processing by sending, receiving, and/or executing tasks. The term “mutually connected” refers to a state in which a plurality of nodes in the network are connected through one or more communication paths that enable direct or indirect exchange of data between the nodes.

The term “high-performance artificial intelligence” refers to an artificial intelligence model, algorithm, or processing workflow that requires substantial computational resources, such as deep neural networks, large language models, complex image recognition models, or multi-modal models.

The term “task” refers to a unit of artificial intelligence processing, including a portion of a computation graph, a processing job on a subset of input data, or any other discrete operation, that can be assigned to and executed by a node in the network.

The term “smaller task” refers to a subdivision of an overall artificial intelligence processing job, obtained by partitioning the job into finer-grained tasks that can be independently or semi-independently executed by different nodes.

The term “network” refers to a communication infrastructure, including wired or wireless links and associated protocols, that interconnects a plurality of nodes and allows exchange of control messages, task data, and result data among the nodes.

The term “load balancing algorithm” refers to one or more procedures executed by the processor to determine how tasks are assigned or redistributed among nodes based on metrics such as processing capability, current load, or resource usage of the nodes.

The term “processing capability” refers to a characteristic of a node indicating its ability to execute tasks, including but not limited to CPU performance, GPU performance, available memory, storage bandwidth, and other computational resources.

The term “load state” refers to a current utilization condition of resources of a node, including CPU usage, memory usage, network usage, task queue length, or other indicators of how heavily the node is currently loaded.

The term “aggregate results” refers to combine, merge, or otherwise integrate a plurality of partial results produced by different nodes into a consolidated result that corresponds to the overall artificial intelligence processing.

The term “final output” refers to an overall result of the artificial intelligence processing for a given request or job, obtained after aggregating and optionally post-processing the results of a plurality of tasks executed by the nodes.

The term “data security” refers to protection of data against unauthorized access, alteration, or destruction during storage, transmission, or processing within the system.

The term “privacy” refers to protection of information related to users, devices, or environments, including prevention of unauthorized disclosure or identification of sensitive data contained in inputs, intermediate data, or outputs of the artificial intelligence processing.

The term “availability” refers to a property of the system indicating that the network and its artificial intelligence functions remain accessible and operational for processing tasks, even when one or more nodes fail or become unreachable.

The term “redundancy” refers to replication or duplication of data, tasks, or functional components across multiple nodes so that a failure of one node does not cause loss of data or interruption of essential processing.

The term “failover functionality” refers to automatic or semi-automatic mechanisms by which tasks, data, or roles handled by a failed or unavailable node are transferred to one or more other nodes so that processing can continue with minimal interruption.

The term “Internet Protocol address” refers to a numerical label assigned to a node in accordance with an Internet Protocol (such as IPv4 or IPV6), which uniquely identifies the node within a network for communication purposes.

The term “port number” refers to a numerical identifier associated with a particular communication endpoint or service on a node, used together with an Internet Protocol address to distinguish multiple communication sessions on the same node.

The term “heartbeat message” refers to a periodic communication transmitted by a node to another node or a management entity to indicate that the transmitting node is active and reachable, thereby supporting liveness detection.

The term “liveness confirmation” refers to determining, based on reception or absence of heartbeat messages or similar signals, whether a particular node is currently active, functioning, and connected to the network.

The term “computation graph” refers to a directed graph representation of operations, layers, or functions in an artificial intelligence model, in which nodes represent computational operations and edges represent data dependencies between the operations.

The term “dependency” refers to a relationship between two or more operations or tasks in which one operation or task requires the output or completion of another operation or task before it can be executed correctly.

The term “task queue” refers to a data structure or logical component that stores multiple tasks in a waiting state and manages ordering, retrieval, and assignment of the tasks to nodes for execution.

The term “resource information” refers to data indicating current or historical usage or availability of resources of a node, including at least CPU usage, memory usage, and network bandwidth, and optionally including storage usage, battery level, or other metrics.

The term “CPU usage” refers to a measure of how much processing time or capacity of a central processing unit in a node is currently being consumed by executing tasks or processes.

The term “memory usage” refers to a measure of how much of the available system memory of a node is currently allocated or in use by executing tasks or processes.

The term “network bandwidth” refers to a measure of the data transmission capacity of a communication link or interface associated with a node, typically expressed as a rate of data transfer per unit time.

The term “round-robin method” refers to a task assignment strategy in which tasks are distributed sequentially and cyclically among a set of nodes, so that each node is selected in turn in a repeating order.

The term “resource-based scheduling algorithm” refers to a task assignment strategy in which tasks are distributed among nodes based on their resource information, such that nodes with more available resources are preferentially assigned more or larger tasks.

### BRIEF DESCRIPTION OF THE DRAWINGS

Exemplary embodiments of the present disclosure will be described in detail based on the following figures, wherein:

FIG. 1 is a schematic diagram illustrating an example of a configuration of a data processing system according to a first exemplary embodiment;

FIG. 2 is a schematic diagram illustrating an example of relevant functions of a data processing device and a smart device according to the first exemplary embodiment;

FIG. 3 is a schematic diagram illustrating an example of a configuration of a data processing system according to a second exemplary embodiment;

FIG. 4 is a schematic diagram illustrating an example of relevant functions of a data processing device and smart glasses according to the second exemplary embodiment;

FIG. 5 is a schematic diagram illustrating an example of a configuration of a data processing system according to a third exemplary embodiment;

FIG. 6 is a schematic diagram illustrating an example of relevant functions of a data processing device and a headset-type terminal according to the third exemplary embodiment;

FIG. 7 is a schematic diagram illustrating an example of a configuration of a data processing system according to a fourth exemplary embodiment;

FIG. 8 is a schematic diagram illustrating an example of relevant functions of a data processing device and a robot according to the fourth exemplary embodiment;

FIG. 9 illustrates an emotion map mapping plural emotions;

FIG. 10 illustrates an emotion map mapping plural emotions;

FIG. 11 is a sequence diagram showing the flow of data processing system processing in Example 1;

FIG. 12 is a sequence diagram showing the flow of data processing system processing in Application Example 1;

FIG. 13 is a sequence diagram showing the flow of data processing system processing in Example 2; and

FIG. 14 is a sequence diagram showing the flow of data processing system processing in Application Example 2.

### DETAILED DESCRIPTION

Description follows regarding an example of exemplary embodiments of a system according to technology disclosed herein, with reference to the appended drawings.

First, explanation follows regarding terminology employed in the following description.

In the following exemplary embodiments, a reference-numeral-appended processor (hereinafter simply referred to as “processor”) may be implemented by a single computation unit, and may be implemented by a combination of plural computation units. The processor may be implemented by a single type of computation unit, or may be implemented by a combination of plural types of computation units. Examples of computation unit include a central processing unit (CPU), a graphics processing unit (GPU), a general-purpose computing on graphics processing units (GPGPU), an accelerated processing unit (APU), and the like.

In the following exemplary embodiments, random access memory (RAM) appended with a reference numeral is memory temporarily stored with information, and is employed as working memory by a processor.

In the following exemplary embodiments, reference-numeral-appended storage is a single or plural non-volatile storage devices for storing various programs and various parameters and the like. Examples of non-volatile storage devices include flash memory (such as a solid state drive (SSD)), a magnetic disk (for example, a hard disk), magnetic tape, and the like.

In the following exemplary embodiments, a reference-numeral-appended communication interface (I/F) is an interface including a communication processor and an antenna or the like. The communication I/F has the role of communicating between plural computers. An example of a communication standard applied for the communication I/F is a wireless communication standard, such as a Fifth Generation Mobile Communication System (5G), Wi-Fi (registered trademark), Bluetooth (registered trademark), and the like.

In the following exemplary embodiments “A and/or B” has the same definition as “at least one out of A or B”. Namely, “A and/or B” may mean A alone, may mean B alone, or may mean a combination of A and B. Moreover, similar logic to “A and/or B” is applied when “and/or” is employed to link three or more items in the present specification.

### First Exemplary Embodiment

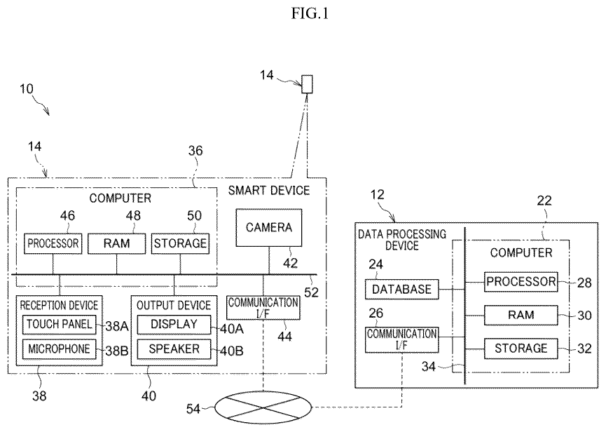

FIG. 1 illustrates an example of a configuration of a data processing system 10 according to a first exemplary embodiment.

As illustrated in FIG. 1, the data processing system 10 includes a data processing device 12 and a smart device 14. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart device 14 includes a computer 36, a reception device 38, an output device 40, a camera 42, and a communication I/F 44. The computer 36 includes a processor 46, RAM 48, and storage 50. The processor 46, the RAM 48, and the storage 50 are connected to a bus 52. The reception device 38, the output device 40, the camera 42, and the communication I/F 44 are also connected to the bus 52.

The reception device 38 includes a touch panel 38A, a microphone 38B, and the like for receiving user input. The touch panel 38A receives user input from contact of a pointer (for example, a pen, a finger, or the like) by detecting contact of the pointer. The microphone 38B receives spoken user input by detecting speech of the user. A control unit 46A in the processor 46 transmits data representing the user input received by the touch panel 38A and the microphone 38B to the data processing device 12. A specific processing unit 290 in the data processing device 12 acquires the data indicating the user input.

The output device 40 includes a display 40A, a speaker 40B, and the like for presenting data to a user 20 by outputting the data in an expression format perceivable by the user 20 (for example, audio and/or text). The display 40A displays visual information such as text, images, or the like under instruction from the processor 46. The speaker 40B outputs audio under instruction from the processor 46. The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like.

The communication I/F 44 is connected to the network 54. The communication I/F 44 and the communication I/F 26 perform the role of exchanging various information between the processor 46 and the processor 28 over the network 54.

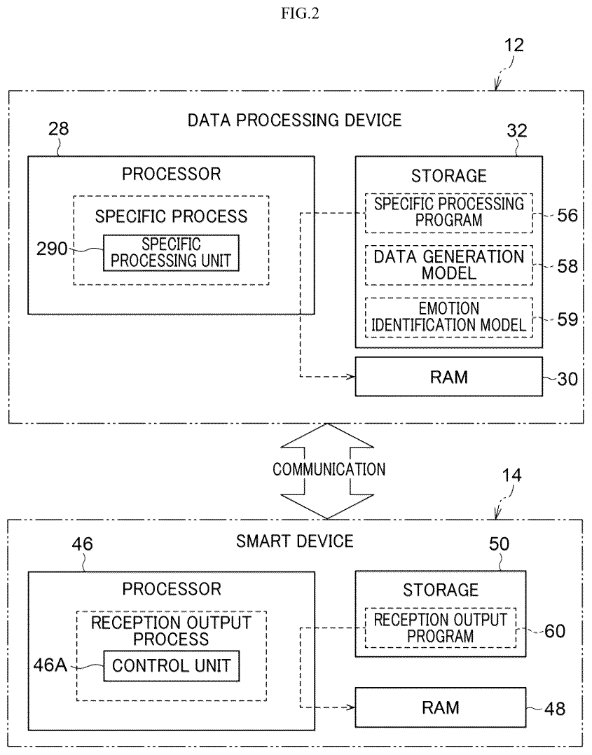

FIG. 2 illustrates an example of relevant functions of the data processing device 12 and the smart device 14.

As illustrated in FIG. 2, specific processing is performed by the processor 28 in the data processing device 12. A specific processing program 56 is stored in the storage 32. The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

A data generation model 58 and an emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart device 14. A reception and output program 60 is stored in the storage 50. The reception and output program 60 is employed by the data processing system 10 in combination with the specific processing program 56. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48. Note that a configuration may be adopted in which a similar data generation model and emotion identification model to the data generation model 58 and the emotion identification model 59 are included in the smart device 14, and these models are used to perform similar processing to the specific processing unit 290. The reception and output program is implemented by the processor 46 operating as the control unit 46A according to the reception and output program 60 executed in the RAM 48.

Note that devices other than the data processing device 12 may include the data generation model 58. For example, a server device (for example, a generation server) may include the data generation model 58. In such cases, the data processing device 12 performs communication with the server device including the data generation model 58 to obtain a processing result (prediction result or the like) obtained using the data generation model 58. The data processing device 12 may be a server device, and may be a terminal device owned by the user (for example, a mobile phone, a robot, a home electrical appliance, or the like). Next, description follows regarding an example of processing by the data processing system 10 according to the first exemplary embodiment.

### Example 1

Description follows regarding a flow of the specific processing in an Example 1. The units of the system described below are implemented by the data processing device 12 and the smart device 14. The data processing device 12 is called a “server” and the smart device 14 is called a “terminal”.

Conventional generative AI systems typically execute inference of large-scale models on centralized computing resources such as a single data center or a small number of server clusters. As a result, such systems suffer from several technical problems in terms of computer technology itself.

First, central servers become computational bottlenecks when many users concurrently submit prompt sentences and associated input data. Even if horizontal scaling is attempted, the scheduling unit is often an entire request, and the system cannot efficiently partition and distribute fine-grained portions of the computation graph or the input data. This leads to inefficient utilization of distributed computing resources and causes increased latency and degraded throughput.

Second, existing distributed processing frameworks often treat tasks as independent jobs, and do not tightly integrate prompt sentences, intermediate results, and generative model execution. In many cases, partial processing such as pre-processing, segmentation, or feature extraction is performed separately from the generative AI model, and the distributed environment is not aware of how intermediate information contributes to the final generation. Consequently, the system cannot offload parts of high-load generative computations to edge nodes in a controlled and model-aware manner, which results in suboptimal division of work and inefficient use of heterogeneous resources.

Third, resource-aware scheduling at the level of individual nodes is typically limited. Many systems rely on static configuration or simple round-robin assignment without dynamically considering real-time metrics such as computation resource usage, memory resource usage, remaining power, and communication quality. This lack of fine-grained, real-time load balancing causes performance degradation, especially when nodes have heterogeneous capabilities or fluctuating conditions, such as mobile or edge terminals.

Fourth, robustness and availability in the presence of node failures and network fluctuations are insufficient. When a node fails during execution of partial tasks, conventional systems often restart the entire job or lose intermediate results. There is no unified mechanism that tightly couples node liveness monitoring, redundancy of input and intermediate data, and failover reassignment of partially executed tasks, particularly in the context of generative AI workflows driven by prompt sentences.

Fifth, security and privacy in distributed generative AI processing remain challenging. Intermediate data, such as partial text, feature vectors, or detection results, must traverse multiple nodes. Existing approaches do not systematically integrate encryption, authentication, and integrity verification at the level of fine-grained tasks and partial results across heterogeneous network paths while still maintaining efficient scheduling and aggregation.

Sixth, interactivity and iterative refinement based on user prompt sentences are often implemented as independent requests and are not integrated with previously computed intermediate information. As a result, every refinement requires recomputation from raw input, increasing load on central servers and lengthening response time. The computer system lacks mechanisms to reuse integrated intermediate information or final outputs in a structured way as part of the generative pipeline.

Accordingly, there is a need for an improved computer-implemented technique and system architecture that (i) decomposes input data and computations for a generative AI model into partial tasks, (ii) distributes and executes these partial tasks across a plurality of heterogeneous nodes based on dynamic resource states, (iii) integrates partial results into intermediate information directly consumable by a generative AI model, (iv) enforces end-to-end security and availability for distributed processing, and (v) supports interactive refinement of generative outputs using prompt sentences while reusing intermediate results. The technical problem to be solved is to improve the underlying computer technology for distributed execution of generative AI models so as to increase throughput, reduce latency, enhance robustness, and improve utilization of heterogeneous networked computing resources.

The specific processing by the specific processing unit 290 of the data processing device 12 in Example 1 is realized by the following means.

The present invention provides a server comprising a processor configured to construct, on a distributed information processing network including a plurality of information processing devices, a communication topology in which each information processing terminal functions as a node and is mutually connected based on address information and connection information; to receive, from a user terminal, a processing request including a prompt sentence for a generative AI task, and to generate internal instruction information that defines a processing type and an output format on the basis of the prompt sentence and store the internal instruction information in association with the processing request; to analyze input information included in the processing request, to divide the input information into a plurality of information units according to a type and a scale of the input information, and to generate partial task information defining partial processing contents for each of the plurality of information units; to analyze a computational processing structure of a generative AI model, to generate the partial task information on the basis of processing dependency in the computational processing structure, to store the generated partial task information in a task storage region for distribution to the plurality of nodes in the distributed information processing network, and to cause the plurality of nodes to acquire the partial task information from the task storage region in response to acquisition requests from the plurality of nodes; to collect resource state information periodically transmitted from each node, to calculate, on the basis of the resource state information including computation resource usage, memory resource usage, power remaining amount, and communication quality, a load index for each node, to determine, according to the load index, an assignment number and a priority for the partial task information, and to dynamically assign the partial task information to the plurality of nodes by using at least one of a round-robin method and a resource-based allocation method; to receive partial result information generated by the plurality of nodes by executing computational processing corresponding to the partial task information on local information processing resources of the plurality of nodes, to collect the partial result information, to determine an integration order on the basis of order information or time information included in the partial result information, and to combine the partial result information according to the integration order to generate integrated intermediate information; to generate final-generation instruction information including contents of the prompt sentence, the output format, and constraint conditions on the basis of the prompt sentence and the integrated intermediate information, to input the final-generation instruction information into the generative AI model, and to cause the generative AI model to generate final output information composed of natural language information or structured information; to apply encryption processing and decryption processing to data and results that are distributed and processed among the plurality of nodes, to authenticate each node and each user terminal on the basis of authentication information, and thereby to ensure confidentiality and integrity of information on communication paths and in storage regions; to monitor states of the plurality of nodes and the communication topology, to detect a node failure on the basis of periodic status notification information or monitoring signals, to reassign the partial task information and the partial result information assigned to a failed node to another node, and to replicate and hold at least one of the input information and the integrated intermediate information in a plurality of nodes or a plurality of storage devices to provide redundancy and failover functionality; and to store the final output information in association with the processing request, to transmit the final output information to the user terminal, and, on the basis of an additional prompt sentence received from the user terminal, to reuse at least one of the integrated intermediate information and the final output information to perform at least one of regeneration processing and modified generation processing without additional input information. This enables improvement of computer technology by allowing fine-grained, resource-aware distribution and aggregation of generative AI computations across heterogeneous nodes, by reducing processing latency and central bottlenecks through model- and prompt-aware task partitioning, by increasing robustness via integrated redundancy and failover control, and by supporting interactive refinement of generative outputs while reusing intermediate computation results in a secure distributed environment.

The term “distributed information processing network” refers to a logical and physical interconnection of a plurality of information processing devices that are capable of exchanging data and control messages with one another over one or more communication paths.

The term “information processing device” refers to an apparatus including at least one processor and at least one memory configured to execute instructions for performing computational processing, data storage, and communication.

The term “information processing terminal” refers to an information processing device that operates as a node in the distributed information processing network and that executes at least part of a task assigned by a server or central controller.

The term “node” refers to a logical endpoint in the distributed information processing network that is associated with an information processing terminal and that can send, receive, and process data.

The term “communication topology” refers to a structure defining how nodes in the distributed information processing network are connected, including address relationships, routing paths, and connectivity patterns among the nodes.

The term “address information” refers to information, such as network addresses and port numbers, used to uniquely identify a node or endpoint within the distributed information processing network and to route communications thereto.

The term “connection information” refers to information describing how nodes establish and maintain communication sessions, including protocol parameters, routing data, and session identifiers.

The term “user terminal” refers to an information processing device operated by a user for submitting processing requests, prompt sentences, and input data to the server and for receiving output results.

The term “processing request” refers to a data structure or message sent from a user terminal to the server that specifies a task to be executed, and that includes at least a prompt sentence and associated input information.

The term “prompt sentence” refers to a natural language or structured instruction provided by a user that specifies or constrains behavior of a generative AI model, including requested content, style, or output format.

The term “internal instruction information” refers to data generated by the server from a processing request and the prompt sentence, specifying a normalized processing type, output format, and constraints used to control subsequent computation.

The term “input information” refers to data included in or referenced by a processing request, such as text data, image data, audio data, sensor data, or other machine-processable content to be processed by the system.

The term “information unit” refers to a portion of the input information obtained by partitioning the input information based on type, size, or other criteria for enabling fine-grained processing.

The term “partial task information” refers to a description of a subtask that specifies at least one information unit to be processed and a corresponding partial processing operation to be performed by a node.

The term “computational processing structure” refers to a representation of operations and dependencies within a generative AI model, such as a computation graph, indicating how data flows through the model's layers or components.

The term “processing dependency” refers to a relationship indicating that execution of a particular operation or partial task depends on a result of another operation or partial task.

The term “task storage region” refers to a logical or physical storage area, such as a memory or database, used to store partial task information until it is assigned to or retrieved by nodes.

The term “resource state information” refers to information periodically reported by each node indicating current usage and availability of computational resources, memory resources, power, and communication capacity.

The term “computation resource usage” refers to a measure of processing load on a node, such as utilization of a central processing unit, graphics processing unit, or other compute hardware.

The term “memory resource usage” refers to a measure of memory consumption on a node, such as the amount or percentage of volatile or nonvolatile memory currently in use.

The term “power remaining amount” refers to information representing remaining energy capacity of a node, such as battery level or residual power, relevant to deciding task assignment.

The term “communication quality” refers to metrics describing performance of a communication path to or from a node, including latency, bandwidth, packet loss, or error rate.

The term “load index” refers to a value or set of values computed from resource state information to quantitatively represent the current processing load or capacity of a node.

The term “round-robin method” refers to a task assignment method in which tasks are allocated to nodes in a repeating sequence without regard to prior history, thereby distributing tasks in a cyclic manner.

The term “resource-based allocation method” refers to a task assignment method in which tasks are allocated to nodes based on resource state information, such that nodes with greater available resources receive more tasks or higher-priority tasks.

The term “partial result information” refers to output data generated by a node as a result of executing a partial task, representing a partial computation result over at least one information unit.

The term “integration order” refers to an order determined for combining multiple pieces of partial result information, based on sequence identifiers, timestamps, or other ordering information.

The term “integrated intermediate information” refers to information obtained by merging or combining multiple pieces of partial result information into a single, coherent intermediate representation.

The term “final-generation instruction information” refers to data constructed from a prompt sentence and integrated intermediate information, specifying how the generative AI model is to generate final output, including content constraints and output format.

The term “generative AI model” refers to a machine learning model configured to generate output data such as natural language text, images, or structured information, based on input data and prompts.

The term “final output information” refers to information generated by the generative AI model in response to the final-generation instruction information, including natural language output or structured data that directly addresses the processing request.

The term “encryption processing” refers to processing that transforms plaintext data into ciphertext using a cryptographic algorithm and key so as to protect confidentiality of the data during storage or transmission.

The term “decryption processing” refers to processing that transforms ciphertext back into plaintext using a cryptographic algorithm and key so as to recover original data.

The term “authentication information” refers to data, such as credentials, certificates, or tokens, used to verify the identity of a node, user terminal, or other entity participating in communication.

The term “confidentiality” refers to a property that information is not made available or disclosed to unauthorized entities, processes, or devices.

The term “integrity” refers to a property that information is protected against unauthorized modification, insertion, or deletion during storage or transmission.

The term “status notification information” refers to information periodically transmitted from a node indicating operational state, including liveness, error state, or performance indicators.

The term “monitoring signal” refers to a signal, such as a heartbeat or health-check message, used to confirm liveness or operational status of a node or communication path.

The term “node failure” refers to a condition in which a node is determined to be non-operational or unable to correctly execute assigned partial tasks or communicate within the network.

The term “redundancy” refers to an arrangement in which the same data or capability is maintained in multiple nodes or storage devices so that operation can continue even when one element fails.

The term “failover functionality” refers to a capability of the system to automatically redirect tasks and data from a failed node or component to another node or component to maintain continuous processing.

The term “regeneration processing” refers to processing in which a generative AI model produces new output based on previously computed intermediate information or final output information in response to a new prompt sentence.

The term “modified generation processing” refers to processing in which a generative AI model adjusts or refines previously generated output based on an additional prompt sentence, without requiring recomputation from the original raw input information.

The term “interactive response” refers to an operation mode in which the system repeatedly accepts additional prompt sentences from a user and generates corresponding outputs while reusing intermediate information or prior outputs to support iterative refinement.

In one embodiment, a server, a plurality of terminals, and a user cooperate to implement a distributed system that executes a generative AI model based on a prompt sentence while improving utilization of heterogeneous computing resources and reducing central processing bottlenecks.

The server comprises at least one processor, at least one memory, and at least one network interface. The server is implemented, for example, on a rack-mounted general-purpose computer including a multi-core central processing unit, a graphics processing unit, magnetic or solid-state storage, and a network adapter connected to a packet-switched network. The server executes an operating system such as a general-purpose server operating system and middleware such as database software and message-queuing software. The server further executes a model execution runtime such as a tensor computation library and a generative AI inference engine.

The terminal comprises at least one processor, at least one memory, at least one local storage device, and at least one wireless or wired communication interface. The terminal is implemented, for example, on a mobile device, an embedded controller, an edge server, or a sensor gateway. The terminal executes an operating system such as a mobile operating system or an embedded operating system and includes a runtime environment capable of executing inference of a compact neural network model using a numerical computation library.

The user operates a user interface running on a user terminal. The user terminal can be implemented as a web browser or a dedicated application installed on a terminal. The user inputs a prompt sentence and input data through the user interface. For example, the user inputs one of the following prompt sentences:

“Please summarize this document in about 500 words focusing on key findings and recommendations.”

“Please describe the content of this image in detail.”

“Please convert this audio data into text and then list all action items with responsible persons.”

“Please analyze this sensor dataset and extract the main trends relevant to irrigation planning.”

The server receives the prompt sentence and associated input data from the user terminal via a network interface. The server stores the prompt sentence, input data, and metadata in a relational database or key-value store. The server converts the prompt sentence into internal instruction information by parsing the prompt sentence and mapping it to a normalized representation including fields such as task type, target modality, desired output length, and required output structure. This conversion is implemented by the server using a rule-based parser and optional lightweight text classification model. The rule-based parser uses a predefined grammar table and keyword lexicon to detect phrases indicating summarization, explanation, transcription, or analysis. The classification model is implemented as a small feed-forward neural network using word embeddings as input, and is trained with supervised learning on a labeled dataset of prompt sentences. The server stores the resulting internal instruction information together with a task identifier in a task table.

The server analyzes the input data according to the task type indicated by the internal instruction information. For text input, the server uses a tokenizer implemented in a natural language processing library to segment the text into tokens and to compute token counts. For image input, the server uses an image processing library to decode, resize, and optionally crop the image. For audio input, the server uses an audio processing library to resample the waveform, normalize amplitude, and compute basic features such as spectrogram segments if required. For sensor or tabular data, the server parses delimited records, converts timestamps to a canonical time representation, and normalizes units.

The server divides the input data into information units according to configurable size thresholds and constraints imposed by the generative AI model, such as a maximum number of tokens or pixels per partial inference. For text, the server divides a long document into contiguous segments each containing a fixed or adaptive number of tokens or sentences. For images, the server divides a high-resolution image into tiles arranged in a grid. For audio, the server divides a long waveform into successive overlapping or non-overlapping windows of predetermined duration. For sensor data, the server groups records by region, sensor type, or time window.

The server generates partial task information for each information unit. The partial task information includes a reference to the corresponding information unit, a description of the partial processing to be performed, and an identifier used to track results. The partial processing description is selected based on the internal instruction information and includes, for example, “partial summarization of this text segment,” “object detection on this image tile,” “speech recognition on this audio window,” or “statistical feature extraction for this sensor window.” The server stores the partial task information in a task storage region implemented as a database table or distributed queue.

The server analyzes a computational processing structure of a generative AI model used in the system. In one embodiment, the generative AI model is implemented as a transformer-based neural network having multiple self-attention layers, feed-forward layers, and embedding layers. The model accepts tokenized text and optional auxiliary features and generates token sequences representing natural language output. The server obtains a representation of the computation graph from the model runtime. The computation graph represents operations and data dependencies among layers and is used by the server to determine which portions of computation can be offloaded or approximated by partial tasks running on terminals.

The server, for example, configures the system so that terminals execute feature extraction or lower-layer sub-models while the server executes upper-layer decoding and generation. In one example, the server provides terminals with a reduced version of the generative AI model containing only a subset of layers or a distilled model trained to approximate the hidden representations produced by deeper layers. The server trains the reduced model using knowledge distillation: the server uses a training dataset of inputs and corresponding hidden states produced by the full generative AI model, and minimizes a loss function such as mean-squared error between the reduced model outputs and the full model hidden states. During training, the server updates weights of the reduced model using gradient descent with backpropagation, an optimizer such as Adam, and regularization such as dropout. The server stores the trained reduced model in a model registry accessible to terminals.

The server configures terminals to download and locally store the reduced model and to execute inference on information units assigned to them. The terminal receives partial task information and input data references. The terminal loads the reduced model into memory and runs forward propagation on input features computed from the information unit. For text, the terminal converts text segments into token IDs using a tokenizer and then computes hidden representations using the reduced transformer layers. For images, the terminal uses a convolutional or vision transformer sub-model to compute feature vectors or detection boxes. For audio, the terminal uses a recurrent or transformer-based acoustic model to compute phoneme probabilities or partial transcripts. For sensor data, the terminal uses a small neural network or statistical algorithm to compute feature vectors such as averages, variances, and trend slopes.

The terminal encapsulates the resulting feature vectors, partial summaries, detection results, or partial transcripts as partial result information. The terminal includes ordering metadata and confidence scores in the partial result information. The terminal transmits the partial result information to the server using an encrypted communication channel such as a transport-layer security protocol. The terminal uses a cryptographic library to perform encryption and decryption based on credentials provisioned by the server. This arrangement ensures that partial results and intermediate representations are protected from eavesdropping and tampering.

The server receives partial result information from multiple terminals, verifies message integrity by checking digital signatures or message authentication codes, and stores the verified partial result information in a result storage region. The server uses ordering metadata, sequence numbers, or timestamps to reconstruct the logical order of information units. The server merges partial result information into integrated intermediate information. For text-based tasks, the server concatenates partial summaries or hidden representations and, if necessary, adjusts boundaries to prevent semantic discontinuity. For image-based tasks, the server maps detection boxes or features from tile coordinate systems into global image coordinates and resolves overlapping detections via non-maximum suppression. For audio-based tasks, the server concatenates transcripts and aligns them by timestamps while correcting for overlaps. For sensor-based tasks, the server combines feature vectors from multiple windows into a time series or spatial map.

The server constructs final-generation instruction information by combining the original prompt sentence with the integrated intermediate information. The final-generation instruction information guides the generative AI model to perform higher-level generation using lower-level computations already distributed to terminals. For example, when the user submits a summarization prompt, the server constructs an instruction such as:

“Using the following partial summaries of document segments, generate a single coherent summary in about 500 words that focuses on key findings and recommendations. Partial summaries: [merged partial summaries].”

The server ensures that combined tokens of the instruction and integrated intermediate information fall within token limits of the generative AI model by optionally performing additional compression or summarization of partial results. The server then inputs the final-generation instruction information into the generative AI model and executes inference on the server's hardware accelerator. The generative AI model produces final output information such as a complete summary, a full image description, a list of action items derived from transcript, or an analytic narrative of sensor trends.

The server post-processes the final output information by performing tasks such as detokenization, punctuation normalization, language-specific formatting, and conversion to a structured representation when required. The server stores the final output information in association with the original processing request and returns it to the user terminal. The user reviews the result and may provide an additional prompt sentence that modifies or refines the previous instruction, such as:

“Please make the previous summary more concise and focus only on financial risks.”

The server receives the additional prompt sentence and uses it together with the integrated intermediate information or previously generated final output information to perform regeneration processing or modified generation processing without re-processing the raw input data. This reuse of intermediate representations achieves lower latency and reduces computational load, because the server and terminals avoid repeated execution of lower-level feature extraction and segmentation steps.

The server periodically receives resource state information from terminals. Each terminal monitors its own computation resource usage, memory resource usage, power remaining amount, and communication quality by reading system metrics provided by the operating system. The terminal encapsulates the metrics into resource state information and transmits the information securely to the server. The server uses these metrics to compute a load index for each terminal using a deterministic function or weighted score. The server updates assignment policies based on the load index, sending more partial tasks to terminals with higher available capacity and fewer partial tasks to terminals experiencing high load or low power. This dynamic, metric-based allocation improves overall throughput and reduces failure rates due to overload.

The server monitors node liveness using status notification information and monitoring signals such as heartbeat messages. If the server detects that a terminal is not responding or is exhibiting abnormal metrics, the server marks that node as failed or degraded. The server reassigns any pending partial tasks previously assigned to the failed node to other terminals.

The server also replicates important input information and integrated intermediate information across multiple nodes or storage devices. By maintaining redundant copies, the server prevents data loss and can continue processing even when one node or storage device fails. This failover functionality enhances system availability and ensures that generative workflows based on long-running or large-scale input data can complete reliably. The described architecture improves computer technology by introducing a model- and prompt-aware partitioning of computation and data. The server does not merely split tasks by user request boundaries but instead uses structural knowledge of the generative AI model and constraints of terminal resources to generate partial tasks. The offloading of layered or feature-level computation to terminals, combined with centralized generative decoding, reduces the amount of data transferred over the network because terminals return compact feature vectors or partial summaries instead of raw input data. This structure achieves reduced communication bandwidth consumption and improved end-to-end latency.

The server improves computation efficiency by performing dynamic load balancing using detailed resource state information rather than static or coarse-grained scheduling. The use of per-terminal power and communication metrics allows the server to avoid assigning high-load tasks to weak or unstable nodes, which reduces wasted computation and retries. This resource-aware scheduling, combined with intermediate result reuse, results in observable improvements in processing speed and responsiveness compared to a purely centralized or naïve distributed approach.

The generative AI model and reduced models deployed on terminals are implemented as specific neural network architectures with defined training procedures, loss functions, and optimization algorithms rather than as abstract “AI” components. The server configures embedding layers, multi-head attention layers, feed-forward networks, and normalization layers for the full generative AI model. The server trains the model offline using large datasets and loss functions such as cross-entropy for token prediction, optionally combined with auxiliary losses for alignment or consistency. The server trains reduced models using knowledge distillation by minimizing differences between hidden representations of reduced and full models. This explicit use of neural network architectures and training procedures provides a concrete, technical implementation rather than a generic abstract idea.

The terminals execute compact models or feature extractors that operate according to the same learned feature space as the full generative AI model. Terminals do not simulate human reasoning but instead perform transformations defined by trained numerical weights and deterministic activation functions. The combination of central and distributed computations follows algorithmic rules designed to minimize redundant computation and network traffic. For example, the system reuses partial results when a user issues a refinement prompt sentence, instead of re-reading and re-parsing the original data, thus reducing disk I/O and avoiding repeated decoding or feature extraction.

Alternative embodiments can be realized within the same general framework. In one embodiment, the server uses a convolution-based encoder on terminals for image tasks and a transformer-based decoder on the server. In another embodiment, the server uses a graph-based representation of nodes and constructs a scheduling policy using a reinforcement learning agent that maximizes throughput and minimizes latency. In yet another embodiment, terminals execute classical algorithms such as discrete Fourier transforms, wavelet transforms, or statistical filters, while the server applies the generative AI model to feature sequences derived from these operations. In each case, the fundamental mechanism remains: the server decomposes tasks into partial tasks guided by the structure of the generative AI model and the content of the prompt sentence, distributes computation to terminals in a resource-aware way, aggregates partial results into integrated intermediate information, and then executes final generative inference on the server.

By explicitly linking generative model structure, prompt-aware task definition, resource-aware scheduling, secured communication, and stateful reuse of intermediate results, the disclosed embodiments provide concrete improvements in computational efficiency, robustness, and scalability of distributed generative AI processing, beyond mere automation of human conceptual tasks.

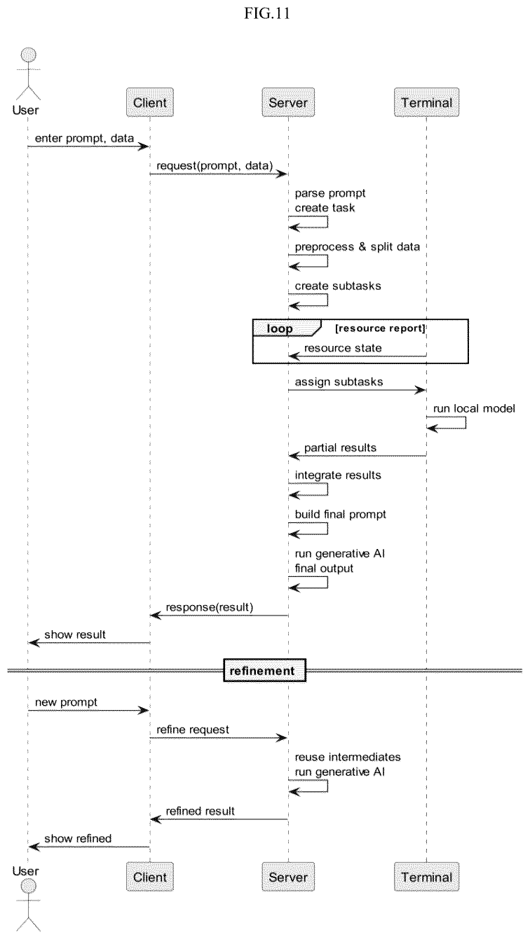

The following describes the processing flow using FIG. 11.

### Step 1:

User operates a user terminal to input a prompt sentence and select or upload input data.

User provides, as input, a natural language prompt sentence such as “Please summarize this document in about 500 words focusing on key findings and recommendations.” together with data such as a text file, an image file, an audio file, or a dataset.

User confirms task type (for example, summarization, image description, speech-to-text, trend analysis) via a graphical user interface.

User causes the user terminal to send an HTTP or HTTPS request including the prompt sentence, task type, and input data to the server.

The output of Step 1 is a network request containing the prompt sentence, input data, and metadata, transmitted from the user terminal to the server.

### Step 2:

Server receives the processing request and generates internal instruction information.

Server takes, as input, the network request including the prompt sentence, task type, and input data descriptors.

Server parses the prompt sentence using a rule-based parser and optionally a lightweight classifier to identify intent (for example, “summarize,” “describe,” “transcribe,” “analyze”) and output constraints (for example, output length, focus topics).

Server converts these findings into an internal instruction record that contains fields such as normalized task type, input modality, output structure, and priority level.

Server stores this internal instruction information in a database, associated with a unique task identifier.

The output of Step 2 is the internal instruction information and task identifier registered in persistent storage.

### Step 3:

Server preprocesses and segments the input data into information units.

Server receives, as input, the raw input data and the internal instruction information. Server determines preprocessing operations based on the input modality:
For text, server tokenizes the text, normalizes characters, and splits the text into segments of a defined token or sentence length.
For images, server decodes and resizes the image and divides it into tiles arranged in a grid.
For audio, server resamples the audio, normalizes amplitude, and splits the waveform into fixed-duration windows.
For sensor or tabular data, server parses records, converts timestamps, and groups data into time or spatial windows.

Server produces a set of information units, each with a unique identifier and a reference to a specific portion of the input.

The output of Step 3 is a collection of information units and associated metadata that represent partitioned input data ready for distributed processing.

### Step 4:

Server generates partial task information corresponding to each information unit.

Server takes, as input, the collection of information units and the internal instruction information.

Server creates, for each information unit, a partial task record that specifies:
the associated information unit identifier,
the required partial processing operation (for example, “partial summarization of segment,” “object detection on tile,” “speech recognition on window,” “feature extraction for data window”),
expected output type and format.

Server inserts these partial task records into a task storage region, such as a task queue or database table.

The output of Step 4 is a set of partial task records stored in the server's task storage region and linked to the original task identifier.

### Step 5:

Terminal periodically reports its resource state to the server.

Terminal uses, as input, local system metrics such as CPU utilization, memory usage, remaining battery level or power state, and network quality indicators.

Terminal reads these metrics via operating system APIs and aggregates them into a resource state message.

Terminal encrypts the resource state message using a secure communication protocol and transmits it to the server at defined intervals.

The output of Step 5 is a resource state message sent from each terminal to the server, providing up-to-date capacity information.

### Step 6:

Server performs load calculation and assigns partial tasks to terminals.

Server takes, as input, the partial task records stored in the task storage region and the resource state messages received from terminals.

Server computes, for each terminal, a load index by combining CPU usage, memory usage, remaining power, and communication quality using a weighted function.

Server selects eligible terminals and decides, based on the load index and scheduling policy (such as round-robin or resource-based allocation), which partial tasks to assign to which terminals.

Server updates each selected partial task record with an assigned terminal identifier and sends assignment messages to the corresponding terminals, including references to the information units.

The output of Step 6 is a set of assignment messages transmitted to terminals and updated partial task records indicating terminal assignments.

### Step 7:

Terminal receives assigned partial tasks and prepares local execution.

Terminal takes, as input, assignment messages specifying partial task identifiers, information unit references, and required processing types.

Terminal validates each assignment, checks model version requirements, and places each partial task into a local processing queue.

Terminal downloads or retrieves the associated information units if not already cached locally, optionally decrypting any encrypted data.

The output of Step 7 is a populated local processing queue on each terminal, containing ready-to-execute partial tasks and their input data.

### Step 8:

Terminal executes local feature extraction or partial inference using a compact model.

Terminal selects, as input, the next partial task from its local processing queue and the corresponding information unit data.

Terminal loads a compact model or feature extractor into memory, such as a distilled transformer, a convolutional network, or a statistical feature extractor trained by the server.

Terminal performs numerical computations defined by the model:
For text segments, terminal converts text to token IDs and runs forward passes through transformer layers to generate hidden state vectors or partial summaries.
For image tiles, terminal applies convolutional or attention layers to compute feature maps or detection bounding boxes.
For audio windows, terminal computes spectrograms and runs recurrent or attention layers to obtain phoneme scores or short transcripts.
For sensor windows, terminal calculates statistical features or passes numeric vectors through a small neural network to obtain feature embeddings.

Terminal aggregates computed values into partial result information that includes the partial task identifier, feature vectors or partial outputs, confidence scores, and ordering metadata. The output of Step 8 is a partial result information object generated on the terminal for each executed partial task.

### Step 9:

Terminal transmits partial result information securely to the server.

Terminal uses, as input, the partial result information and cryptographic credentials provisioned by the server.

Terminal serializes the partial result information into a structured format and computes integrity data such as a message authentication code.

Terminal establishes or reuses a secure communication session and sends the serialized partial result information to the server.

Terminal marks the partial task as completed in its local queue and may free associated resources.

The output of Step 9 is a set of partial result messages transmitted from terminals to the server.

### Step 10:

Server validates and stores partial result information from terminals.

Server receives, as input, the partial result messages and corresponding integrity data.

Server verifies message authenticity and integrity using cryptographic checks, such as verifying the message authentication code or digital signature.

Server writes validated partial result information to a result storage region, indexed by partial task identifier and original task identifier.

Server updates the status of each partial task record from “assigned” to “completed” or records failure information if validation fails.

The output of Step 10 is a collection of validated partial result records stored in the result storage region and updated task status information.

### Step 11:

Server integrates partial results into intermediate information.

Server takes, as input, all partial result records associated with a particular original task identifier.

Server sorts the partial results according to ordering metadata, such as segment indices, tile positions, or timestamps.

Server merges the sorted partial results:
For text-related tasks, server concatenates partial summaries or hidden state vectors and may compress redundant phrases.
For image-related tasks, server maps tile-based detections into global coordinates and reconciles overlaps.
For audio-related tasks, server concatenates segment transcripts and resolves boundary overlaps by timestamp.
For sensor-related tasks, server merges feature vectors into a time series or spatial grid representation.

Server produces integrated intermediate information that summarizes or encodes the entire input data in a compact structured form.

The output of Step 11 is integrated intermediate information stored in association with the original task.

### Step 12:

Server constructs final-generation instruction information based on the prompt sentence and intermediate information.

Server receives, as input, the original prompt sentence, the internal instruction information, and the integrated intermediate information.

Server builds a final instruction text or structure that embeds the integrated intermediate information into a new prompt suitable for the generative AI model.

For example, server generates an instruction such as:

“Using the following partial summaries of document segments, generate one coherent summary in about 500 words focusing on key findings and recommendations: [insert partial summaries].”

Server ensures that the combined tokens remain within model limits by applying truncation or secondary summarization if necessary.

The output of Step 12 is final-generation instruction information ready for inference by the generative AI model.

### Step 13:

Server executes the generative AI model to produce final output information.

Server takes, as input, the final-generation instruction information and a trained generative AI model residing on the server's accelerator hardware.

Server performs tokenization and encoding of the instruction, then runs forward propagation through neural network layers (embedding, attention, feed-forward, and output projection) according to learned weights.

Server iteratively generates output tokens using decoding algorithms such as greedy decoding, beam search, sampling with temperature, or top-k/top-p filtering, constrained by the instruction and task configuration.

Server accumulates the generated tokens and decodes them into natural language text or structured output (for example, a list of bullet points).

The output of Step 13 is final output information that directly addresses the user's original prompt sentence.

### Step 14:

Server post-processes and returns the final result to the user terminal.

Server uses, as input, the final output information and metadata about desired output structure.

Server applies formatting operations such as detokenization, whitespace normalization, language-specific punctuation handling, and conversion to structured formats if requested (for example, JSON with action items, tables of trends).

Server stores the final result in persistent storage associated with the original task identifier and may log performance metrics.

Server transmits the formatted final result to the user terminal via the previously established communication channel.

The output of Step 14 is a response message to the user terminal containing the completed result generated by the generative AI model.

### Step 15:

User views the final result and may issue an additional refinement prompt sentence.

User receives, as input, the displayed final result on the user terminal.

User evaluates whether the result satisfies the original intent and, if refinement is desired, enters a new prompt sentence such as “Please shorten the summary and focus only on financial risks.” or “Please add more detail about anomalies in the northern area.” User causes the user terminal to send a refinement request that includes the new prompt sentence and a reference to the previous task or result.

The output of Step 15 is a refinement request containing an additional prompt sentence linked to existing intermediate and final outputs.

### Step 16:

Server reuses intermediate information to perform regeneration or modified generation.

Server takes, as input, the refinement request, the additional prompt sentence, and stored integrated intermediate information and/or final output information from the earlier execution.

Server constructs updated final-generation instruction information that incorporates the new prompt sentence and references the stored intermediate content instead of the original raw data.

Server executes the generative AI model again with this updated instruction to generate a refined result.

Because the server and terminals do not repeat preprocessing, segmentation, or partial task execution, the amount of computation and data transfer is reduced.

The output of Step 16 is an updated final output information object that reflects the user's refinement request and is returned to the user terminal as a new result.

### Application Example 1

Description follows regarding a flow of the specific processing in an Application Example 1. The units of the system described below are implemented by the data processing device 12 and the smart device 14. The data processing device 12 is called a “server” and the smart device 14 is called a “terminal”.

The specific processing by the specific processing unit 290 of the data processing device 12 in Application Example 1 is realized by the following means.

The term “information processing device” refers to any electronic computing apparatus that includes at least one processor and memory, and that is capable of executing instructions to perform data communication, data processing, or control operations within the system.

The term “edge terminal” refers to an information processing device that is located near data sources or control targets, and that performs sensing, local computation, and communication with other nodes and a central device in a distributed system.

The term “node” refers to an edge terminal or other information processing device that participates as an endpoint in the distributed network, executes assigned analysis processing units, and exchanges data with other nodes and a central device.

The term “communication path” refers to a logical or physical connection arrangement among nodes and a central device that enables bidirectional data transmission using identification information such as network addresses or identifiers.

The term “identification information” refers to any data element that uniquely or semi-uniquely identifies a node or device in the system, including, for example, network addresses, port numbers, device identifiers, or other routing identifiers.

The term “time-series information” refers to data that consists of measurements or events each associated with a time stamp, representing how a quantity or state changes over time.

The term “environmental information” refers to data describing physical, operational, or contextual conditions of an environment, including but not limited to temperature, humidity, noise level, traffic volume, energy usage, and air quality.

The term “observation device” refers to any sensor apparatus or monitoring apparatus that measures physical quantities or operational states and outputs corresponding digital data to an information processing device.

The term “service area” refers to a spatial region, logical region, or functional region for which the system performs monitoring, analysis, and control, such as an intersection, a building, a district, or an environmental zone.

The term “information set” refers to a collection of related time-series information and environmental information that has been grouped according to at least one criterion such as service area, time period, or data type.

The term “analysis processing unit” refers to a discrete computation job or task that is derived from an information set and that can be executed independently by a node to produce analysis result information.

The term “computation resource usage information” refers to information indicating a utilization state of processing resources of a node, including, for example, processor utilization, memory usage, and communication bandwidth usage.

The term “state index” refers to a quantitative or qualitative evaluation value computed from analysis result information that represents an operational or environmental condition of a service area, such as a traffic flow index, an energy consumption index, or an environmental quality index.

The term “verification value” refers to a value calculated from analysis result information, such as a hash value or checksum, that is used to verify integrity of the analysis result information and detect tampering or corruption.

The term “tampering” refers to an unauthorized modification, insertion, or deletion of data that alters the original analysis result information or state indices in a way that is not permitted by the system.

The term “communication path encryption” refers to the application of cryptographic techniques to data transmitted over a communication path so that the data is unintelligible to unauthorized entities.

The term “terminal authentication information” refers to credentials or security data, such as keys, certificates, or authentication tokens, that are used to verify the identity of a node or device in mutual authentication.

The term “personal-related information” refers to information that directly or indirectly relates to an individual or a small group of individuals, including identifiers, location traces, or usage patterns, and that may affect privacy.

The term “anonymizing” refers to processing data such that personal-related information cannot be associated with a specific individual, even when combined with other reasonably available information.

The term “pseudonymizing” refers to processing data such that direct identifiers are replaced with pseudonyms, while still allowing re-identification under controlled conditions using separate additional information.

The term “monitoring information” refers to data used to observe operational status of nodes or components, including heartbeat signals, error logs, performance metrics, and availability indicators.

The term “abnormal node” refers to a node that is determined, based on monitoring information, to be failed, unreachable, degraded, or operating outside of acceptable performance or reliability thresholds.

The term “service continuity” refers to a capability of the system to maintain provision of its analysis, recommendation, and control functions without unacceptable interruption, even when one or more nodes become abnormal.

The term “explanation information” refers to textual or structured descriptive data that includes at least a target area, a time period, and current control conditions, and that summarizes the context of state indices and analysis results.

The term “query sentence” refers to a natural language sentence or set of sentences that is formatted to request analysis, prediction, or recommendations from a generative information processing model.

The term “prompt sentence” refers to a specific kind of query sentence that is constructed to be input to a generative information processing model and that encodes relevant context, constraints, and requested output content.

The term “generative information processing model” refers to an information processing model, such as a generative artificial intelligence model, that receives a prompt sentence and outputs generated natural language content and/or structured data based on learned parameters.

The term “proposal information” refers to natural language output generated by the generative information processing model that includes recommendations, strategies, or rationales regarding control, optimization, or improvement for a target area.

The term “control candidate information” refers to structured information generated by the generative information processing model that expresses one or more candidate control policies, parameter sets, or schedules in a machine-interpretable format.

The term “control target device” refers to any device or system whose operational parameters can be adjusted by the system, including, for example, signaling devices, energy management devices, or environmental control devices.

The term “control parameter” refers to a value or a set of values that determine operation of a control target device, such as timing values, setpoints, thresholds, or schedule entries.

The term “machine-readable group of control parameters” refers to a structured representation of control parameters, such as a data structure or configuration file, that can be directly processed by a node or control target device without human intervention.

The term “display device” refers to any user interface device, including a graphical display or terminal, that is capable of presenting text, graphics, or other information to a user.

The term “approval information” refers to user-supplied input indicating acceptance of proposed control parameters or strategies, authorizing the system to apply such parameters.

The term “correction instruction” refers to user-supplied input that modifies, constrains, or rejects at least a part of the proposal information or control parameters generated by the system or the generative information processing model.

The term “traffic flow index” refers to a state index that quantitatively evaluates traffic conditions in a service area, based on parameters such as traffic volume, speed, density, or queue length.

The term “energy consumption index” refers to a state index that quantitatively evaluates energy usage in a service area, based on parameters such as power demand, peak load, and energy efficiency.

The term “environmental quality index” refers to a state index that quantitatively evaluates environmental conditions in a service area, based on parameters such as air quality, noise levels, or temperature distributions.

The term “signal control condition” refers to a set of control parameters that define timing, phasing, and coordination of signaling devices, such as traffic signals, within a service area.

The term “energy utilization measure” refers to an operational strategy or configuration that is intended to optimize or improve energy usage, such as demand shifting, load reduction, or efficiency enhancement.

The term “environmental improvement measure” refers to an operational strategy, control change, or policy that is intended to improve environmental quality indexes, such as measures for reducing emissions, noise, or pollution concentrations.

The term “safety standard information” refers to data representing constraints derived from safety regulations, engineering standards, or system safety policies that define permissible ranges or conditions for control parameters.

The term “operation constraint information” refers to data representing operational limitations, business rules, or service-level requirements that restrict or condition how control parameters may be applied in practice.

In one embodiment, a server, a plurality of terminals, and a generative AI model cooperate to implement the claimed system. The server includes at least one processor, main memory, non-volatile storage, and network interfaces. The server executes an operating system such as a general-purpose server operating system and application software implemented, for example, in programming languages such as C++, Java, or Python. The terminals each comprise a processor, memory, a network interface, and sensor or actuator interfaces such as digital input/output ports, analog-to-digital converters, serial interfaces, or fieldbus interfaces. The terminals execute an embedded operating system or a lightweight operating system such as a general-purpose embedded operating system.

### A. Overall Configuration and Data Structures

The server stores program modules corresponding to a communication path construction function, an analysis processing unit generation and distribution function, a load-aware scheduling function, a result integration and verification function, a communication security function, an availability management function, a prompt generation function, a generative AI model interface function, a control application function, and a user interaction function.

The server manages core data using structured data models. The server stores sensor data in a time-series table in a relational data management system such as a relational database with an extension for time-series data, or in a time-series database. Each record includes, for example, fields: node_id, area_id, timestamp, sensor_type, value, quality_flag. The server stores analysis processing units as task records comprising a task_id, a data_range (start_time, end_time, area_id), a task_type (traffic, energy, environment), a required_features list, an assigned_node_id, and a status flag.

The server maintains a state index table that stores indices such as a traffic flow index, an energy consumption index, and an environmental quality index. Each entry includes area_id, time_window, index_type, index_value, and confidence_score. The server also stores verification values as hash records comprising result_id, hash_value, hash_algorithm, and timestamp.

The terminals store local configuration data, including a node identifier, hardware capability information (processor frequency, memory size), and a list of connected observation devices and control target devices. The terminals maintain a local buffer of recently acquired sensor frames, each frame having a timestamp and a vector of measurements from different sensors.

### B. Communication Path and Node Organization

The server assigns each terminal a logical node identifier and network parameters such as an IP address and port number. The server provides configuration files to the terminals during an initialization phase. The terminals register with the server by sending registration messages over a communication protocol such as Transport Layer Security-protected HTTP. The server authenticates the terminals using digital certificates or cryptographic tokens.

The terminals maintain secure connections with the server using TLS. The terminals periodically send heartbeat messages that contain node_id, current CPU utilization, memory utilization, and link status. The server aggregates these heartbeat messages to form monitoring information used for load balancing and availability management.

The technical effect of this arrangement is that the server can maintain an accurate, real-time view of resource availability in the distributed network, which allows the server to make algorithmic decisions about where to place computation that minimize communication load and improve overall throughput compared with static assignment.

### C. Sensor Acquisition and Local Processing at Terminals

The terminals acquire time-series information and environmental information from observation devices. For example, one terminal is connected to a traffic signal controller via a fieldbus interface. The terminal reads per-lane vehicle counts, average speed, and occupancy values at fixed intervals. Another terminal is connected to an energy management controller and reads active power, reactive power, and equipment states. A further terminal interfaces with environmental sensors for temperature, humidity, particulate matter levels, and acoustic noise.

The terminals normalize sensor outputs into structured frames. Each frame is stored as a vector of features, such as [vehicle_count, average_speed, occupancy, noise_level, pm25, temperature], with a timestamp. The terminals can perform light preprocessing, such as unit conversion, basic filtering, and anomaly flagging, using numerical libraries such as a standard numerical computation library.

This local preprocessing at the terminals reduces the data volume that must be sent to the server by removing invalid values and compressing redundant information, which yields a reduction in communication load and improves data quality for subsequent analysis.

### D. Analysis Processing Units and Resource-Aware Scheduling

The server periodically groups sensor frames into information sets based on area_id and time_window. The server then derives analysis processing units. For example, for a traffic analysis, the server forms an analysis processing unit that uses as input a sequence of traffic measurements from all lanes of an intersection for a fifteen-minute window. For energy and environmental analysis, similar grouping is performed.

The server uses an algorithmic scheduler to assign these analysis processing units to nodes. The server stores recent resource usage metrics per node in memory. The server executes a scheduling algorithm that considers a cost function combining CPU load, memory load, network latency, and estimated computation time for each task type. The server uses a resource-based scheduling algorithm that is not a simple round-robin; instead, the server calculates a score for each node and selects the node with the best score for each task. This algorithm provides a technical improvement in computation efficiency because the server uses dynamic, quantitative metrics to allocate workloads, reducing queueing delays at overloaded nodes and increasing utilization of underused nodes, which improves throughput and reduces overall response time compared to uniform or static assignment.

### E. Result Integration and Verification

The terminals execute assigned analysis processing units using local processors. For traffic tasks, the terminals compute indices such as average delay per vehicle and queue length estimates by applying deterministic formulas and, if available, a local prediction model, for example a small recurrent neural network running in an optimized inference engine. For energy tasks, the terminals compute peak-to-average ratios and detect abnormal spikes using threshold rules and statistical tests. For environmental tasks, the terminals compute moving averages and exceedance rates for pollutant concentrations.

The terminals send the resulting analysis result information to the server. The server aggregates the results into area-level and city-level state indices by combining data from multiple terminals and multiple time windows. The server then calculates verification values, such as cryptographic hashes computed with a secure hash function, for each aggregated result and stores those verification values in storage.

By storing verification values, the server can later detect any unauthorized modification of past analysis results. This ensures integrity of the data used for generating prompt sentences and for controlling devices, improving reliability and safety of the entire technical system.

### F. Communication Security and Availability

The server employs a communication security stack that uses mutual authentication. The terminals store terminal authentication information, such as client certificates, and the server stores corresponding trust anchors. During connection establishment, the terminal and server perform a handshake, validate certificates, and only then accept application messages. The server also runs a privacy module that anonymizes or pseudonymizes personal-related information. For example, precise position data may be generalized to areas, and identifiers may be replaced by pseudonyms stored in separate secure storage.

The server maintains availability by replicating critical data across different storage devices and nodes. The server continuously observes monitoring information and uses a failure detection algorithm. When the server detects that a node is abnormal, the server reassigns uncompleted analysis processing units to other nodes with sufficient resources.

This architecture yields a technical effect in that communication security, data integrity, and service continuity are achieved systematically by machine-level mechanisms, not merely by human operational procedures. The combination of replication, monitoring, and automatic failover ensures continuous functioning of control operations in a distributed environment.

### G. Prompt Generation and Generative AI Model Interaction

The server generates prompt sentences in a deterministic way based on state indices and analysis result information. The server extracts explanation information that includes at least the target area, the time window, current control conditions (for example, current signal timings or energy control setpoints), and selected state indices. The server converts numerical values into textual descriptions using templates, and assembles these descriptions into a grammatically structured prompt sentence.

For example, the server may generate prompt sentences such as:

“At Intersection A, between 17:00 and 18:00, the east-west traffic volume is 1200 vehicles per hour, the north-south traffic volume is 400 vehicles per hour, and the current green time is 30 seconds for all directions. Please propose new signal timings to alleviate congestion.”

“For Building B, on weekdays between 13:00 and 16:00, the average power consumption is 500 kW, and the HVAC system accounts for 60 percent of this consumption. Please propose specific operational strategies to optimize the building's energy consumption while maintaining occupant comfort.”

“In Area C, PM2.5 levels repeatedly exceed recommended thresholds between 22:00 and 1:00. The area includes residential zones, a major road, and several small factories. Please propose effective measures to improve air quality in this area.”

The server then sends these prompt sentences to a generative AI model. In one embodiment, the generative AI model is a transformer-based neural network with multiple layers of self-attention and feedforward sub-layers. The model has been trained in advance on a corpus that includes domain-specific text about traffic control, energy management, and environmental policies. During training, the model optimizes a loss function such as cross-entropy over next-token prediction using gradient-based optimization algorithms such as Adam, with regularization techniques including dropout and layer normalization.

The generative AI model processes tokenized prompt sentences and produces output tokens representing natural language text. The output can contain explicit numerical suggestions and structured text segments that the server can parse. The server uses a deterministic parser to extract parameter candidates from the text using patterns and token type classification. For example, the server can identify phrases that match “X seconds” and map them to new timing values.

This structure is not a simple automation of human reasoning but provides a technical improvement because the server systematically integrates numeric state indices and detailed control context into the prompt sentences and interprets the output with machine-level rules, enabling the server to compute new control parameters across a large number of areas and time windows that would be infeasible for human operators to handle in real time.

### H. Control Application and Feedback to Devices

The server converts the extracted control candidate information into device-specific configuration objects. For traffic signals, the server builds a control parameter group that defines cycle length, phase sequence, green times, and offsets. For building energy systems, the server builds a schedule with temperature setpoints, equipment operation time windows, and priority flags for load shedding. The control parameters are represented as machine-readable data structures that the terminals can directly apply through device APIs.

The server subjects the control candidate information to a safety and operation constraint check. The server stores safety standard information and operation constraint information, such as minimum and maximum green times, maximum cycle lengths, maximum allowed temperature ranges, and maximum ramp rates for equipment. The server evaluates each candidate control parameter against these constraints and either adjusts the parameter to the nearest permissible value or discards it if no safe adjustment is possible.

The server then transmits the corrected control parameter group to the relevant terminals. The terminals verify that the control parameters conform to local safety checks and update local controllers via standardized interfaces. For example, a terminal may write new timing parameters to a signal controller register or send new schedules to an energy management controller.

This produces a direct technical effect in the physical world, as the actuators change their behavior based on the generated control parameters. It also improves computer technology by enabling a closed-loop system that autonomously computes and applies control parameters using distributed data structures and resource-aware scheduling, which reduces response time and improves the quality and consistency of control decisions compared with prior systems.

### I. User Interaction and Override Capability

The server provides a user interface through which a user can observe system status and AI-generated proposals. The server generates displays that show state indices, recommended control parameter changes, and applied updates. The user can approve, modify, or reject recommendations. When the user modifies recommendations, the server updates the control parameters accordingly and logs the changes.

The user can also manually craft additional prompt sentences to query the generative AI model. For example, the user can enter:

“Please analyze the traffic pattern in the city center between 7:00 and 9:00 and propose a coordinated signal control strategy for the main arterial road.”

The server sends such user-defined prompt sentences to the generative AI model and processes the responses following the same parsing and constraint-checking procedure.

### J. Technical Effects and Computer Technology Improvements

The described system improves computer technology in several ways. First, the resource-aware scheduling and distributed analysis processing units reduce processing latency and improve throughput by dynamically adapting to node resource states. This is not merely human decision-making automation; it is a specific algorithm implemented at the server that computes task-to-node assignments based on measured CPU, memory, and bandwidth utilization and on estimated computational cost for each task.

Second, the data structures used for state indices and prompt sentences integrate quantitative metrics, temporal context, and device-specific control conditions in a machine-readable way. This enables the server to construct detailed, context-rich prompt sentences that the generative AI model can exploit, yielding more precise and actionable outputs. The system increases the accuracy and robustness of control decisions by deriving prompt inputs from structured, verified data and by applying constraint checks to the AI outputs.

Third, the system improves data management and security by computing and storing verification values for analysis results and by implementing automated integrity checks. This reduces risk of undetected tampering and ensures that prompt sentences and control decisions are derived from authentic data. The replication and failover mechanisms ensure continuity of computation and control even when nodes fail, thus improving reliability beyond what manual human management could offer.

Fourth, the use of a transformer-based neural network that has been trained with domain-specific examples allows the system to apply complex relationships between traffic patterns, energy usage, and environmental conditions that are not captured in simple rule-based systems. The server does not simply follow human-written rules; instead, the server uses model-generated proposals derived from high-dimensional representations. The server then combines these proposals with explicit safety and operation constraints using program logic, which results in improved optimization quality and reduced human error.

In alternative embodiments, the server may use different generative AI architectures, such as recurrent neural networks or hybrid models with convolutional components for time-series features. The server may augment training data by synthetic data generation and adversarial examples to improve robustness. The system can support other types of state indices and control targets, such as water distribution systems or lighting systems, by changing the feature definitions, indices, and device interfaces while maintaining the same core architecture of distributed analysis, prompt generation, generative AI recommendation, and constrained control application.

By combining these elements, the server, the terminals, and the generative AI model implement a concrete, technical system that uses specific data structures, algorithms, and hardware-software cooperation to realize improved performance, accuracy, and reliability in the control of real-world devices and infrastructures.

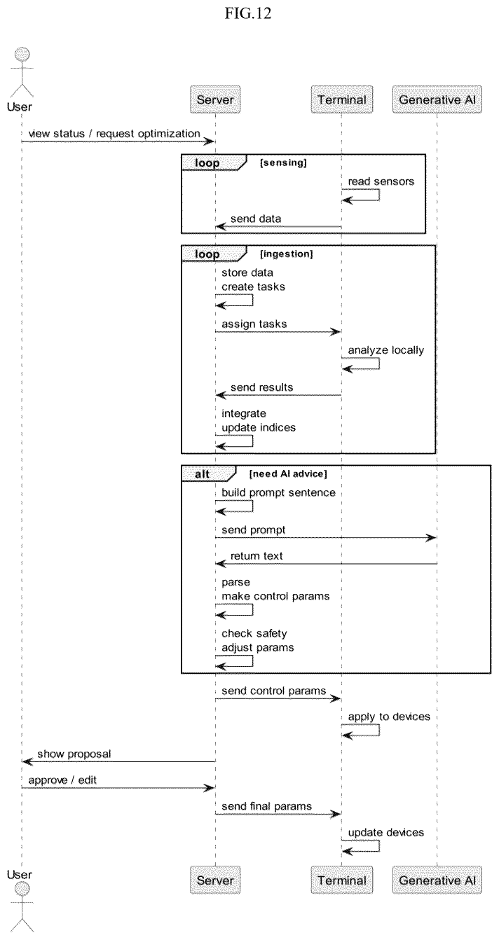

The following describes the processing flow using FIG. 12.

### Step 1:

Terminal acquires raw sensor data from observation devices and normalizes it.

Terminal receives, as input, raw electrical signals or protocol messages from connected sensors such as traffic detectors, energy meters, and environmental sensors. Terminal converts these inputs into digital measurement values (for example, vehicle_count, average_speed, power_usage, pm25_concentration) and attaches a timestamp, node_id, and area_id to each measurement. Terminal then performs data processing that includes unit conversion, removal of obviously invalid values, and packaging of multiple measurements into a structured record, such as a feature vector or a JSON-like object. As output, terminal produces normalized sensor records ready for transmission to the server.

### Step 2:

Terminal transmits normalized sensor records securely to the server.

Terminal takes, as input, the normalized sensor records produced in Step 1 and terminal authentication information stored locally. Terminal establishes a secure communication channel with the server using a TLS handshake and validates the server certificate. Terminal then sends batched sensor records to a predefined API endpoint on the server using HTTPS. Terminal receives, as output, an acknowledgment message or error code from the server. Terminal logs transmission results and, when transmission fails, performs a retry operation with exponential backoff based on the error code.

### Step 3:

Server ingests sensor records, validates them, and stores them in time-series data structures. Server receives, as input, HTTPS requests containing sensor records from multiple terminals. Server authenticates each terminal using its terminal authentication information and validates the structure of the received data (for example, checking required fields such as timestamp, node_id, area_id, sensor_type, and value). Server performs data processing that includes schema validation, type checking, and basic consistency checks (for example, rejecting data with timestamps far in the future or past). Server then writes valid sensor records into time-series tables in a database, indexing by timestamp and area_id. As output, server generates database insert confirmations and internal log entries that record successful and failed ingestions.

### Step 4

Server forms information sets from stored sensor data and generates analysis processing units. Server takes, as input, stored sensor records from the time-series database and configuration parameters that define time windows and service areas. Server groups sensor records into information sets by applying a grouping operation over keys such as area_id and fixed-length time intervals (for example, fifteen-minute windows). For each group, server performs aggregation operations such as computing min, max, average, and count for relevant measurement types, and constructs an information set that includes both raw samples and aggregate statistics. Server then generates analysis processing units by associating each information set with a task_type (traffic, energy, environment) and a data_range. As output, server produces a list of analysis processing units stored in a task table or a task queue.

### Step 5:

Server collects resource usage metrics from nodes and schedules analysis processing units to nodes.

Server receives, as input, periodic heartbeat messages from terminals that contain current CPU usage, memory usage, and network bandwidth usage. Server updates an internal resource table with these metrics and uses them together with the pending analysis processing units from Step 4 as inputs to a scheduling algorithm. Server computes a score for each candidate node for each analysis processing unit based on a cost function that may include CPU utilization, memory headroom, and estimated execution time for that task_type. Server selects a node with the best score and assigns the analysis processing unit to that node by updating the task record and enqueuing a task descriptor into the node's task queue. As output, server generates updated task assignments and a set of task descriptors ready for retrieval by the terminals.

### Step 6:

Terminal retrieves assigned analysis processing units and performs local analytical computations.

Terminal obtains, as input, task descriptors from its task queue and local or remote data references that specify which sensor records to use. Terminal fetches the referenced data, either from its local buffer or via a server query, and performs analysis appropriate to the task_type. For a traffic task, terminal calculates congestion metrics such as average delay and queue length from traffic volume and speed values using mathematical formulas. For an energy task, terminal computes peak load, load factor, and detects spikes using threshold comparisons and variance calculations. For an environmental task, terminal computes moving averages and exceedance rates for pollutant levels using sliding-window operations. As output, terminal produces analysis result information, which includes computed indices, summary statistics, and any anomaly flags, and returns this information to the server in a structured format.

### Step 7:

Server integrates analysis result information into state indices and verifies integrity with verification values.

Server takes, as input, analysis result information from multiple terminals and existing stored results. Server merges analysis results that share a common area_id and time_window by aggregating indices (for example, computing weighted averages or maxima across sub-areas). Server then calculates state indices such as a traffic flow index, an energy consumption index, and an environmental quality index from the merged results by applying predetermined formulas that map multiple metrics into a single index value. Server also computes a verification value for each integrated result, for example by applying a cryptographic hash function to the serialized result data. As output, server stores the state indices and corresponding verification values in the database and produces integrated result objects that are ready for further use.

### Step 8:

Server manages communication security and maintains availability by monitoring nodes and reassigning tasks.

Server receives, as input, heartbeat messages, error reports, and connection status information from terminals, as well as stored replicas of important data. Server evaluates monitoring information to classify each node as normal or abnormal using threshold logic on missing heartbeats, high error rates, or failed authentication. When server detects an abnormal node, server identifies analysis processing units and control tasks assigned to that node and reassigns them to alternative nodes with sufficient resources using the scheduling logic from Step 5. Server also maintains replicated copies of state indices and analysis results across different storage devices, updating them when new results are generated. As output, server updates node status flags, task assignments, and replication records, thereby ensuring continuity of computation and control operations.

Server generates prompt sentences from state indices and analysis results for a generative AI model.

Server uses, as input, the state indices, analysis result information, and configuration rules that specify which indices and conditions trigger AI-based recommendations. When server determines that an AI recommendation is required (for example, congestion index exceeding a threshold), server selects relevant indices and control condition data, such as current signal timings or energy setpoints. Server formats these numerical values into natural language phrases using templates, concatenates them to form a coherent context description, and appends a request clause asking for specific recommendations. Server thus performs text construction operations that convert structured numeric and categorical data into a natural language prompt sentence. As output, server generates one or more prompt sentences such as: “At Intersection A, between 17:00 and 18:00, the east-west traffic volume is 1200 vehicles per hour, the north-south traffic volume is 400 vehicles per hour, and the current green time is 30 seconds for all directions. Please propose new signal timings to alleviate congestion.” or

“For Building B, on weekdays between 13:00 and 16:00, the average power consumption is 500 kW, and the HVAC system accounts for 60 percent of this consumption. Please propose specific operational strategies to optimize the building's energy consumption while maintaining occupant comfort.”

### Step 10:

Server inputs prompt sentences to a generative AI model and interprets the generated output into control candidate information.

Server takes, as input, the prompt sentences from Step 9 and model configuration parameters, such as model type and temperature. Server tokenizes each prompt sentence into token sequences, sends these tokens to a generative AI model such as a transformer-based neural network via an API, and receives output tokens corresponding to generated natural language responses. Server decodes the output tokens into text and then parses the text using rule-based or pattern-matching techniques. For example, server identifies phrases expressing time durations, setpoints, or priority levels and maps them to structured fields such as green_time_east_west, temperature_setpoint_peak, or restriction_time_window. As output, server produces structured control candidate information, which is a machine-readable representation of suggested control parameters and schedules derived from the generative AI model's response.

### Step 11:

Server validates and corrects control candidate information using safety standards and operation constraints.

Server receives, as input, the control candidate information from Step 10 and stored safety standard information and operation constraint information. Server evaluates each candidate parameter by comparing its value against allowable ranges and logical constraints. For example, server checks whether signal green times satisfy minimum and maximum limits and whether the sum of phase times matches a permitted cycle length, or checks whether temperature setpoints remain within comfort and equipment safety limits. Server performs data processing that includes clamping out-of-range values, discarding unsafe proposals, and, when necessary, deriving corrected values using constraint satisfaction logic. As output, server generates a corrected control parameter group that contains only parameters that satisfy safety and operational rules and flags indicating which original candidates were modified or rejected.

### Step 12:

Server distributes corrected control parameters to terminals and updates control target devices.

Server uses, as input, the corrected control parameter groups and mapping information that associates each group with specific terminals and control target devices. Server transmits the control parameter groups over secure communication channels to the relevant terminals using HTTPS and logs the transmission. Terminal receives, as input, the control parameter group for its associated devices. Terminal performs a local validation check consistent with device-specific safety rules and, when the group passes validation, writes the parameters to the control interfaces of devices such as traffic signal controllers or energy management controllers. Terminal triggers the new configuration at a specified activation time. As output, terminal updates actual device operation conditions, resulting in changes such as modified signal timings or adjusted energy control schedules, and sends status confirmations back to the server.

### Step 13:

Server presents recommendations and applied control parameters to the user and accepts user approvals or corrections.

Server receives, as input, the proposal information generated by the generative AI model, the corrected control parameter groups, and current device status. Server renders these data into user interface elements, such as tables, charts, and explanation text, and sends them to a display operated by the user. User views the presented information and may input approval information or correction instructions, such as editing specific parameter values or rejecting certain changes. Server processes these user inputs, updating the control parameter group and, if necessary, overwriting AI-derived values with user-specified ones. As output, server produces final control parameter groups that incorporate user decisions and either applies them immediately through Step 12 or schedules them for later deployment, while recording user interactions for auditing.

It is also possible to incorporate an emotion engine for estimating the user's emotions. That is, the specific processing unit 290 may estimate the user's emotions using an emotion identification model 59, and perform specific processing based on the estimated emotions.

### Example 2

Description follows regarding a flow of the specific processing in an Example 2. The units of the system described below are implemented by the data processing device 12 and the smart device 14. The data processing device 12 is called a “server” and the smart device 14 is called a “terminal”.

Conventional network-based artificial intelligence systems that employ large generative AI models typically centralize almost all computation on one or more server-side processors. This centralized architecture leads to several interrelated technical problems in computer systems.

First, when a large number of client devices concurrently submit prompt sentences to a centralized generative AI model, computation and memory loads concentrate on a limited number of processors and accelerators. This concentration causes increased queueing delay in task schedulers, higher contention for processor cores and memory bandwidth, and greater congestion on network interfaces. As a result, overall response latency increases and throughput decreases, thereby degrading system-level performance characteristics such as tail latency and effective capacity.

Second, many existing distributed or edge-oriented architectures treat all requests and all users as equivalent from the standpoint of task scheduling. In particular, conventional task allocation and load balancing algorithms typically use only resource metrics such as CPU utilization, memory usage, and network bandwidth, and do not incorporate any structured information about the emotional state or urgency level of a user as part of the scheduling decision. Consequently, requests from highly stressed or anxious users, for which delayed or overly complex responses can worsen user dissatisfaction, are not prioritized or shaped at a system level. This leads to a mismatch between the actual importance or sensitivity of certain requests and the behavior of the underlying scheduling and resource allocation mechanisms.

Third, in typical systems, the user interface pipeline is loosely coupled to the back-end computation pipeline. While some applications adjust wording or style heuristically, the low-level computation graph of the generative AI model and the distributed execution of subtasks are not dynamically adapted based on emotion-aware information. In particular, conventional systems do not reconfigure the decomposition of a generative AI task into subtasks, the order and structure of conclusion parts and detailed explanation parts, or the distribution of work across client-side processors and server-side processors in response to emotion metadata. As a result, existing implementations fail to exploit available computation resources on client devices and cannot systematically optimize both latency and intelligibility of responses. Fourth, many current systems ignore the fact that client devices often have non-trivial computing, storage, and communication capabilities, including local inference engines for lightweight models. Because existing architectures do not expose a mechanism for fine-grained offloading of subtasks to client-side processors based on up-to-date resource information and emotion-driven priorities, the systems do not fully utilize the aggregate compute capacity of the distributed network. This leads to inefficient use of computational resources and prevents the system from scaling efficiently under heavy load.

Accordingly, there is a need for an improved computer-implemented system and method that (i) dynamically decomposes processing associated with a prompt sentence for a generative AI model into subtasks; (ii) computes emotion-aware priorities based on structured emotion metadata derived from multimodal user inputs; (iii) performs load balancing and task allocation across terminal-side nodes and centralized processing nodes using both resource information and emotion priority; and (iv) generates and presents final output data in a structure and order that are adapted to the user's emotional state. Such a system should improve core technical properties of the computer system, including reduced response latency for critical tasks, increased throughput via distributed execution, and enhanced stability and efficiency of scheduling under varying load conditions, while preserving security, privacy, and availability in a multi-node environment.

The specific processing by the specific processing unit 290 of the data processing device 12 in Example 2 is realized by the following means.

The present invention provides a server comprising a processor and a memory storing instructions that, when executed by the processor, cause the server to construct a communication network in which multiple information processing nodes, including at least one terminal-side node and at least one centralized processing node, operate as mutually connected communication endpoints; to receive, from a terminal-side node, a prompt sentence expressed in natural language and structured emotion metadata that represents an emotional state of a user together with resource information for the terminal-side node; to generate, based on the prompt sentence and the emotion metadata, a modified prompt sentence to be input to a generative AI model, the modified prompt sentence including constraint conditions that specify at least one of presenting a conclusion before details, suppressing use of technical terminology, and limiting a number of reasons to be output; to analyze processing associated with the modified prompt sentence, to divide the processing into a plurality of subtasks including at least a conclusion-presentation subtask and a detailed-explanation subtask, and to construct a task graph representing dependency relationships among the subtasks; to acquire resource information for each node in the network, the resource information including at least computation resource information, storage resource information, communication resource information, and power resource information, and to calculate an emotion priority value from the emotion metadata; to determine, based on the resource information and the emotion priority value, an allocation destination node for each of the subtasks so that higher-priority subtasks are preferentially allocated to nodes having greater available computation resources or lower communication latency; to cause each node to execute its allocated subtasks by using a local lightweight inference engine or deep learning framework to generate partial processing results, and to execute the generative AI model on the centralized processing node with the modified prompt sentence as input to generate a model output; to integrate the model output and the partial processing results into final output data whose internal structure is controlled according to the emotion metadata, including ordering and information density of at least a conclusion part, a reason-explanation part, and a detailed-explanation part; and to transmit the final output data to the terminal-side node via an encrypted communication channel so that the terminal-side node can dynamically determine display order, emphasis level, and output modality based on the emotion metadata. This enables the computer system to improve core technical performance by distributing processing associated with generative AI tasks across heterogeneous nodes using emotion-aware priorities, thereby reducing response latency for emotionally urgent requests, increasing throughput under high load, more fully utilizing terminal-side computation resources, and producing responses whose structure is dynamically adapted at the system level to the user's emotional context while maintaining security, privacy, and availability across the distributed network.

The term “system” refers to an arrangement of one or more hardware devices and software components that cooperate to perform distributed information processing, including execution of generative AI-related tasks across multiple nodes.

The term “processor” refers to one or more hardware execution units, such as central processing units or accelerators, that execute instructions stored in memory to perform computational operations, control data flow, and manage communication between components in the system.

The term “memory” refers to one or more hardware storage devices, including volatile storage and non-volatile storage, that store instructions and data for use by the processor.

The term “information processing apparatus” refers to a hardware device including at least a processor, a memory, and a communication interface, and configured to perform computation, storage, and communication operations as a node in a network.

The term “node” refers to an information processing apparatus that participates as an endpoint in a communication network and is capable of executing at least part of a distributed processing task.

The term “terminal-side node” refers to a node that is directly operated or associated with a user, such as a client device, and that can acquire user inputs, perform local computation, and communicate with a centralized processing node.

The term “centralized processing node” refers to a node having relatively greater computation or storage capability, such as a server apparatus, that executes centralized portions of processing including execution of a generative AI model.

The term “network” refers to a communication infrastructure through which nodes exchange messages using predefined communication protocols over physical or logical links.

The term “communication endpoint” refers to an addressable interface, such as an address and port combination or equivalent identifier, used by a node to send and receive messages over the network.

The term “prompt sentence” refers to natural language text that expresses an instruction, question, or request to be processed by a generative AI model.

The term “generative AI model” refers to a machine learning model, typically implemented as a deep learning model, that generates new data such as text or other content based on an input including at least a prompt sentence.

The term “emotion metadata” refers to structured data representing an estimated emotional state of a user, including at least one emotion label and one or more numerical indicators of emotion intensity or confidence.

The term “emotion label” refers to a categorical identifier that classifies an emotion state, such as anxiety, anger, joy, sadness, confusion, or neutrality.

The term “emotion intensity indicator” refers to a numerical value, such as a probability or score, that indicates the strength or confidence level associated with a particular emotion label.

The term “emotion priority value” refers to a numerical value derived from emotion metadata that indicates a priority level to be used by scheduling or allocation logic for one or more subtasks.

The term “modified prompt sentence” refers to a prompt sentence that has been transformed based on emotion metadata or task requirements, and that may include additional constraints, instructions, or formatting directives for a generative AI model.

The term “constraint condition” refers to a rule or instruction that restricts or guides the behavior of a generative AI model, such as presenting a conclusion before details, suppressing technical terminology, or limiting the number of reasons to be generated.

The term “processing content” refers to the computational operations and data transformations that are to be performed in response to a prompt sentence, including intermediate processing steps and final output generation.

The term “subtask” refers to a unit of processing that constitutes a part of the overall processing content, and that can be executed independently or in combination with other subtasks to produce a final result.

The term “conclusion-presentation subtask” refers to a subtask whose primary purpose is to generate or present a concise main answer or conclusion in response to a prompt sentence.

The term “detailed-explanation subtask” refers to a subtask whose primary purpose is to generate extended background, supporting reasoning, or additional details beyond a main conclusion.

The term “task graph” refers to a data structure representing a set of subtasks as nodes and dependencies among subtasks as edges, indicating execution order or data flow between subtasks.

The term “resource information” refers to data describing utilization or availability of system resources of a node, including at least computation resources, storage resources, communication resources, and power resources.

The term “computation resource information” refers to data that indicates usage or availability of processing elements of a node, such as CPU utilization, accelerator utilization, or available processing capacity.

The term “storage resource information” refers to data that indicates usage or availability of memory or persistent storage at a node, such as memory utilization, free storage space, or storage bandwidth.

The term “communication resource information” refers to data that indicates the state of network-related resources at a node, such as available bandwidth, latency, packet loss rate, or connection status.

The term “power resource information” refers to data that indicates a power-related status of a node, such as battery level, power source type, or power-saving mode state.

The term “allocation destination node” refers to a node selected to execute a particular subtask based on one or more criteria including resource information and emotion priority.

The term “scheduling evaluation value” refers to a numerical score computed from resource information, emotion priority, and optionally other factors, and used to rank or select nodes for subtask allocation.

The term “lightweight inference engine” refers to a software component optimized for executing relatively small or resource-efficient machine learning models on devices with limited computing resources, such as mobile or embedded devices.

The term “deep learning framework” refers to a software library or platform for constructing, training, and executing deep neural network models, including modules for defining network architectures and performing inference.

The term “partial processing result” refers to an intermediate output produced by a node when executing a subtask, which does not yet represent the final output data but contributes to generation of the final output data.

The term “model output” refers to data generated by a generative AI model in response to an input including at least a modified prompt sentence and optionally additional contextual data.

The term “final output data” refers to data generated after integration of the model output and partial processing results, and structured for presentation to the user, including at least a conclusion part, a reason-explanation part, and optionally a detailed-explanation part.

The term “conclusion part” refers to a portion of the final output data that expresses the main answer or result in a concise form.

The term “reason-explanation part” refers to a portion of the final output data that describes one or more reasons, justifications, or key factors that support the conclusion part.

The term “detailed-explanation part” refers to a portion of the final output data that provides extended descriptions, background information, or in-depth technical explanations in addition to the conclusion part.

The term “structured data format” refers to a data representation format having explicit field definitions, such as a key-value or schema-based representation, including but not limited to formats like JSON, XML, or equivalent structures.

The term “encrypted communication channel” refers to a communication path between nodes that uses cryptographic protocols to protect confidentiality and integrity of transmitted data.

The term “display order” refers to the sequence in which different parts of the final output data are presented to the user on a user interface.

The term “emphasis degree” refers to a level or style of visual or auditory prominence given to a part of the final output data, such as font size, color, ordering, or vocal stress in an audio output.

The term “output modality” refers to a mode or combination of modes used to present information to the user, such as text display, graphical representation, or audio playback.

The term “text input” refers to user-provided characters or strings entered through a keyboard, touchscreen, or other text entry interface.

The term “voice input” refers to user-provided audio data acquired through a microphone or equivalent audio capture device.

The term “image input” refers to user-provided or device-captured visual data, including still images or video frames, acquired through a camera or equivalent imaging device.

The term “authentication processing” refers to operations that verify the identity or authority of an entity, user, or node before granting access to data or functions.

The term “access control processing” refers to operations that enforce policies governing which entities are permitted to access, modify, or transmit particular data or to invoke particular functions.

The term “confidentiality” refers to a property by which data is protected from unauthorized disclosure during storage or transmission.

The term “anonymity” refers to a property by which personal identifiers or directly identifying information are removed or obscured so that data cannot be readily associated with a specific user.

The term “heartbeat message” refers to a periodic message transmitted by a node to indicate its operational state, including liveness and optionally resource status.

The term “redundant path” refers to an alternative communication or processing route that can be used if a primary path fails or degrades.

The term “failover control” refers to logic and operations that detect a fault or degradation in a node or path and switch processing or communication to a redundant node or path.

The term “availability” refers to the ability of the system to continue providing its services and processing tasks correctly within required time constraints, even in the presence of faults or resource fluctuations.

In one embodiment, a distributed information processing system includes at least one server as a centralized processing node and a plurality of terminals as terminal-side nodes interconnected through a communication network. The server and each terminal include at least one processor, a main memory, a non-volatile storage device, and a communication interface. The server further includes one or more hardware accelerators, such as graphics processing units or matrix computation accelerators, suitable for executing a large generative AI model. The terminals may include mobile devices, desktop devices, or embedded computing devices with limited but non-trivial computing resources.

The server executes a server operating system such as a server-class operating system and runs application server software, a web server component, a database management component, and a deep learning framework such as a generic tensor computation framework.

The server stores a generative AI model that may be implemented as a large transformer-based neural network with multiple self-attention layers, feedforward layers, and layer normalization components. The terminals execute a client-side operating system and a client application that implements user interaction, local emotion estimation, local preprocessing, and communication with the server. The terminals may use a mobile deep learning runtime such as a compact tensor inference engine or a mobile neural network library to run lightweight neural networks for emotion estimation and partial tasks.

The server manages a database or structured data store that keeps session records, task graphs, resource information of nodes, partial processing results, and final output data. The server stores, for each session, a current prompt sentence, corresponding emotion metadata including at least one emotion label and one or more emotion intensity indicators, as well as resource information received from the terminals. The server also maintains configuration data describing available nodes, their communication endpoints, and their capabilities.

The terminal obtains a prompt sentence as natural language text through a user interface component. The user interacts with the terminal by typing on a touchscreen or keyboard, speaking into a microphone, or capturing images or documents via a camera. The terminal uses an operating system input API to obtain text strings, audio buffers in pulse-code modulation format, and image buffers in a standard pixel format. The terminal encapsulates these pieces of data in a structured input object maintained in its main memory.

The terminal estimates the user's emotional state by executing one or more neural network models locally. For text-based emotion estimation, the terminal uses a tokenizer implementing a subword segmentation method such as a wordpiece or sentence piece algorithm. The terminal converts the prompt sentence into a sequence of token identifiers and feeds this sequence into a compact transformer-based classifier that has fewer layers and reduced hidden dimension compared to the server-side model. The terminal executes a forward pass on this classifier to compute a vector of logits over predefined emotion categories. The terminal applies a softmax operation to the logits to obtain emotion probabilities and then selects a primary emotion label and probability as text-based emotion information.

For voice-based emotion estimation, the terminal computes short-time Fourier transforms on overlapping windows of the recorded audio and derives spectrograms. The terminal converts the spectrograms into feature vectors such as mel-frequency cepstral coefficients or log-mel filter bank coefficients. The terminal feeds these feature vectors into a recurrent neural network, such as a multi-layer long short-term memory network or a gated recurrent unit network, or into a temporal convolutional network trained to classify emotion from acoustic patterns. The terminal obtains probabilities for emotion labels and extracts a corresponding audio-based emotion label and intensity indicator.

For image-based emotion estimation, the terminal performs face detection using a classical object detection algorithm or a lightweight convolutional neural network. The terminal crops detected facial regions, normalizes pixel values, and resizes them to a fixed input size. The terminal feeds these normalized face images into a convolutional neural network with multiple convolutional, pooling, and fully connected layers that has been trained on labeled facial expression datasets. The terminal obtains probabilities over a set of expression categories mapped to emotions and extracts an image-based emotion label and score.

The terminal aggregates the text-based, voice-based, and image-based emotion information using a multimodal fusion function. The terminal may weight each modality based on signal quality metrics, such as signal-to-noise ratio for audio or occlusion level for images. The terminal computes a weighted sum of probability vectors from each modality and then selects one or more dominant emotion labels and corresponding numeric scores. The terminal constructs emotion metadata as a structured object including at least one label and one or more intensity indicators. By performing this fusion directly on the terminal hardware using optimized tensor operations, the system reduces server load and network traffic that would otherwise be required to transmit raw high-volume media data to the server.

The terminal also obtains resource information describing the current computational and communication state of the terminal. The terminal queries the operating system for processor utilization metrics, memory utilization, network connectivity status, and power information such as battery state and power-saving mode. The terminal aggregates these metrics into a structured resource information object. The terminal then transmits, through an encrypted communication channel, a request that includes the prompt sentence, the emotion metadata, and the resource information to the server. The use of structured data with explicit fields reduces the overhead of parsing and supports deterministic scheduling decisions at the server.

The server receives the request via a communication interface. The server's web server component terminates a secure communication protocol, such as a transport layer security session, and passes the decrypted payload to an application server component. The server parses the structured request using a structured data parser and creates a session structure in main memory. The server stores the prompt sentence, emotion metadata, resource information, user identifier, and session identifier in a session table in the database. This persistent representation enables the server to correlate subsequent messages with the same session and to adapt behavior over time.

The server analyzes the prompt sentence using a natural language processing module. The server applies sentence segmentation and tokenization to the prompt sentence, and optionally uses a classifier or rule-based analyzer to determine the task type, such as document summarization, explanation of a mathematical expression, analysis of sensor values, or evaluation of an image set. The server uses the emotion metadata to compute an emotion priority value, for example by applying a function that increases priority for anxiety or confusion states and decreases priority for neutral states. The server uses this priority value in subsequent scheduling.

The server generates a modified prompt sentence for controlling the generative AI model. The server composes this modified prompt sentence from a base system prompt and additional instructions determined from the emotion metadata and the task type. For example, when the emotion label indicates anxiety with high intensity, the server appends instructions such as: “State the main conclusion first in one or two simple sentences. Avoid technical terms as much as possible. Then provide three short reasons in plain language. After that, provide an optional detailed explanation for users who want more depth.” The server inserts the user's original prompt sentence and any relevant context or document references into this structure. The server stores the modified prompt sentence as part of an internal task configuration. The server decomposes the processing associated with the modified prompt sentence into a plurality of subtasks. The server analyzes an internal representation of the generative AI model's computation graph as provided by the deep learning framework and identifies potential segmentation points, such as separate passes for conclusion generation, reason enumeration, and detailed elaboration. The server maps these segments to conceptual subtasks and constructs a task graph where nodes represent subtasks and edges represent dependencies. For example, a conclusion-presentation subtask may be independent of a detailed-explanation subtask, but a reasons subtask may depend on the conclusion. The server may also define subtasks for preprocessing, such as extracting structured numerical features from large sensor datasets or generating compressed representations of images.

The server determines allocation of subtasks among nodes by using both resource information and emotion priority. The server collects up-to-date resource information for each node from a resource store that aggregates periodic reports from terminals and internal worker nodes.

The server defines a scheduling evaluation function that combines computation capacity metrics, memory headroom, communication latency, available bandwidth, and power state with the emotion priority value. The server computes a scheduling evaluation value for each subtask-node pair and selects the node with the highest evaluation value as the allocation destination node for that subtask. By including the emotion priority in the scheduling evaluation, the server can route time-critical subtasks arising from emotionally urgent prompts to nodes that provide lower latency or higher throughput, thereby improving response time for those cases.

The server causes each node to execute its allocated subtasks using local software modules. For subtasks running on the terminals, the server transmits a subtask description that includes a subtask identifier, task type, references to input data, an associated modified prompt sentence (when relevant), and an expected output schema. The terminal receives this description and creates a local job record, which is stored in main memory and optionally persisted in local storage. The terminal then selects appropriate local algorithms to implement the subtask. For example, if the subtask is a preprocessing task for sensor data, the terminal loads raw data from local persistent storage, performs normalization, outlier removal using statistical thresholds, and feature extraction by computing metrics such as moving averages, variance, or domain-specific indices. The terminal produces a structured feature vector as a partial processing result.

For subtasks that require running a lightweight generative model or classifier on the terminal, the terminal uses a locally stored neural network model that comprises fewer layers or reduced hidden size compared to the server model. The terminal executes inference using this model and the modified prompt sentence or local features, generating a coarse summary or an approximate decision. The terminal encapsulates the result with the subtask identifier and transmits it back to the server through the encrypted communication channel.

The server executes the subtasks allocated to internal workers, including running the main generative AI model. The server uses the deep learning framework to load model parameters into device memory of a hardware accelerator. The generative AI model may be implemented as an encoder-decoder transformer network with multiple layers of multi-head attention, positional encoding, and feedforward sublayers. The server performs inference by providing the modified prompt sentence as tokenized input, optionally augmented with additional context vectors representing preprocessed sensor features or image embeddings. The server may use beam search or nucleus sampling algorithms with specific hyperparameters, such as beam width or sampling temperature, to control diversity and quality of generated text.

The server collects partial processing results returned by terminals and internal workers. The server stores each partial result in a results table keyed by session identifier and subtask identifier. The server may compute a hash over each result for integrity verification. Once all required subtasks in the task graph have reached a completed state, the server retrieves the corresponding partial results and the output of the generative AI model. The server passes these to a result integration module.

The server integrates these outputs into final output data that is structured according to the emotion metadata. The server uses an internal rule engine or a smaller formatting model to stitch together textual segments, ensuring that, for users with high anxiety or confusion, the conclusion part appears first, formatted as a short, clear statement, followed by a reason-explanation part with a fixed number of short bullet points, and then a detailed-explanation part that can be longer and more technical. For users with neutral or expert-level emotion metadata, the server may alter the structure to include more technical details earlier. The server also normalizes terminology and phrasing as needed using lexical substitution rules or a compact rephrasing model.

The server constructs final output data as a structured object containing at least a conclusion part, a reason-explanation part, and a detailed-explanation part, along with associated metadata. The server serializes this structure into a structured data format such as a key-value based text representation and transmits it to the terminal via an encrypted channel. By performing this assembly on the server where all partial results and model outputs are available, the system can ensure a consistent and coherent final response while leveraging the high-performance hardware of the centralized node.

The terminal receives the final output data and emotion metadata and applies a presentation policy determined by emotion-aware rules. The terminal may render the conclusion part in a larger font at the top of the display, with a calm color scheme when the emotion label indicates anxiety, and may present the detailed-explanation part within a collapsible section that the user can expand on demand. The terminal may also use a text-to-speech engine to speak the conclusion part and reasons aloud. The user may then input another prompt sentence to continue the interaction.

Specific examples of prompt sentences that the user may input include, but are not limited to:

“Please summarize this long report in a way that is easy to understand for a beginner.”

“From this farmland sensor data, tell me whether irrigation is needed.” “Explain the proof of this equation in an easy-to-understand way.”

“Tell me the recent trend from this sales data.”

“Evaluate the crop health status in this area based on these images.”

“Decide whether irrigation is necessary based on this soil moisture data.”

In these examples, the system may also process real-world sensor data, such as soil moisture readings, temperature logs, or crop imagery from cameras or drones. The terminal or server can extract numerical features from such data and feed them as additional inputs to either a specialized decision model or to the generative AI model as context. The server may apply threshold-based rules or trained classifiers to derive intermediate decisions, and then use the generative AI model to generate an explanation in natural language tailored to the emotion metadata. This integration of sensor-driven decision making with emotion-aware prompt modification and distributed processing yields technical benefits in the form of reduced latency for time-critical decisions, improved data throughput, and efficient utilization of both server and terminal resources.

In another embodiment, the generative AI model is trained using supervised learning on large corpora of text or multimodal data. The server, during model training, uses a loss function such as cross-entropy between predicted token distributions and ground truth tokens, and optimizes model parameters using a gradient-based optimization algorithm such as stochastic gradient descent with momentum or an adaptive optimizer. The server may use data augmentation techniques such as paraphrasing or back-translation to increase diversity of training examples. The server may also fine-tune the model on datasets annotated with emotion-related instructions, so that the model learns to respond differently to prompts containing specific constraint conditions. By training the model in this way, the system can achieve improved coherence and sensitivity in its outputs while maintaining robust performance.

In yet another embodiment, the server implements alternative scheduling and task decomposition strategies. The server may use a graph-partitioning algorithm to split the task graph into clusters that can be executed on different nodes with minimal cross-node data transfer. The server may also consider network topology and historical performance logs to refine the scheduling evaluation function. For example, the server may penalize nodes that frequently fail or report high packet loss, thereby improving reliability of the distributed system. The server may further adjust subtask granularity depending on current load; when many sessions are active, the server may define smaller subtasks to increase scheduling flexibility.

The described system improves computer technology itself rather than merely automating human mental steps. By defining an emotion-aware scheduling metric and integrating it directly into the resource-based task allocation logic, the server makes non-obvious decisions about where and when to run which subtasks, leading to measurable reductions in end-to-end latency and more stable tail latency distributions under heavy load. By offloading well-defined subtasks to terminals equipped with lightweight inference engines, the system reduces central server load and network bandwidth usage, which improves scalability. The use of a task graph with explicit dependencies and the combination of partial processing results with generative model outputs yields predictable and controllable system behavior. These technical effects are realized through specific data structures, algorithms, and hardware-software cooperation described above, and not merely through a change in business rules or human workflow.

Although certain embodiments have been described with a particular generative AI architecture, emotion estimation pipeline, and scheduling policy, variations are possible. The server may use different neural network architectures, such as recurrent networks, convolutional networks, or hybrid models, and different loss functions or optimization algorithms during training. The terminal may use simpler or more complex emotion estimators depending on available resources. The scheduling evaluation function may incorporate additional metrics, such as energy consumption or historical fault rates. All such variations that operate within the scope of distributing subtasks across nodes based on resource information and emotion-aware priority, generating modified prompt sentences for a generative AI model, and integrating partial results into structured final output data are considered to fall within the embodiments for implementing the invention.

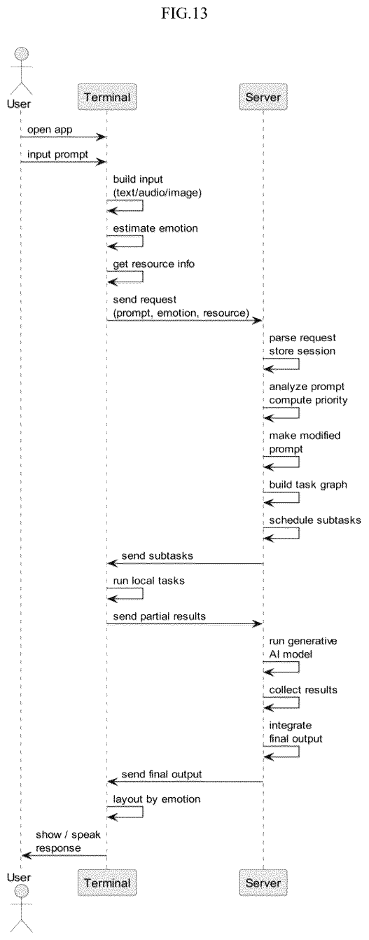

The following describes the processing flow using FIG. 13.

### Step 1:

The user operates the terminal and starts a client application that presents an input interface.

The terminal initializes user interface components using an operating system UI framework and displays a text input field, a microphone button, and an image attachment control.

Input: no user data (initial state).

Output: an active input screen on the terminal that can accept a prompt sentence, voice input, or image input.

### Step 2:

The user inputs a prompt sentence such as “Please summarize this long report in a way that is easy to understand for a beginner.” or “Decide whether irrigation is necessary based on this soil moisture data.”

The terminal calls keyboard input APIs to read typed characters into a text buffer, or calls audio APIs to record voice into an audio buffer, or calls camera APIs to capture an image buffer.

Input: user actions on the UI (key strokes, microphone activation, camera activation).

Output: a user input object on the terminal containing at least one of a text string (prompt sentence), an audio buffer, and an image buffer.

### Step 3:

The terminal performs text-based emotion estimation by processing the prompt sentence. The terminal takes the prompt sentence from the user input object, applies a tokenizer that converts the text into a sequence of token IDs, and feeds the token IDs into a lightweight transformer-based classifier running on a mobile inference engine.

The terminal executes a forward pass through embedding layers, self-attention layers, and a classification head to compute logits and applies a softmax function to obtain emotion probabilities over predefined labels.

Input: prompt sentence as a text string.

Output: a text-based emotion probability vector and a primary text-based emotion label with a probability score.

### Step 4:

The terminal performs audio-based emotion estimation when an audio buffer is present.

The terminal segments the audio buffer into overlapping frames, applies a short-time Fourier transform to each frame, and computes spectrograms.

The terminal extracts features such as mel-frequency cepstral coefficients from the spectrograms and feeds the feature vectors into a recurrent neural network or temporal convolutional network deployed on a mobile inference engine.

The terminal executes the network to obtain logits per emotion class, applies a softmax, and produces a distribution over emotion labels.

Input: audio buffer from the microphone.

Output: an audio-based emotion probability vector and a primary audio-based emotion label with a probability score.

### Step 5:

The terminal performs image-based emotion estimation when an image buffer is present.

The terminal applies a face detection algorithm to the image, crops the facial region, normalizes pixel values, and resizes the image to a fixed size.

The terminal feeds the processed face image into a convolutional neural network with multiple convolution and pooling layers to classify facial expression into emotion labels.

The terminal computes a probability vector over emotion labels and selects the most likely label and score.

Input: image buffer from the camera.

Output: an image-based emotion probability vector and a primary image-based emotion label with a probability score.

### Step 6:

The terminal fuses multimodal emotion information into unified emotion metadata.

The terminal takes the text-based, audio-based, and image-based probability vectors, assigns weights based on modality reliability (for example, lowering the weight for noisy audio), and computes a weighted sum to form a fused probability vector.

The terminal selects a dominant emotion label corresponding to the maximum value in the fused vector and records its value as an emotion intensity indicator.

Input: text-based, audio-based, and image-based emotion probability vectors.

Output: emotion metadata including at least one emotion label and one or more emotion intensity indicators.

### Step 7:

The terminal collects local resource information.

The terminal queries operating system APIs to obtain current CPU utilization, memory usage, network connectivity status (for example, signal strength, latency estimate), and power state (for example, battery level and charging state).

The terminal aggregates these numerical values into a structured resource information object.

Input: low-level resource counters and status information from the OS.

Output: a resource information object containing numerical metrics for CPU, memory, communication, and power resources.

### Step 8:

The terminal builds a request message to send to the server.

The terminal combines the prompt sentence, emotion metadata, and resource information into a structured data object and serializes it into a text-based structured format using a serialization library.

The terminal attaches user and session identifiers managed by the client application.

Input: prompt sentence, emotion metadata, resource information, user ID, and session ID.

Output: a serialized request payload ready for transmission to the server.

### Step 9:

The terminal transmits the request to the server through an encrypted communication channel.

The terminal establishes or reuses a secure connection using a transport layer security protocol, sets up an HTTP or remote procedure call request with the serialized payload as a body, and sends it over the network interface.

Input: serialized request payload.

Output: an outbound network packet stream containing the request delivered to the server.

### Step 10:

The server receives and parses the request from the terminal.

The server's network stack and web server component terminate the secure protocol, extract the request body, and pass it to an application server.

The server uses a structured data parser to deserialize the payload into an internal request object containing the prompt sentence, emotion metadata, resource information, user ID, and session ID.

Input: decrypted request payload from the network.

Output: a server-side request object in memory that represents the user's prompt and context.

### Step 11:

The server records and updates a session state based on the request.

The server takes the user ID and session ID from the request object, looks up a corresponding session record in a database, and inserts or updates the record with the current prompt sentence, emotion metadata, and timestamp.

The server may also store the terminal's resource information for later scheduling decisions.

Input: server-side request object.

Output: an updated session record and an in-memory session context used for subsequent processing.

### Step 12:

The server analyzes the prompt sentence to determine task characteristics.

The server applies a natural language processing pipeline to the prompt sentence, including sentence segmentation, tokenization, and possibly a task-type classification using a smaller classifier model or rule set.

The server determines whether the prompt is a summarization request, an explanation request, a sensor data analysis request, or another supported task type.

Input: prompt sentence from the request object.

Output: a task-type label and a parsed representation of the prompt used for task decomposition.

### Step 13:

The server computes an emotion priority value from the emotion metadata.

The server reads the emotion label and intensity indicators and applies a predefined mapping function that converts emotion scores into a numeric priority value.

For example, the server may assign higher priority to anxiety or confusion with high intensity and lower priority to neutral or low-intensity states.

Input: emotion metadata from the request object.

Output: a numeric emotion priority value that influences scheduling and response shaping.

### Step 14:

The server generates a modified prompt sentence to control the generative AI model.

The server combines a base system prompt with instructions derived from the emotion label and task type, such as “state the conclusion first,” “avoid technical terms,” or “limit the number of reasons.”

The server inserts the user's original prompt sentence and any referenced documents or data summaries into this template to form a single, coherent modified prompt sentence.

Input: original prompt sentence, task-type label, and emotion metadata.

Output: a modified prompt sentence tailored for the generative AI model.

### Step 15:

The server decomposes the processing into multiple subtasks and builds a task graph.

The server analyzes the generative AI model's computation graph and predefined templates for task types, and defines subtasks such as a conclusion-presentation subtask, a reason-explanation subtask, a detailed-explanation subtask, and one or more preprocessing subtasks.

The server constructs a task graph data structure where each subtask is a node and edges represent required execution order or data dependencies.

Input: task-type label, parsed prompt, and generative model configuration.

Output: a task graph including a list of subtasks, their types, and their dependencies.

### Step 16:

The server collects resource information for all available nodes.

The server queries an internal resource store that holds periodic reports from terminals and server-side worker nodes and aggregates CPU headroom, memory headroom, network latency, bandwidth, and power metrics for each node.

The server organizes this into a resource table indexed by node identifier.

Input: resource store entries from nodes, including the resource information from the requesting terminal.

Output: a consolidated resource table representing the current resource state across all nodes.

### Step 17:

The server calculates scheduling evaluation values for subtask-node combinations.

The server applies a scheduling function that takes, as input, for each subtask and each node, the node's resource metrics and the emotion priority value.

The server computes a numeric evaluation value that reflects suitability of assigning that subtask to that node, giving extra weight to low-latency, high-capacity nodes for high-priority subtasks.

Input: task graph, resource table, and emotion priority value.

Output: a matrix or list of evaluation values for each subtask-node pair.

### Step 18:

The server determines allocation destination nodes for each subtask.

The server selects, for each subtask, the node with the highest scheduling evaluation value that satisfies any additional constraints (for example, data locality or model availability).

The server records the selected node identifiers in a task assignment table that maps each subtask ID to a node ID.

Input: evaluation values for subtask-node pairs.

Output: a task assignment table specifying an allocation destination node for each subtask.

### Step 19:

The server dispatches subtasks to assigned nodes.

The server creates, for each subtask, a subtask message containing the subtask identifier, subtask type, input data references, the associated modified prompt sentence if needed, and an expected output schema.

The server serializes each subtask message and transmits messages for terminal-assigned subtasks through secure connections, while enqueuing server-assigned subtasks on internal worker queues.

Input: task assignment table and task graph.

Output: distributed subtask messages residing on terminals and server worker queues.

### Step 20:

The terminal receives and registers assigned subtasks.

The terminal's communication module accepts incoming subtask messages, deserializes the payloads into internal subtask objects, and places them into a local work queue managed in main memory.

Input: subtask messages from the server.

Output: a local work queue containing subtask objects ready for execution on the terminal.

### Step 21:

The terminal executes local preprocessing subtasks on sensor or image data.

The terminal retrieves a preprocessing subtask from the work queue, loads referenced data from local storage or sensors, and performs operations such as normalization, outlier filtering, aggregation, or image resizing and feature extraction using numerical libraries or small neural networks.

The terminal transforms raw input values into structured feature vectors or compressed representations suitable for further processing.

Input: raw sensor readings or images referenced by the preprocessing subtask.

Output: a partial processing result containing preprocessed feature vectors or reduced data.

### Step 22:

The terminal executes lightweight inference subtasks.

The terminal retrieves a lightweight inference subtask, loads a compact neural network model from local storage into memory, and supplies the modified prompt sentence and any local features as input.

The terminal runs inference in a mobile inference engine and produces a preliminary summary, classification result, or other intermediate textual or numeric output.

Input: modified prompt sentence and preprocessed features for the lightweight subtask.

Output: a partial processing result containing a simple summary, decision flag, or classification score.

### Step 23:

The terminal returns partial processing results to the server.

The terminal wraps each partial processing result with its subtask identifier and node identifier, serializes the data into a structured format, and transmits it back to the server over the encrypted communication channel.

Input: partial processing results from executed subtasks.

Output: one or more response messages sent to the server containing partial results.

### Step 24:

The server executes server-side subtasks including the main generative AI model.

The server dequeues server-assigned subtasks, loads the necessary components of the generative AI model into accelerator memory, and encodes the modified prompt sentence into token sequences.

The server performs forward passes through layers of the transformer network and uses a decoding strategy such as beam search or sampling to generate natural language tokens that form the conclusion, reasons, or detailed explanation segments, depending on the subtask definition.

Input: modified prompt sentence and any server-local data references.

Output: server-side partial processing results including generative AI model outputs for designated subtasks.

### Step 25:

The server collects and stores all partial processing results.

The server receives partial results from the terminals and retrieves results from local worker modules, checks integrity via hash or length checks, and writes them into a results table keyed by session ID and subtask ID.

The server updates the status of each subtask in the task graph to “completed” when its corresponding result is stored.

Input: partial processing results from terminals and server workers.

Output: a populated results table and an updated task graph state for the session.

### Step 26:

The server determines when all required subtasks are complete.

The server examines the task graph and verifies that all subtasks required for constructing the final response (for example, conclusion-presentation, reason-explanation, detailed-explanation, and required preprocessing tasks) have completed.

If any required subtasks are missing or failed, the server may reschedule them or adjust the response structure accordingly.

Input: task graph state and results table.

Output: a decision to proceed with final integration and a list of available partial results.

### Step 27:

The server integrates the generative AI outputs and partial results into structured final output data.

The server takes the conclusion text, reason explanations, and detailed explanation segments from the results table, arranges them according to rules derived from the emotion metadata, and stitches them into a coherent multi-part response.

The server organizes the content into clearly separated sections (for example, “Conclusion,” “Reasons,” “Details”) and may adjust wording using lexical rules or a small formatting model to ensure consistency and clarity.

Input: partial processing results and emotion metadata.

Output: final output data as a structured object with at least a conclusion part, a reason-explanation part, and a detailed-explanation part.

### Step 28:

The server serializes and transmits the final output data to the terminal.

The server converts the final output structure into a serialized representation, constructs a response message that includes the session ID and status, and sends the message over the encrypted communication channel to the terminal.

Input: final output data object and session context.

Output: a network response containing the final structured output delivered to the terminal.

### Step 29:

The terminal receives and parses the final output data.

The terminal deserializes the response payload into an internal object representing the conclusion, reasons, and details, and associates it with local emotion metadata for the session.

The terminal prepares this data for rendering by mapping each section to a UI element or component.

Input: serialized final output message from the server.

Output: an internal representation of the final output data ready for presentation.

### Step 30:

The terminal determines a presentation layout based on emotion metadata and displays the response.

The terminal examines the emotion label and intensity indicators, decides on a display order and emphasis style (for example, placing the conclusion at the top in a large font and folding details in a collapsible section for a highly anxious user), and configures UI widgets accordingly.

The terminal renders the customized layout on the display and, if enabled, invokes a text-to-speech engine to read out key parts of the response.

Input: final output data object and emotion metadata.

Output: a visible and/or audible presentation of the response that the user can perceive and interact with.

### Application Example 2

Description follows regarding a flow of the specific processing in an Application Example 2. The units of the system described below are implemented by the data processing device 12 and the smart device 14. The data processing device 12 is called a “server” and the smart device 14 is called a “terminal”.

In large-scale urban environments, computing systems are increasingly required to process heterogeneous data streams originating from distributed sensors, infrastructure controllers, and user devices. Conventional smart-city platforms are typically architected as centralized or loosely distributed server systems that consume objective state data such as traffic counts, environmental measurements, and energy usage. These systems then execute predefined optimization algorithms or rule sets to adjust infrastructure control parameters. However, such architectures exhibit several technical limitations from a computer-technology standpoint.

First, existing systems generally treat user-related information, such as feedback or complaints, as coarse, low-frequency inputs that are manually collected and processed offline. They do not continuously integrate fine-grained, multimodal emotion data (e.g., facial expressions, speech signals, subjective ratings) into the core computational pipeline. As a result, the computation graph for analytics and control is driven almost exclusively by objective telemetry, without a structured representation of user emotional states. The computing system therefore lacks an internal prioritization signal that reflects real-time user dissatisfaction or stress, and task scheduling remains insensitive to user-centric conditions. Second, conventional distributed AI and analytics frameworks typically perform task distribution and load balancing based only on resource metrics, such as CPU usage, memory usage, and network bandwidth. That is, the scheduler is designed to maximize throughput or resource utilization, but it does not take into account dynamically computed “importance” or “urgency” values derived from the semantics of the data being processed. As a consequence, the platform may allocate considerable computation to analytically interesting but low-impact regions, while starving analysis for locations where users are experiencing significant frustration. This leads to suboptimal use of computation resources from the standpoint of system responsiveness and quality of service.

Third, existing generative AI integrations in control systems are typically implemented as ad-hoc, application-level wrappers that send loosely defined textual queries to a generative AI model and then manually interpret the results. The prompt construction logic is often static, handwritten, and decoupled from the underlying data model and task graph. Likewise, the extraction of actionable control parameters from generative outputs is brittle and not integrated as a first-class component of the computational pipeline. This results in unreliable, non-repeatable behavior, and it prevents the generative AI model from being systematically embedded into the distributed control loop.

Fourth, current systems do not provide an integrated mechanism that simultaneously (i) captures multimodal emotion signals at edge devices, (ii) fuses those signals with objective state data into a machine-readable, time-space indexed representation, (iii) uses the fused representation to compute task priorities for distributed analytics, and (iv) automatically generates structured natural-language prompt sentences and parses generative AI outputs into machine-executable control commands. Instead, each of these functions, if present at all, is implemented in isolation, which leads to increased latency, duplicated processing, and inconsistent state management across components.

Fifth, because smart-city platforms operate over massive, continuously updated datasets, the above limitations also manifest as concrete computer-system issues: saturation of central processing nodes, frequent bottlenecks in single-point task schedulers, inefficient use of network bandwidth, and difficulty in preserving low latency for critical analytics. Adding emotion data exacerbates these problems if the system is not architected to exploit such data as a computational steering signal. In addition, integrating generative AI services introduces further challenges in orchestration, as prompt generation, model invocation, and response post-processing add new dependencies and potential failure points that must be managed in a distributed environment.

Furthermore, emotion data inevitably carries privacy-sensitive user information. Conventional distributed analytics frameworks often treat all input streams uniformly from a security and availability standpoint, lacking specialized mechanisms for consistent encryption, anonymization, replicated storage, and failover tailored to multimodal emotion and urban-state data. This leads to increased risk of data leakage, difficulty in maintaining robust fault tolerance, and complex, ad-hoc implementations of security and redundancy at the application layer.

Accordingly, there is a need for an improved computer-implemented architecture that augments a distributed AI protocol with (i) edge-assisted, multimodal emotion recognition, (ii) server-side fusion of emotion indices with objective urban state data, (iii) priority-aware task generation and distributed scheduling that exploit these fused indices, and (iv) an integrated prompt-generation and command-derivation mechanism for a generative AI model. Such an architecture should improve the technical performance of the computing system itself—by steering computation resources to high-impact tasks, by embedding the generative AI model as a structured component of the control loop, and by providing built-in security and availability mechanisms for the combined emotion and state data streams.

The specific processing by the specific processing unit 290 of the data processing device 12 in Application Example 2 is realized by the following means.

The present invention provides a server comprising a processor configured to receive, from user terminals, multimodal user data including image information from an imaging device, audio information from an audio input device, location information from a location acquisition device, and subjective evaluation input information from a user interface, to perform, at the edge or at the server, signal processing and feature extraction on the image information and the audio information using lightweight inference models, to convert the subjective evaluation input information into numerical values, to generate an emotion index vector representing an emotional state of a user, and to associate the emotion index vector with infrastructure identification information based on the location information, to collect urban state data including traffic information, environment information, energy information, and equipment operation information from distributed infrastructure devices, to store the urban state data in association with the emotion index vector in a time- and space-correlated manner as integrated urban state data, to compute, from the integrated urban state data, objective indicators and subjective indicators for each infrastructure unit and generate an integrated view for each infrastructure unit, to generate, from the integrated urban state data, analysis tasks for respective infrastructure units, to calculate, for each analysis task, a task priority based at least on the objective indicators and the emotion index vector, to create task information including the task priority, to obtain resource usage information from a plurality of computation nodes, to perform task scheduling based on the task priority and the resource usage information so as to dynamically allocate the analysis tasks to the plurality of computation nodes, to cause each computation node to execute, in accordance with an allocated analysis task, data computations such as traffic flow analysis, energy consumption analysis, or environment evaluation using the integrated urban state data and to receive task results produced by the computation nodes, to generate, based on the integrated urban state data and the task results, a prompt sentence for a generative AI model by extracting description elements including infrastructure identification information, objective indicator values, emotion index values, and optimization objectives and by constructing a natural-language sentence according to predetermined templates or rules, to input the prompt sentence into the generative AI model, to receive proposal information output from the generative AI model, to parse the proposal information to extract specific control parameters for infrastructure control, to convert the control parameters into structured control commands interpretable by infrastructure control devices, and to transmit the control commands to the infrastructure control devices, and to execute security and availability operations including encrypting transmissions of the emotion index vector and the urban state data, anonymizing user identification, enforcing access control, and replicating and backing up the integrated urban state data, the emotion index vector, and the task results across multiple storage devices or nodes so as to enable failover and recovery in case of failures. This enables the computer system to use user-derived emotion indices as internal scheduling and control signals that guide distributed analysis tasks, to tightly integrate generative AI-based decision synthesis into the distributed AI protocol, to reduce end-to-end latency and improve throughput by prioritizing high-impact computations, and to provide a robust, secure, and fault-tolerant infrastructure for continuous, emotion-aware urban control.

The term “processor” refers to a hardware processing unit or a combination of hardware processing units, such as one or more central processing units, graphics processing units, or specialized accelerators, that execute instructions to perform the functions described herein.

The term “node” refers to a computing entity participating in a distributed system, including but not limited to servers, edge devices, gateways, or user terminals, that can receive tasks, execute computations, and exchange data over a communication network.

The term “communication network” refers to a wired or wireless data communication infrastructure that enables data exchange between a plurality of nodes, including local area networks, wide area networks, and public or private packet-switched networks.

The term “user terminal” refers to a user-operated computing device equipped with at least a display, an input interface, a communication interface, and one or more sensors, such as a camera, microphone, and location sensor, and configured to execute applications that interact with a server.

The term “imaging device” refers to a sensor module, such as a camera or image sensor, configured to capture still images or video frames representing a scene including a user's face or surroundings.

The term “audio input device” refers to a sensor module, such as a microphone or microphone array, configured to capture acoustic signals including speech and environmental sounds.

The term “location information acquisition device” refers to a hardware component or combination of components, such as a global positioning system receiver, network-based location module, or inertial sensor, configured to obtain geographic position data and related timing information.

The term “user interface” refers to a software and/or hardware mechanism on a user terminal that presents information to a user and receives inputs from the user, including graphical user interfaces, touch interfaces, and input controls such as buttons and text fields.

The term “subjective evaluation input information” refers to user-provided data expressing personal assessments or feelings, including but not limited to selected rating values, scale inputs, and free-form text comments describing perceived comfort, dissatisfaction, or other user experiences.

The term “signal processing and feature extraction” refers to computational operations applied to raw sensor data, such as filtering, normalization, transformation, or detection, to derive structured feature representations suitable for further analysis by models or algorithms.

The term “emotion index” refers to one or more numerical values or vectors computed from multimodal input data, representing estimated emotional states of a user, including, for example, anger, dissatisfaction, stress, comfort, or satisfaction levels.

The term “emotion index vector” refers to a multi-dimensional numerical representation of one or more emotion indices, each dimension corresponding to a specific emotional attribute or metric.

The term “urban infrastructure” refers to physical and cyber-physical systems deployed in an urban environment, including but not limited to roads, intersections, traffic signals, lighting installations, buildings, energy supply systems, transportation systems, and environmental monitoring systems.

The term “infrastructure identification information” refers to data that uniquely or quasi-uniquely identifies a unit of urban infrastructure, such as an intersection identifier, building identifier, or area identifier associated with a geographic region.

The term “urban state data” refers to data representing objective states of urban infrastructure and its use, including but not limited to traffic flow measurements, environmental conditions, energy consumption, and operational states of equipment.

The term “traffic information” refers to data describing vehicular or pedestrian movements and control states, including vehicle counts, flow rates, speeds, queue lengths, and signal phase information.

The term “environment information” refers to data describing environmental conditions in an urban area, including temperature, humidity, illuminance, noise level, and similar measurements.

The term “energy information” refers to data describing consumption, generation, or distribution of energy resources, including electric power usage, heating and cooling loads, and renewable energy output.

The term “equipment operation information” refers to data describing operating states or control settings of devices within the urban infrastructure, such as on/off states, setpoints, modes, and measured performance parameters.

The term “integrated urban state data” refers to data structures or records in which urban state data and emotion index data are stored in association with each other and with time and location attributes, enabling combined analysis of objective and subjective indicators.

The term “objective indicators” refers to quantitative measures derived from urban state data, representing observable infrastructure or environmental conditions, such as average waiting time, temperature, noise level, or energy consumption.

The term “subjective indicators” refers to quantitative measures or indices derived from emotion indices or user feedback that capture perceived user experience, such as dissatisfaction level, stress level, or satisfaction level.

The term “integrated view” refers to a representation, typically per infrastructure unit and time interval, that combines objective indicators and subjective indicators into a unified data structure for analysis or control.

The term “analysis task” refers to a unit of computation defined by a task description, which specifies input data, an analysis objective, and processing steps, such as traffic flow analysis, energy optimization analysis, or environmental evaluation, associated with a specific infrastructure unit.

The term “task priority” refers to a numerical or categorical value assigned to an analysis task that reflects at least one of the task's importance or urgency, and that is used to influence scheduling, ordering, or resource allocation among multiple tasks.

The term “task information” refers to a data structure including at least task identification information, target infrastructure identification information, a task type, and a task priority value, and optionally additional metadata required for scheduling and execution.

The term “resource usage information” refers to data indicating current utilization of computational and communication resources of a node, such as central processing unit load, memory usage, and network bandwidth usage.

The term “task scheduling” refers to an algorithmic process that selects and assigns analysis tasks to computation nodes based on specified criteria, such as task priorities and resource usage information, to optimize performance, latency, or resource utilization.

The term “computation node” refers to a node in the distributed system that is capable of executing analysis tasks, including servers, edge devices, or gateways that have access to relevant data and computation resources.

The term “task result” refers to output data produced by a computation node upon completion of an analysis task, including derived metrics, predictions, or recommendations associated with the target infrastructure unit.

The term “generative AI model” refers to a trained artificial intelligence model that, in response to an input prompt sentence, generates output data such as natural-language text, structured information, or recommendations, based on learned patterns from training data.

The term “prompt sentence” refers to a natural-language or structured textual input provided to a generative AI model, containing description elements such as infrastructure identification information, objective indicator values, emotion index values, and optimization objectives, and instructing the model to produce a control proposal or related output.

The term “description elements” refers to specific pieces of information extracted from integrated urban state data and task results, such as identifiers, numeric values, constraints, and goals, that are embedded into a prompt sentence.

The term “proposal information” refers to output generated by a generative AI model in response to a prompt sentence, including one or more proposed control strategies, recommendations, or parameter values for controlling urban infrastructure.

The term “control parameters” refers to values or settings derived from proposal information that directly influence the behavior of infrastructure devices, such as timing values, temperature setpoints, illuminance levels, or schedule definitions.

The term “structured control commands” refers to machine-readable messages or data structures formatted in accordance with a protocol or interface specification of an infrastructure control device, encoding control parameters to be applied by that device.

The term “infrastructure control device” refers to a device or control system that receives control commands and applies corresponding changes to physical or logical infrastructure, such as a traffic signal controller, building management system, or lighting controller.

The term “encryption” refers to cryptographic processing applied to data transmitted or stored in the system, using an encryption algorithm and keys, to prevent unauthorized parties from accessing the underlying information.

The term “anonymization” refers to the processing of data to remove or obfuscate direct identifiers or quasi-identifiers associated with individuals, so that the data cannot reasonably be linked to a specific individual under typical conditions.

The term “access control” refers to mechanisms that regulate which entities or processes are permitted to access particular data, services, or functions, based on policies, authentication, and authorization.

The term “replication” refers to the creation and maintenance of multiple copies of data, such as integrated urban state data, emotion index data, and task results, across different storage devices or nodes to improve reliability and availability.

The term “backup” refers to the periodic or event-driven process of storing copies of data in a separate storage location or medium for the purpose of recovery in case of data loss, corruption, or failure.

The term “failover” refers to an automated or semi-automated process by which a standby system, replica node, or alternative resource takes over the functions of a failed or degraded system component to maintain service continuity.

The term “security and availability operations” refers to system-level processes and mechanisms, including encryption, anonymization, access control, replication, backup, and failover, that together protect data confidentiality, integrity, and availability within the distributed system.

In one exemplary embodiment, a server, a plurality of terminals, and a plurality of infrastructure control devices cooperate to implement the claimed system. The server comprises at least one processor, a main memory, a non-volatile storage device, and a network interface. The terminal comprises at least one processor, a memory, a display, an input interface such as a touch panel, an imaging device, an audio input device, and a location acquisition device. The infrastructure control devices comprise, for example, traffic signal controllers, building management controllers, and lighting controllers, each having a processor, a communication interface, and device-specific actuation hardware.

The server operates under a server-class operating system such as a general-purpose server operating system and executes application software implemented using a server-side application framework, a stream-processing framework, and a database management system.

The server executes, for example, a web application stack using a web server component and an application framework component, a distributed message bus such as a generic streaming platform, and a database management system such as a relational database system. The server also executes a distributed data-processing framework such as a general distributed computation engine for performing large-scale joins and aggregations over urban state data and emotion indices.

The terminal operates under a mobile or embedded operating system and executes an application that provides a graphical user interface, accesses the imaging device and the audio input device, and communicates with the server over a secure network connection such as a transport-layer-secured protocol. The terminal uses a camera framework of the operating system to obtain image frames, an audio input framework to obtain digital audio samples, and a location framework to obtain location coordinates. The terminal uses a software library for image processing such as a general-purpose computer vision library to perform face detection and image pre-processing. The terminal uses a software library for digital signal processing such as a general audio analysis library to compute audio features.

The terminal uses a lightweight inference runtime such as a mobile inference engine to execute a pre-trained convolutional neural network for facial-expression recognition and a pre-trained neural network for speech emotion recognition. The convolutional neural network for facial-expression recognition comprises, for example, several convolutional layers with rectified linear activation functions, pooling layers, and fully connected layers, with a final softmax output layer providing probabilities over multiple emotion categories such as joy, anger, sadness, and anxiety. The speech emotion recognition network comprises, for example, convolutional layers operating on time-frequency features such as Mel spectrograms, followed by fully connected layers that output scores for irritation, anxiety, or calmness.

These networks are trained offline using supervised learning with a cross-entropy loss function and stochastic gradient descent or a variant thereof. During training, the models are optimized to minimize classification errors on labeled emotion datasets. Data augmentation techniques such as random cropping, brightness adjustment, noise injection, and time-stretching may be used to increase robustness.

The terminal receives permission from the user to access sensors and periodically captures image frames and audio samples. The terminal uses the image processing library to detect one or more faces in an image frame via a trained face detector. The terminal extracts a cropped face region and resizes it to a fixed spatial resolution suitable for the facial-expression model.

The terminal normalizes pixel values and passes the resulting tensor to the lightweight inference runtime. The terminal executes the neural network inference locally, obtaining a probability vector that serves as a facial emotion vector. By executing this deep learning model on the terminal instead of transmitting raw images to the server, the system reduces network bandwidth usage and decreases server-side computational load, thereby improving overall latency and scalability compared to a purely centralized architecture.

The terminal similarly processes audio. The terminal records audio segments and converts them from time-domain waveforms into features such as Mel-frequency cepstral coefficients or log-Mel spectrograms. The terminal uses the audio processing library to compute these features and normalizes them. The terminal inputs the features to the speech emotion recognition model through the lightweight inference runtime and receives numerical scores such as irritation level and calmness level. The combination of local feature extraction and on-device neural network inference reduces the amount of data that must be transmitted to the server and enables near-real-time estimation of the user's emotional state.

The terminal presents a user interface that enables the user to provide subjective evaluation inputs. The user can tap a rating button representing perceived comfort or dissatisfaction and can enter free-form text comments describing the user's experience in the current context, for example, an intersection or an office floor. The terminal maps the rating to a numerical score and stores the comment in text form. The terminal accesses the location acquisition device to obtain geographic coordinates and time information and uses a locally cached mapping table or a server query to determine infrastructure identification information such as an intersection identifier or a building identifier corresponding to the location.

The terminal generates an anonymous user identifier by applying a cryptographic hash function such as a secure hash function to a device-specific identifier and optionally a random salt, thereby preventing direct association of the data with the user's identity. The terminal constructs a data record containing the anonymous identifier, the facial emotion vector, the audio emotion scores, the subjective rating, the text comment, the infrastructure identification information, the location coordinates, and associated timestamps. The terminal serializes the data record as a structured message, for example, a structured text representation, and transmits it to the server using a secure communication protocol with encryption and server authentication. This design improves data privacy and reduces the risk of interception of sensitive emotion information.

The server receives the transmitted records via the web application framework, parses the messages, and validates fields for type consistency and range constraints. The server stores validated records in a database as raw feedback entries. The server publishes references to these entries on a streaming platform so that multiple analytical components can consume them concurrently. This architecture allows the server to decouple ingestion from downstream processing and to scale horizontally by adding additional processing instances.

The server performs text emotion analysis using a natural language processing library and a language model such as a bidirectional transformer model fine-tuned for sentiment and emotion classification. The server first tokenizes input text using a morphological analyzer, segments the text into tokens, and then maps tokens to embeddings suitable for the language model. The server applies the language model to obtain contextual embeddings and passes them through classifier layers that output scores for sentiment polarities and specific emotional attributes such as anger or dissatisfaction. The model can be trained using supervised learning with labeled corpora, using cross-entropy loss and weight updates via gradient-based optimization. The server normalizes these scores and stores them alongside the corresponding feedback entry.

The server performs multimodal emotion fusion. The server retrieves the facial emotion vector and the audio emotion scores from the database and aligns them with the text emotion scores and the subjective rating based on time and session identifiers. The server applies a fusion algorithm, such as a weighted linear combination or a small neural network, to produce a combined emotion index vector. For example, the server may compute an anger index as a sum of weighted facial anger probability, speech irritation score, and text-based anger score, and compute a satisfaction index as a combination of facial joy probability, text satisfaction score, and subjective rating. The weights can be learned from training data by minimizing prediction error against ground-truth labels, or can be configured empirically. This fusion algorithm leverages the complementary strengths of each modality and improves robustness and accuracy compared to using any single modality alone.

The server also collects objective urban state data. The server receives traffic-related measurements from traffic sensors and controllers, environment measurements from environmental monitoring devices, and energy-related measurements from building management systems. These data are stored in relational tables keyed by infrastructure identification information and timestamps. The server performs pre-processing such as missing value imputation and outlier detection using statistical techniques. The server then joins the emotion indices and the objective data into integrated urban state data, forming records in which each infrastructure unit and time interval is associated with both objective indicators (such as vehicle throughput, waiting time, temperature, noise, and energy consumption) and subjective indicators (such as dissatisfaction and stress indices).

The server generates analysis tasks from the integrated urban state data. For each infrastructure unit, the server inspects objective and subjective indicators and creates an analysis task if certain thresholds or conditions are met. For example, for an intersection with high average waiting time and high pedestrian dissatisfaction index, the server may create a traffic flow analysis task. The server computes a task priority value using a scoring function that increases with higher dissatisfaction indices and more severe objective metrics. This priority value is stored in task information records along with the task type and references to relevant data. By embedding emotion-derived priorities into the task scheduler, the system changes the behavior of the computing infrastructure itself: nodes and resources are directed toward computation that has the greatest impact on user experience, which is not achievable by conventional schedulers that consider only low-level resource metrics.

The server implements a scheduler that uses both task priorities and resource usage information from computation nodes. The server periodically queries nodes for their CPU load, memory usage, and network capacity or receives such data via push mechanisms. The scheduler executes an algorithm—such as a weighted round robin or a priority queue with resource constraints—that allocates tasks to nodes that have available capacity and that should, based on task priorities, address the most urgent analysis tasks first. The scheduler may update its allocation decisions dynamically as new data and new tasks arrive. This combination of priority-aware routing and resource-based balancing provides improved throughput and reduced latency for critical tasks compared to known distributed processing frameworks that lack semantic prioritization.

Each computation node performs domain-specific analyses. A traffic analysis node may run a microsimulation or a queuing model to predict the effect of different signal timing settings on queues and delays. An energy analysis node may use time-series forecasting models or optimization algorithms to estimate potential energy savings under different HVAC schedules. An environment analysis node may compute noise exposure indices or comfort indices. The computation nodes read the integrated urban state data for the relevant infrastructure units, perform the specified computations, and store task results back to the server. Task results include quantitative predictions and recommended adjustment ranges for control parameters.

The server uses the integrated urban state data and the task results to generate prompt sentences for a generative AI model. The server stores a set of prompt templates, each associated with a task type. A prompt template includes placeholders for infrastructure identification information, objective indicators, emotion indices, and optimization goals. The server fills these placeholders with actual data from the integrated urban state records and task results to construct a complete natural-language description of the current situation and the desired optimization objective. Because the prompt is assembled from structured data via templates or rule-based composition, the content is comprehensive, consistent, and machine-derivable, avoiding arbitrary or ad-hoc text generation.

For example, for a traffic control scenario, the server can generate the following prompt sentence:

“You are a traffic control expert for a smart city. The intersection ID: X123 currently has a peak-hour traffic volume of 1,200 vehicles per hour and an average waiting time of 90 seconds. According to emotion data collected from pedestrians, the dissatisfaction score is 0.85 and the irritation score is 0.80, which are both high. The current signal cycle is: vehicle green 60 seconds, pedestrian green 20 seconds, and all-red 5 seconds. Please propose a detailed signal-timing plan that reduces pedestrians' waiting time and mitigates irritation, while keeping overall vehicle throughput as high as possible. Provide specific green times for vehicles and pedestrians, and all-red durations, in seconds.”

For a building energy and comfort scenario, the server can generate the following prompt sentence:

“You are a consultant specialized in building energy management optimization. The building ID: B456 currently consumes 12,000 kWh of energy per day, and cooling loads account for 60% of this consumption. The average temperature in the office floors is 27° C. According to emotion data collected from occupants, the heat-related dissatisfaction score is 0.75 and the discomfort score is 0.70, both of which are high. The building owner wants to keep the increase in electricity costs within 10% of the current level. Please propose an air-conditioning control schedule and any additional measures that can reduce occupants' discomfort scores while keeping the energy cost increase within 10%. Include specific temperature setpoints and time-of-day control strategies in your proposal.”

The server sends such prompt sentences to a generative AI model through a generative AI service API. The generative AI model may be a large language model based on a transformer architecture with multiple attention layers and feed-forward layers, trained to minimize a language modeling objective on large text corpora. The server configures parameters such as maximum output length and sampling temperature to control the diversity and determinism of the generated outputs. The server receives the generated text from the generative AI model and logs the prompt and response pairs for auditing and possible future fine-tuning of the model.

The server parses the generated text using regular expression patterns, tokenization, and rule-based extraction to identify specific control parameters. The server identifies textual patterns such as “set the vehicle green to 50 seconds” or “reduce the office temperature to 25 degrees Celsius between 9 a.m. and 6 p.m.” and extracts numerical values, time intervals, and parameter names. The server maps these extracted values to structured fields corresponding to device configuration parameters in a control command format. The server enforces safety constraints by checking that the proposed values are within predefined bounds or by applying post-processing rules, such as adjusting values that would violate minimum green time constraints.

The server transmits the structured control commands to infrastructure control devices. For traffic signal controllers, the server uses an appropriate field communication protocol or application interface to update the signal plan with new phase durations. For building management systems, the server sends messages conforming to building automation protocols to set new HVAC setpoints and schedules. For lighting controllers, the server sends commands to adjust dimming levels and schedules. The infrastructure control devices apply these commands to modify physical device behavior in the real world. As a result, the system does not merely compute abstract recommendations; it dynamically modifies the operation of physical devices, thereby directly influencing traffic flow, indoor climate, and lighting conditions.

The server continuously collects post-intervention data in the same manner as pre-intervention data. The server stores emotion indices and objective indicators after control changes and evaluates the effectiveness of the interventions by comparing pre- and post-intervention metrics. The server may use statistical tests, time-series analysis, or control-theoretic metrics to quantify improvements in waiting time, energy consumption, or user satisfaction. The system can adjust future prompts and selection of candidate control parameters based on historical effectiveness, for example, by inserting prior successful ranges into the prompt or by biasing post-processing filters. This creates a feedback loop in which the computing system adapts its own behavior based on empirical outcomes, further improving accuracy and efficiency over time.

The server implements security and availability functions at multiple layers. The server ensures that all communication carrying emotion indices or urban state data is encrypted using transport-layer security. The server anonymizes user identifiers so that emotion indices cannot be directly linked to specific individuals. The server enforces access controls on databases and message buses so that only authorized processes can read or write sensitive data. The server replicates integrated urban state data, emotion indices, and task results across multiple storage devices or nodes and maintains backup copies so that data can be recovered in case of hardware or software failures. The server implements failover mechanisms to switch to alternate nodes when a primary node becomes unavailable, maintaining continuity of the distributed AI protocol.

In another embodiment, the terminal may perform additional fusion or pre-aggregation of emotion features before sending them to the server, reducing network traffic further at the cost of increased computation on the terminal. In yet another embodiment, all emotion recognition may be performed on the server, with the terminal transmitting raw or compressed sensor data. This variant may be suitable for terminals with limited computational capability but stable, high-bandwidth connections. The system may also employ different neural network architectures, such as recurrent networks for modeling temporal dependencies in emotion signals or graph-based models for capturing spatial relationships among infrastructure units. The core architecture remains that the server uses multimodal emotion indices to prioritize and orchestrate distributed computations and to generate structured prompt sentences for a generative AI model, and that the resulting proposals are translated into concrete control commands that modify operation of physical infrastructure.

By designing the system to use emotion indices and integrated urban state data as internal scheduling and control signals, the server alters the way computation resources are managed and how decisions are synthesized and applied. The combination of edge-side inference, server-side multimodal fusion, priority-aware distributed scheduling, template-based prompt generation, and automatic translation of generative outputs into device-specific commands results in improved computational efficiency, reduced network load, better scalability, and more accurate and timely control of urban infrastructure than conventional systems. The described embodiments therefore provide a concrete technological improvement in computer-implemented control systems rather than merely automating a human planning process.

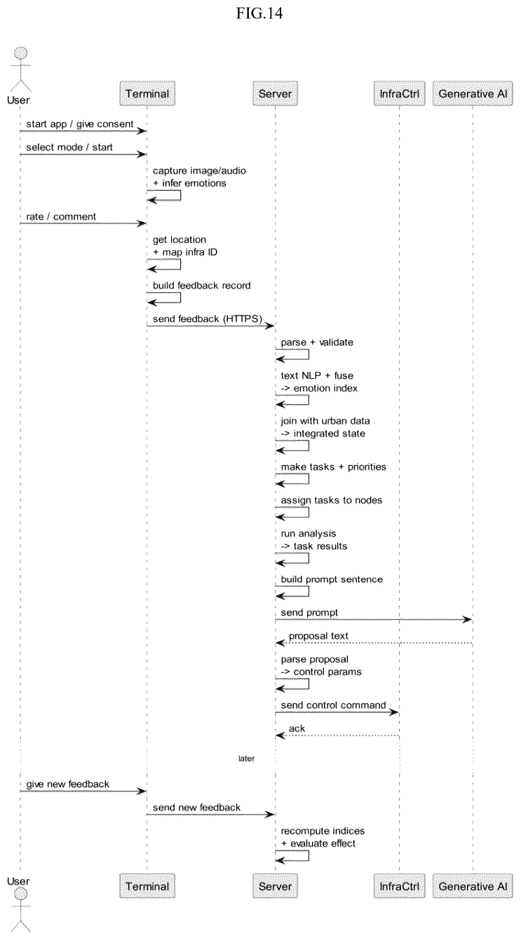

The following describes the processing flow using FIG. 14.

### Step 1:

The user launches an application on the terminal and grants permissions.

The user starts the dedicated smart-city application on the terminal and, via OS dialogs, grants or denies permissions to use the camera, microphone, and location services.

The terminal receives permission status flags as input from the operating system APIs (camera permission, microphone permission, location permission) and writes these flags into an internal configuration structure. The terminal outputs an initialized application state in which only the features corresponding to granted permissions are enabled in the user interface.

### Step 2:

The user selects a feedback mode and initiates a session.

The user taps a menu item on the terminal, such as “Traffic situation feedback” or “Building environment feedback,” and then taps a “Start evaluation” button.

The terminal receives the menu selection and start command as input events from the UI framework. The terminal sets an internal variable ‘current_mode’ based on the selected menu and generates a new session identifier, for example a random or time-based unique value. The terminal outputs a session context object containing the session identifier, the selected mode, and a timestamp, which is stored in memory for association with subsequent sensor data.

### Step 3:

The terminal captures image frames and detects faces.

The terminal uses the imaging device to capture continuous image frames by calling the OS camera API, with the camera configuration (resolution, frame rate) as input. For each frame, the terminal obtains a raw image buffer as input.

The terminal passes the image buffer to an image processing library and executes a face-detection algorithm that computes one or more face bounding boxes. The terminal filters out frames with no detected faces and, for frames with detected faces, selects the primary face region. The terminal crops and resizes the selected face region to a fixed resolution (for example 224×224 pixels) and outputs this normalized face image tensor for further processing.

### Step 4:

The terminal performs facial-expression emotion inference.

The terminal uses the normalized face image tensor as input and loads a pre-trained convolutional neural network for facial-expression recognition through a lightweight inference runtime. The terminal performs forward propagation through convolution, pooling, and fully connected layers with a softmax output layer.

The terminal obtains, as output, a probability distribution over emotion categories (for example joy, anger, sadness, anxiety, neutral). The terminal may aggregate results from multiple consecutive frames by computing an average probability vector across a time window. The terminal outputs a facial emotion vector associated with the current session identifier and timestamp.

### Step 5:

The terminal captures audio samples and extracts audio features.

The terminal activates the audio input device via the OS audio framework and continuously records audio segments, using a configured sampling rate and segment length as input parameters. Each recorded segment is received as a raw waveform buffer.

The terminal inputs the waveform buffer into an audio processing library, which computes features such as Mel-frequency spectra, pitch, energy, and speech rate. The terminal normalizes these features (for example log scaling and z-score normalization) to reduce sensitivity to absolute volume and environmental noise. The terminal outputs an audio feature tensor for each segment.

### Step 6:

The terminal performs speech-emotion inference.

The terminal loads a pre-trained neural network for speech emotion recognition into the lightweight inference runtime. The terminal uses the computed audio feature tensor as input to this network.

The terminal executes forward propagation through convolutional and fully connected layers that map the feature tensor to emotion scores. The terminal obtains as output numeric values such as irritation score, anxiety score, and calmness score. The terminal may average scores over several segments to reduce noise. The terminal outputs an audio emotion vector associated with the session identifier and timestamp.

### Step 7:

The user provides subjective ratings and comments.

The user observes the user interface on the terminal, which prompts the user with a question such as “Please evaluate the comfort level at this place,” and taps a rating button (for example “Very dissatisfied” or “Very satisfied”). The user optionally enters a free-text comment describing the experience.

The terminal receives the button identifier and text string as UI input. The terminal maps the button identifier to a numeric rating (for example from −2 to +2) by a predefined lookup table. The terminal outputs a subjective evaluation record containing the numeric rating and the text comment, tagged with the current session identifier and timestamp.

### Step 8:

The terminal acquires location information and determines infrastructure identifiers.

The terminal calls a location service API, using location request parameters (desired accuracy, update interval) as input, and receives latitude, longitude, and timestamp measurements as output. The terminal collects a sequence of such location readings.

The terminal uses this sequence as input to a movement analysis routine that calculates speed and dwell time and classifies movement state (for example stationary, walking, driving). The terminal also uses the latest latitude and longitude as input to a mapping function that consults a local mapping table or queries the server via a request to map coordinates to infrastructure identification information such as an intersection ID or a building ID. The terminal outputs an infrastructure mapping record containing the infrastructure ID, dwell time, movement state, and associated timestamps.

### Step 9:

The terminal anonymizes user identity and composes a feedback record.

The terminal reads a device-scoped identifier or an application-scoped identifier from the operating system as input. The terminal applies a cryptographic hash function, optionally with a random salt, to this identifier to compute an anonymous user ID.

The terminal then gathers, as inputs, the facial emotion vector, the audio emotion vector, the subjective evaluation record, and the infrastructure mapping record corresponding to the current session. The terminal combines these data into a single structured record, assigning fields for anonymous user ID, session ID, emotion vectors, subjective score, text comment, infrastructure ID, location, movement state, and timestamps. The terminal outputs a serialized representation of this record (for example a structured text message) ready for transmission.

### Step 10:

The terminal securely transmits feedback records to the server.

The terminal configures a secure communication client using the server URL and security credentials as input. The terminal establishes a secure connection using a handshake protocol and verifies the server certificate.

The terminal sends the serialized feedback record as the payload of a request to the server.

The terminal receives the server's response as input indicating success or failure. If the response indicates success, the terminal marks the record as transmitted and outputs a status update freeing associated local storage. If the response indicates failure or a connection error occurs, the terminal outputs a retry queue entry to be used for later retransmission.

### Step 11:

The server receives, parses, and validates feedback records.

The server accepts incoming secure requests at its network interface and passes the payload to the web application framework. The server receives the serialized feedback record as input and invokes a parser to transform it into an internal data structure.

The server executes validation logic that checks for required fields, correct data types, and acceptable ranges for values such as emotion scores and satisfaction ratings. The server outputs valid records by storing them as rows in a raw feedback table in a database and logs invalid records, with associated error details, to an error log table. The server also outputs references to valid records to a streaming platform for downstream processing.

### Step 12:

The server performs text-based emotion analysis.

The server subscribes to the stream of feedback references and reads records that contain text comments as input. For each comment, the server uses a tokenizer and morphological analyzer to convert the comment into a token sequence, which serves as input to a trained language model.

The server runs the language model to compute contextual embeddings and passes them through classifier layers that output scores for emotion categories such as positive sentiment, negative sentiment, anger, anxiety, satisfaction, and dissatisfaction. The server normalizes these scores and outputs a text emotion vector, which it stores in association with the corresponding feedback record.

### Step 13:

The server computes a multimodal emotion index.

The server retrieves, as input, the facial emotion vector and audio emotion vector previously calculated by the terminal and stored in the raw feedback table. The server also retrieves the subjective rating and the text emotion vector for the same feedback record.

The server applies a fusion algorithm that multiplies each modality's scores by predefined or learned weights and sums them to form combined scores. For example, the server computes an anger index by combining facial anger probability, speech irritation score, and text-based anger score. The server computes additional indices such as a dissatisfaction index, a stress index, and a satisfaction index. The server outputs an emotion index vector and writes it to an emotion metrics table keyed by anonymous user ID, infrastructure ID, and timestamp.

### Step 14:

The server integrates emotion indices with objective urban state data.

The server receives objective urban state data from infrastructure sensors and controllers as input streams, including traffic measurements, environmental measurements, and energy consumption readings. The server pre-processes these streams to handle missing data and outliers and stores them in separate tables.

The server then performs a join operation using infrastructure IDs and time windows as keys, combining rows from the objective data tables with corresponding rows from the emotion metrics table. The server computes aggregated objective indicators (for example average waiting time, average noise level) and subjective indicators (for example mean dissatisfaction index) for each infrastructure unit over defined time intervals. The server outputs integrated urban state records, each representing an infrastructure unit at a particular time with combined objective and subjective metrics.

### Step 15:

The server generates and prioritizes analysis tasks.

The server reads integrated urban state records as input and applies task generation rules. For each record, the server evaluates threshold conditions on objective and subjective indicators, such as whether average waiting time exceeds a threshold and dissatisfaction index exceeds another threshold.

When a record meets the conditions, the server creates an analysis task object specifying the infrastructure ID, task type (for example traffic analysis, energy analysis), and references to required data. The server computes a task priority value based on a scoring function that increases with higher dissatisfaction and worse objective metrics. The server outputs the analysis task objects by inserting them into a task queue.

### Step 16:

The server schedules and distributes analysis tasks to computation nodes.

The server periodically gathers resource usage information from computation nodes, including CPU load, memory usage, and network throughput, as input. The server also retrieves pending tasks from the task queue, reading their priorities and estimated computational costs.

The server executes a scheduling algorithm that sorts tasks by priority and, for each task, selects a node with sufficient available resources. The server outputs task assignment messages containing task parameters and data references and sends them to the chosen nodes.

The server updates the task queue to reflect assigned tasks and keeps track of their status.

### Step 17:

Computation nodes execute analysis tasks and return results.

Each computation node receives a task assignment message from the server as input, which specifies a task type, infrastructure ID, and data locations. The node reads the necessary integrated urban state data from the database or data store.

The node executes domain-specific computations, such as simulating the effect of alternate signal timings on queue lengths or predicting energy consumption under different HVAC configurations. The node outputs a task result containing predicted metrics and possible control parameter adjustments and sends this result back to the server via a results interface.

### Step 18:

The server constructs prompt sentences for a generative AI model.

The server receives the task result and the corresponding integrated urban state record as input for each completed analysis task. The server selects an appropriate prompt template based on the task type and extracts description elements including infrastructure ID, current objective metrics, emotion indices, and optimization goals from the input data.

The server fills placeholders in the template with these elements to form a natural-language description. The server outputs a prompt sentence that precisely describes the current situation and asks the generative AI model for a suitable control proposal. For example, in the traffic domain, the server outputs a prompt sentence like the intersection-related example described previously.

### Step 19:

The server sends prompt sentences to the generative AI model and receives proposals.

The server uses the generated prompt sentence, along with model configuration parameters (maximum output length, sampling temperature), as input to a generative AI API call. The server sends a request to the generative AI service and waits for the response.

The generative AI model returns a text output representing a control proposal. The server receives this text as output, logs the prompt and response pair for auditing, and passes the text to a parsing module as input for further processing.

### Step 20:

The server parses proposal text and derives control parameters.

The server takes the proposal text from the generative AI model as input and applies pattern-matching rules and regular expressions to identify parameter phrases, such as recommended green times, temperature setpoints, or schedule intervals.

The server extracts numerical values and associated semantics (for example “vehicle green 50 seconds” or “office temperature 25° C. from 9:00 to 18:00”) and maps them to internal parameter fields. The server checks these values against safety and feasibility constraints. The server outputs a structured control configuration object containing validated control parameters for an infrastructure device.

### Step 21:

The server formats and transmits control commands to infrastructure control devices.

The server uses the structured control configuration object as input and constructs device-specific command messages according to the communication protocol of each infrastructure control device. For example, the server maps signal timing parameters to a traffic control protocol message format or maps temperature setpoints to a building automation command.

The server transmits the command messages to the respective control devices over the communication network and awaits acknowledgment. The server outputs updated control state records reflecting that new control parameters have been applied to the devices.

### Step 22:

The server and terminal collect post-control data for evaluation.

The terminal continues to capture user emotion data and subjective evaluations after new control parameters have been applied, using the same capture and transmission processes as before. The server continues to ingest objective urban state data reflecting the changed conditions.

The server receives, as input, these new feedback records and objective measurements, computes new emotion indices and integrated urban state records, and compares them to pre-control records. The server outputs evaluation metrics such as change in average waiting time, change in dissatisfaction index, and change in energy consumption, which can be used to refine future task generation, prompt construction, and control parameter selection.

The data generation model 58 is a so-called generative artificial intelligence (AI). Examples of the data generation model 58 include generative Als such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Moreover, although the processing by the data processing system 10 described above was executed by the specific processing unit 290 of the data processing device 12 or by the control unit 46A of the smart device 14, the processing may be executed by a specific processing unit 290 of the data processing device 12 and a control unit 46A of the smart device 14. Moreover, the specific processing unit 290 of the data processing device 12 acquires and collects information needed for processing from the smart device 14 or from an external device or the like, and the smart device 14 acquires and collects information needed for processing from the data processing device 12 or from an external device or the like.

For example, a collection unit is implemented by the control unit 46A of the smart device 14 and/or by the specific processing unit 290 of the data processing device 12. For example, an acquisition unit acquires number-of-steps data using the camera 42 and/or the communication I/F 44 of the smart device 14, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the output device 40 of the smart device 14 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart device 14.

### Second Exemplary Embodiment

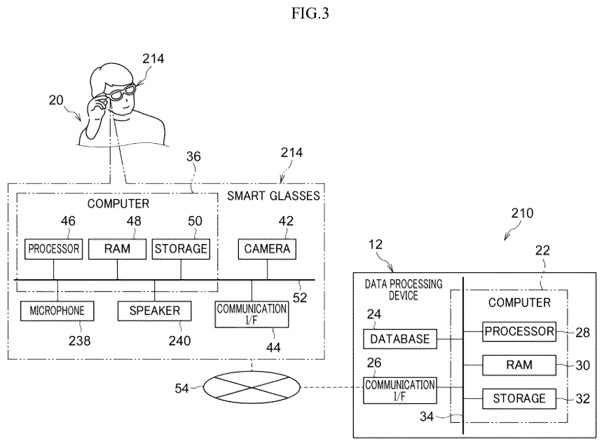

FIG. 3 illustrates an example of a configuration of a data processing system 210 according to a second exemplary embodiment.

As illustrated in FIG. 3, the data processing system 210 includes a data processing device 12 and smart glasses 214. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart glasses 214 include a computer 36, a microphone 238, a speaker 240, a camera 42, and a communication I/F 44. The computer 36 includes a processor 46, RAM 48, and storage 50. The processor 46, the RAM 48, and the storage 50 are connected to a bus 52. The microphone 238, the speaker 240, the camera 42, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

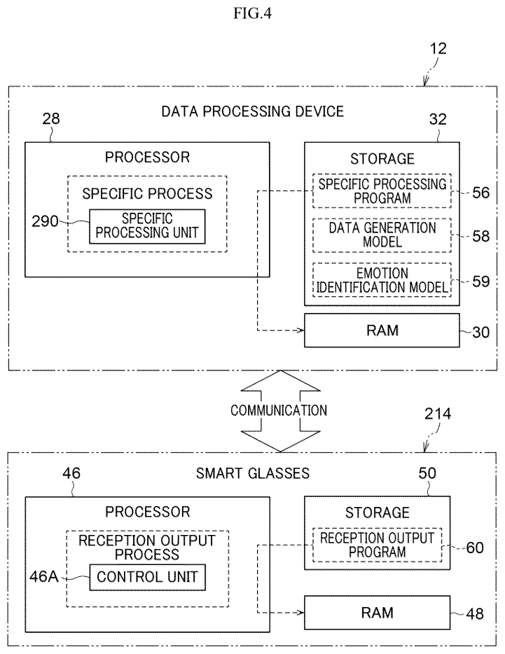

FIG. 4 illustrates an example of relevant functions of the data processing device 12 and the smart glasses 214. As illustrated in FIG. 4, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart glasses 214. A reception and output program 60 is stored in the storage 50. The processor 46 reads the reception and output program 60 from the storage 50 and in the RAM 48 executes the read reception and output program 60. The reception and output processing is implemented by the processor 46 operating as the control unit 46A according to the reception and output program 60 executed in the RAM 48. Note that a configuration may be adopted in which the smart glasses 214 include a data generation model and an emotion identification model similar to the data generation model 58 and the emotion identification model 59, and processing similar to the specific processing unit 290 is performed using these models.

Next, description follows regarding the specific processing by the specific processing unit 290 of the data processing device 12. The units of the system described below are implemented by the data processing device 12 and the smart glasses 214. In the following description the data processing device 12 is called a “server”, and the smart glasses 214 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the smart glasses 214. The control unit 46A in the smart glasses 214 outputs the specific processing result to the speaker 240. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative Als such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the smart glasses 214, the processing may be executed by a specific processing unit 290 of the data processing device 12 and a control unit 46A of the smart glasses 214. Moreover, the specific processing unit 290 of the data processing device 12 acquires and collects information needed for processing from the smart glasses 214 or from an external device or the like, and the smart glasses 214 acquires and collects information needed for processing from the data processing device 12 or from an external device or the like.

For example, the collection unit is implemented by the control unit 46A of the smart glasses 214 and/or by the specific processing unit 290 of the data processing device 12. For example, an acquisition unit acquires number-of-steps data using the camera 42 and/or the communication I/F 44 of the smart glasses 214, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 of the smart glasses 214 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart glasses 214.

### Third Exemplary Embodiment

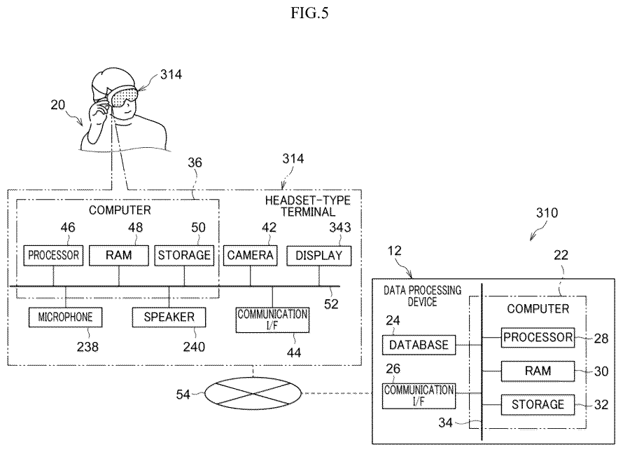

FIG. 5 illustrates an example of a configuration of a data processing system 310 according to a third exemplary embodiment.

As illustrated in FIG. 5, the data processing system 310 includes a data processing device 12 and a headset-type terminal 314. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The headset-type terminal 314 includes a computer 36, a microphone 238, a speaker 240, a camera 42, a communication I/F 44, and a display 343. The computer 36 includes a processor 46, RAM 48, and storage 50. The processor 46, the RAM 48, and the storage 50 are connected to a bus 52. The microphone 238, the speaker 240, the camera 42, the display 343, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

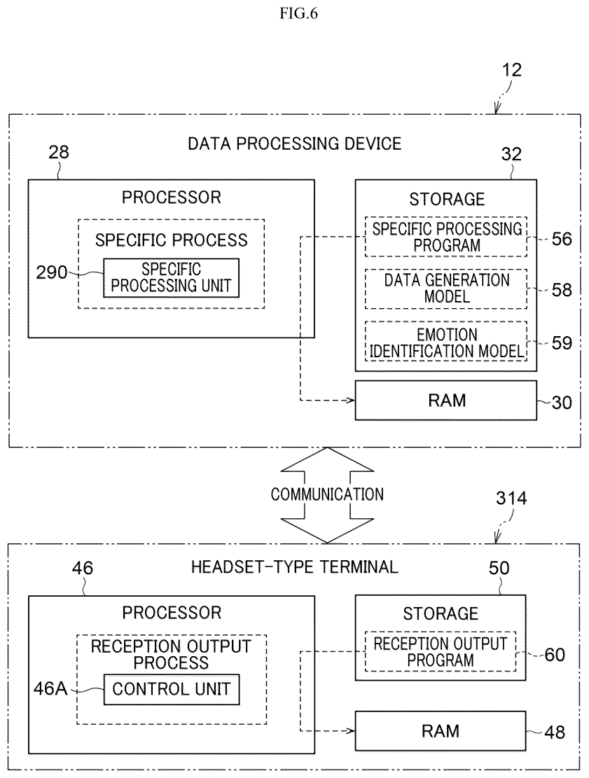

FIG. 6 illustrates an example of relevant functions of the data processing device 12 and the headset-type terminal 314. As illustrated in FIG. 6, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the headset-type terminal 314. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the headset-type terminal 314. In the following description the data processing device 12 is called a “server”, and the headset-type terminal 314 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the headset-type terminal 314. In the headset-type terminal 314, the control unit 46A outputs the result of the specific processing to the speaker 240 and the display 343. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative Als such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the headset-type terminal 314, the processing may be executed by a specific processing unit 290 of the data processing device 12 and a control unit 46A of the headset-type terminal 314. Moreover, the specific processing unit 290 of the data processing device 12 acquires and collects information needed for processing from the headset-type terminal 314 or from an external device or the like, and the headset-type terminal 314 acquires and collects information needed for processing from the data processing device 12 or from an external device or the like.

For example, the collection unit is implemented by the control unit 46A of the headset-type terminal 314 and/or by the specific processing unit 290 of the data processing device 12. For example, an acquisition unit acquires number-of-steps data using the camera 42 and/or the communication I/F 44 of the headset-type terminal 314, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the display 343 of the headset-type terminal 314 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the headset-type terminal 314.

### Fourth Exemplary Embodiment

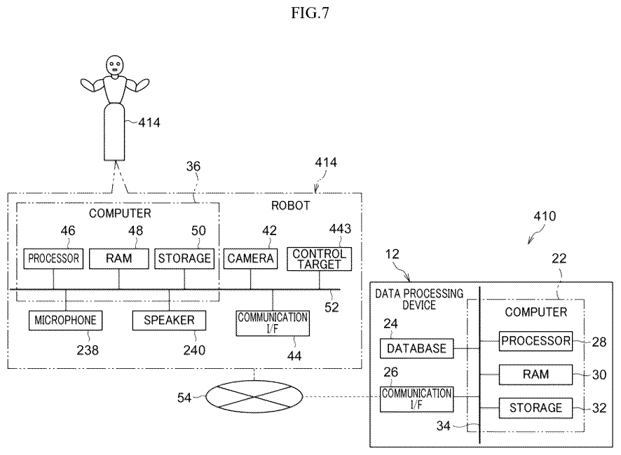

FIG. 7 illustrates an example of a configuration of a data processing system 410 according to a fourth exemplary embodiment

As illustrated in FIG. 7, the data processing system 410 includes a data processing device 12 and a robot 414. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The robot 414 includes a computer 36, a microphone 238, a speaker 240, a camera 42, a communication I/F 44, and a control target 443. The computer 36 includes a processor 46, RAM 48, and storage 50. The processor 46, the RAM 48, and the storage 50 are connected to a bus 52. The microphone 238, the speaker 240, the camera 42, the control target 443, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the robot 414 (for example, with an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

The control target 443 includes a display device, eye LEDs, and motors to drive arms, hands, feet, and the like. The posture and gesture of the robot 414 are controlled by controlling the motors of the arms, hands, feet, and the like. Part of an emotion of the robot 414 can be expressed by controlling these motors. Moreover, a facial expression of the robot 414 can be represented by controlling an illumination state of the eye LEDs of the robot 414.

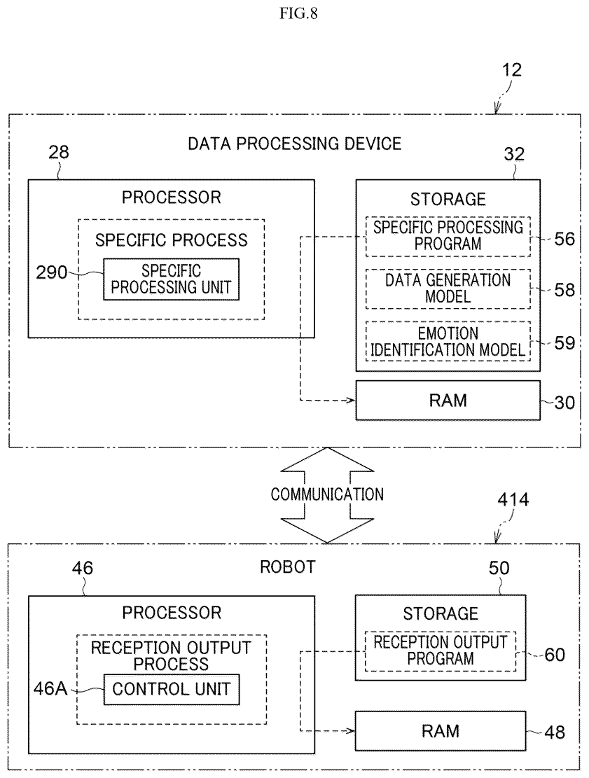

FIG. 8 illustrates an example of relevant functions of the data processing device 12 and the robot 414. As illustrated in FIG. 8, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the robot 414. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the robot 414. In the following description the data processing device 12 is called a “server”, and the robot 414 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the robot 414. In the robot 414, the control unit 46A outputs the result of the specific processing to the speaker 240 and the control target 443. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative Als such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the robot 414, the processing may be executed by a specific processing unit 290 of the data processing device 12 and a control unit 46A of the robot 414. Moreover, the specific processing unit 290 of the data processing device 12 acquires and collects information needed for processing from the robot 414 or from an external device or the like, and the robot 414 acquires and collects information needed for processing from the data processing device 12 or from an external device or the like.

For example, the collection unit is implemented by the control unit 46A of the robot 414 and/or by the specific processing unit 290 of the data processing device 12. For example, an acquisition unit acquires number-of-steps data using the camera 42 and/or the communication I/F 44 of the robot 414, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the control target 443 of the robot 414 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the robot 414.

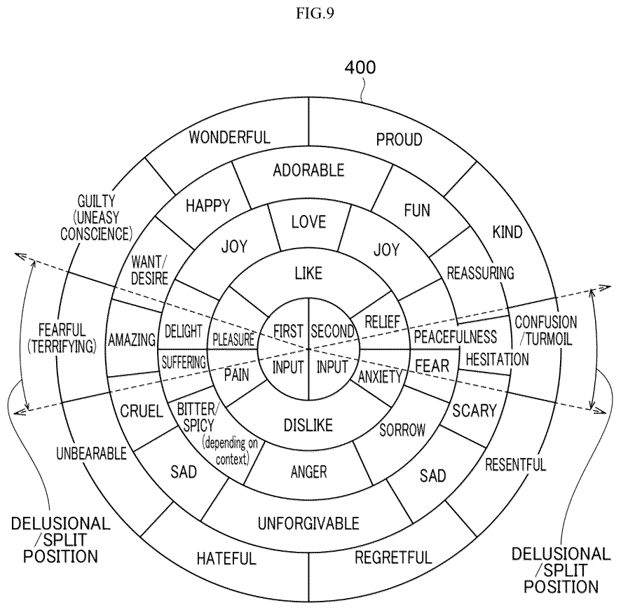

Note that the emotion identification model 59 serves as an emotion engine, and may decide the emotion of a user according to a specific mapping. Specifically, the emotion identification model 59 may decide the emotion of a user according to an emotion map (see FIG. 9) that is a specific mapping. Moreover, the emotion identification model 59 may also decide the emotion of the robot similarly, and the specific processing unit 290 may be configured so as to perform the specific processing using the emotion of the robot.

FIG. 9 is a diagram illustrating an emotion map 400 mapping plural emotions. In the emotion map 400, emotions are arranged in concentric circles that radiate out from the center. Primitive states of emotion are arranged nearer to the center of the concentric circles. Emotions expressing states and actions generated from states of mind are arranged further toward the outside of the concentric circles. Emotions are defined as including both affect and mental states. Emotions generated from reactions occurring in the brain are generally arranged at the left side of the concentric circles. Emotions induced by situational assessment are generally arranged at the right side of the concentric circles. Emotions generated from reactions occurring in the brain that are also emotions induced by situational assessment are generally arranged toward the top and toward the bottom of the concentric circles. Moreover, emotions of “euphoria” are arranged at the upper side of the concentric circles, and emotions of “dysphoria” are arranged at the lower side of the concentric circles. Plural emotions are accordingly mapped in this manner in the emotion map 400 based on a structure giving rise to emotions, and emotions that readily occur at the same time are mapped close to each other.

An example of such emotions is a distribution of emotions in the direction of 3 o'clock on the emotion map 400, generally around a boundary between relief and anxiety. Situational awareness dominates over internal sensations in the right half of the emotion map 400, with an impression of calm.

The inside of the emotion map 400 represents feelings, and the outside of the emotion map 400 represents actions, and so emotions further toward the outside of the emotion map 400 are more visible (are expressed by actions).

Human emotions are based on various balances, such as posture and blood sugar value balances, with a state of dysphoria being exhibited when these balances are far from ideal and a state of euphoria being exhibited when these balances are near to ideal. Even in a robot, a car, a motorbike, or the like, emotions can be thought of as being based on various balances such as orientation and remaining battery balances, with a state called dysphoria being exhibited when these balances are far from ideal and a state called euphoria being exhibited when these balances are near to ideal. An emotion map may, for example, be generated based on the emotion map of Dr. Mitsuyoshi (PhD Dissertation https://ci.nii.ac.jp/naid/500000375379: “Research on the phonetic recognition of feelings and a system for emotional physiological brain signal analysis”, Tokushima University). Emotions belonging to an area called “reaction” where feeling dominates are arranged in the left half of the emotion map. Moreover, emotions belonging to an area called “situation” where situational awareness dominates are arranged in the right half of the emotion map.

There are two types of emotion that facilitate leaning in an emotion map. One is an emotion in the vicinity of the center of negative “penitence” and “reflection” on the situational side. In other words, sometimes a negative “emotion” such as “I don't want to feel this way ever again” and “I don't want to be chided again” is experienced in a robot. Another is a positive emotion in the area of “desire” on the reaction side. In other words, there are times when a positive feeling such as “desire more” and “want to know more” is experienced.

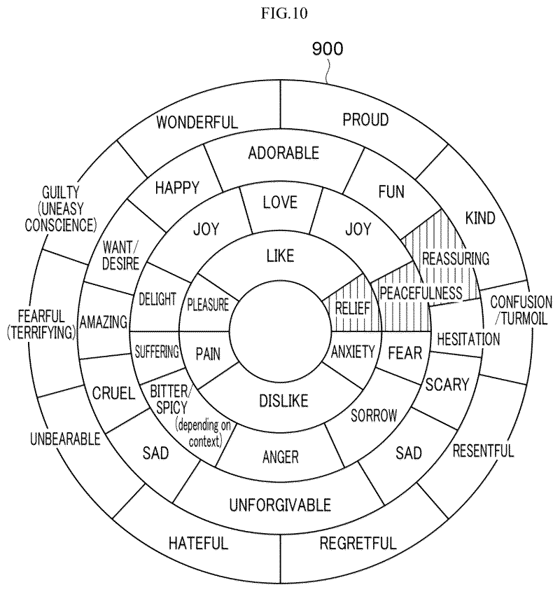

In the emotion identification model 59, user input is input to a pre-trained neural network, and emotion values indicating emotions shown on the emotion map 400 are acquired and the emotions of the user are decided. This neural network is pre-trained based on plural training data sets that each combine a user input with an emotion value indicating an emotion shown on the emotion map 400. The neural network is also trained such that emotions arranged close to each other have values that are close to each other, as in an emotion map 900 illustrated in FIG. 10. In FIG. 10 the plural emotions of “relief”, “peaceful”, and “reassured” are indicated as an example of close emotion values.

Although the system according to the present disclosure has been described mainly as functions of the data processing device 12, the system according to the present disclosure is not limited to being implemented in a server. The system according to the present disclosure may be implemented as a general information processing system. The present disclosure may, for example, be implemented by a software program operating on a personal computer, and may be implemented by an application operating on a smartphone or the like. The method according to the present disclosure may also be supplied to a user in the form of Software as a Service (SaaS).

Although in the exemplary embodiments described above examples are given of embodiments in which the specific processing is performed by a single computer 22, technology disclosed herein is not limited thereto, and distributed processing may be performed for the specific processing, with the specific processing distributed across plural computers including the computer 22. For example, the data generation model 58 may be provided in a device external to the data processing device 12, such that data generation in response to input data is performed in the external device.

Although in the exemplary embodiments described above examples are described of embodiments in which the specific processing program 56 is stored in the storage 32, the technology disclosed herein is not limited thereto. For example, the specific processing program 56 may be stored on a portable, non-transitory, computer readable, storage medium, such as universal serial bus (USB) memory or the like. The specific processing program 56 stored on the non-transitory storage medium is then installed on the computer 22 of the data processing device 12. The processor 28 then executes the specific processing according to the specific processing program 56.

Moreover, the specific processing program 56 may be stored on a storage device, such as a server connected to the data processing device 12 over the network 54, with the specific processing program 56 then being downloaded in response to a request from the data processing device 12 and installed on the computer 22.

Note that there is no need to store the entire specific processing program 56 on the storage device, such as a server connected to the data processing device 12 over the network 54, or to store the entire specific processing program 56 on the storage 32, and part of the specific processing program 56 may be stored thereon.

Hardware resources for executing the specific processing may use various processors as listed below. Examples of processors include, for example, a CPU that is a general-purpose processor that functions as a hardware resource to execute the specific processing by executing software, namely a program. Moreover, the processor may, for example, be a dedicated electronic circuit that is a processor having a circuit configuration custom designed for executing the specific processing, such as a field-programmable gate array (FPGA), a programmable logic device (PLD), or an application specific integrated circuit (ASIC). Memory is inbuilt or connected to each of these processors, and the specific processing is executed by each of these processors using the memory.

The hardware resource that executes the specific processing may be configured from one of these various processors, or may be configured from a combination of two or more processors of the same or different type (for example, a combination of plural FPGAs, or a combination of a CPU and a FPGA). The hardware resource executing the specific processing may be a single processor.

Examples of configurations of a single processor include, firstly, a configuration of a single processor resulting from combining one or more CPU and software, in an embodiment in which this processor functions as the hardware resource for executing the specific processing. Secondly, as typified by a System-on-chip (SOC) or the like, there is also an embodiment that uses a processor realized by a single IC chip to function as an overall system including plural hardware resources for executing the specific processing. Adopting such an approach means that the specific processing is realized using one or more of the various processors described above as hardware resource.

Furthermore, more specifically, an electrical circuit that combines circuit elements such as semiconductor elements or the like may be employed as a hardware structure of these various processors. The specific processing is merely an example thereof. This means that obviously redundant steps may be omitted, new steps may be added, and the processing sequence may be swapped around within a range not departing from the spirit of the present disclosure.

The described content and drawing content illustrated above are a detailed description of parts according to the present disclosure, and are merely examples of the present disclosure. For example, description related to the above configuration, function, operation, and advantageous effects is a description related to examples of the configuration, function, operation, and advantageous effects of parts according to the present disclosure. This means that obviously redundant parts may be eliminated, new elements may be added, and switching around may be performed on the described content and drawing content illustrated above within a range not departing from the spirit of the present disclosure. Moreover, to avoid misunderstanding and to facilitate understanding of parts according to the present disclosure, description related to common knowledge in the art and the like not particularly needing description to enable implementation of the present disclosure is omitted in the described content and drawing content illustrated as described above.

All publications, patent applications and technical standards mentioned in the present specification are incorporated by reference in the present specification to the same extent as if each individual publication, patent application, or technical standard was specifically and individually indicated to be incorporated by reference.

Note that, regarding the above description, the following supplementary notes are further disclosed.

### Example 1

### (Supplementary 1)

A system comprising a processor,
wherein the processor is configured to construct, on a distributed information processing network including a plurality of information processing devices, a communication topology in which each information processing terminal functions as a node and is mutually connected based on address information and connection information,
receive, from a user terminal, a processing request including a prompt sentence for a generative AI task, and generate internal instruction information that defines a processing type and an output format on the basis of the prompt sentence, and store the internal instruction information in association with the processing request,
analyze input information included in the processing request, divide the input information into a plurality of information units according to a type and a scale of the input information, and
generate partial task information defining partial processing contents for each of the plurality of information units,
analyze a computational processing structure of a generative AI model, generate the partial task information on the basis of processing dependency in the computational processing structure, store the generated partial task information in a task storage region for distribution to the plurality of nodes in the distributed information processing network, and cause the plurality of nodes to acquire the partial task information from the task storage region in response to acquisition requests from the plurality of nodes,
collect resource state information periodically transmitted from each node, calculate, on the basis of the resource state information including computation resource usage, memory resource usage, power remaining amount, and communication quality, a load index for each node, determine, according to the load index, an assignment number and a priority for the partial task information, and dynamically assign the partial task information to the plurality of nodes by using a round-robin method or a resource-based allocation method,
receive partial result information generated by the plurality of nodes by executing computational processing corresponding to the partial task information on local information processing resources of the plurality of nodes, collect the partial result information, determine an integration order on the basis of order information or time information included in the partial result information, and combine the partial result information according to the integration order to generate integrated intermediate information,
generate final-generation instruction information including contents of the prompt sentence, the output format, and constraint conditions on the basis of the prompt sentence and the integrated intermediate information, input the final-generation instruction information into the generative AI model, and cause the generative AI model to generate final output information composed of natural language information or structured information,
apply encryption processing and decryption processing to data and results that are distributed and processed among the plurality of nodes, authenticate each node and each user terminal on the basis of authentication information, and thereby ensure confidentiality and integrity of information on communication paths and in storage regions,
monitor states of the plurality of nodes and the communication topology, detect a node failure on the basis of periodic status notification information or monitoring signals, reassign the partial task information and the partial result information assigned to a failed node to another node, and replicate and hold at least one of the input information and the integrated intermediate information in a plurality of nodes or a plurality of storage devices to provide redundancy and failover functionality, and
store the final output information in association with the processing request, transmit the final output information to the user terminal, and, on the basis of an additional prompt sentence received from the user terminal, reuse at least one of the integrated intermediate information and the final output information to perform at least one of regeneration processing and modified generation processing without additional input information, thereby providing an interactive response.

### (Supplementary 2)

The system according to supplementary 1,
wherein the processor is configured to
assign, as part of construction of the communication topology, address information and connection information for direct communication with other nodes to each node, determine a liveness state of each node on the basis of monitoring signals periodically transmitted from the nodes, and supply the liveness state to load balancing control and availability control so as to control assignment and reassignment of the partial task information.

### (Supplementary 3)

The system according to supplementary 1,
wherein the processor is configured to
treat the integrated intermediate information as pre-processing result information including at least one of summary information, detection result information, and feature quantity information, and execute output generation processing by the generative AI model using both the final-generation instruction information including the prompt sentence and the pre-processing result information, and, in cooperation with load balancing and integration of partial results, distribute a part of high-load computation of the generative AI model as execution of the partial task information on the plurality of nodes.

### Application Example 1

### (Supplementary 1)

A system comprising a processor,
wherein the processor is configured to
construct a communication path in which a plurality of information processing devices function as edge terminals serving as nodes, the communication path being formed such that the nodes are mutually connected using identification information to establish connections among the nodes,
receive time-series information and environmental information acquired from observation devices, generate information sets for each service area and for each time period based on the received information, generate analysis processing units based on the information sets, and divide and assign the analysis processing units to a plurality of nodes,
acquire computation resource usage information from each node, dynamically determine a destination node for assignment of each of the analysis processing units based on the computation resource usage information, and redistribute the analysis processing units according to load status of the nodes,
aggregate analysis result information transmitted from the nodes, calculate state indices for an entire service area based on the aggregated analysis result information, calculate verification values for the aggregated analysis result information, store the verification values, and determine whether tampering has occurred based on the verification values,
encrypt a communication path, perform mutual authentication between the nodes and a central device using terminal authentication information, and perform information protection by anonymizing or pseudonymizing personal-related information for storage,
replicate the analysis result information and the state indices to a plurality of storage devices and a plurality of nodes, detect an abnormal node based on monitoring information, and automatically reassign the analysis processing units that were assigned to the abnormal node to another node so as to maintain service continuity,
extract explanation information including a target area, a time period, and current control conditions from the state indices and the analysis result information obtained by the processor, format the explanation information as a query sentence in a natural language, and automatically generate a prompt sentence to be input to a generative information processing model,
input the prompt sentence generated by the processor to the generative information processing model, and receive, from the generative information processing model, proposal information in the natural language or structured control candidate information,
extract, from the proposal information or the control candidate information obtained from the generative information processing model, setting values, control schedules, and priority information for each control target device, convert the extracted information into a machine-readable group of control parameters, and distribute the control parameters to corresponding nodes so as to update operation conditions of the observation devices or control devices, and present the proposal information and the group of control parameters to a display device operated by a user, and change application content of the control parameters based on approval information or correction instructions received from the user.

### (Supplementary 2)

The system according to supplementary 1,
wherein the processor is configured to
acquire, as the state indices, a plurality of types of evaluation values including a traffic flow index, an energy consumption index, and an environmental quality index, embed the evaluation values together with time information and location information into the prompt sentence, and automatically generate a query content that requests at least one of a proposal of signal control conditions, a proposal of energy utilization measures, and a proposal of environmental improvement measures to the generative information processing model.

### (Supplementary 3)

The system according to supplementary 1,
wherein the processor is configured to
inspect the control candidate information obtained from the generative information processing model based on safety standard information and operation constraint information,
automatically correct or invalidate control parameters that do not satisfy the inspection, and distribute only corrected or selected control parameters to the nodes.

### Example 2

### (Supplementary 1)

A system comprising a processor,
wherein the processor is configured to
construct a network in which a plurality of information processing apparatuses function as nodes that are mutually connected as communication endpoints, and to manage node identifiers and communication endpoints for direct communication between the nodes, obtain a prompt sentence expressed in natural language that serves as an instruction to a generative AI model, obtain structured emotion metadata indicating an emotional state of a user, and generate a modified prompt sentence for input to the generative AI model based on the prompt sentence and the emotion metadata,
analyze a processing content corresponding to the modified prompt sentence, divide the processing content into a plurality of subtasks, and generate a task graph representing dependency relationships among the plurality of subtasks,
acquire resource information indicating utilization states of computing devices, storage devices, communication devices, and power supply devices in each node including a terminal-side node and a centralized processing node, calculate an emotion priority value based on the emotion metadata, and determine, based on the resource information and the emotion priority value, an allocation destination node for each of the plurality of subtasks in the task graph so that a subtask having a higher priority is selectively assigned to a node having higher performance or lower latency,
cause each node to execute, by using a lightweight inference engine or a deep learning framework installed in the node, the subtask allocated to the node, collect partial processing results from the nodes, execute the generative AI model on the centralized processing node using the modified prompt sentence as an input to obtain a generation result, and integrate the generation result and the partial processing results,
control a structure of final output data based on the emotion metadata by arranging at least a conclusion part, a reason-explanation part, and a detailed-explanation part in an order and with an information amount that depend on the emotion metadata, and generate the final output data,
convert the final output data into a structured data format, transmit the final output data to the terminal-side node via an encrypted communication path, and cause the terminal-side node to determine, based on the final output data and the emotion metadata, display order, emphasis degree, and output modality so as to selectively emphasize a conclusion part at a beginning of a display or to fold a detailed-explanation part, and to present the final output data as a screen display or an audio output,
acquire text input, voice input, and image input from the user, estimate emotion classification information and emotion intensity indicators from the inputs to generate the emotion metadata, generate resource information including a CPU utilization, a memory utilization, a communication state, and a power state of the terminal-side node, and transmit the prompt sentence, the emotion metadata, and the resource information to the centralized processing node,
and perform encryption processing, authentication processing, and access control processing on the prompt sentence, the emotion metadata, the resource information, and the final output data to ensure confidentiality and anonymity of data, monitor states of the nodes and heartbeat messages, manage redundant paths and failover control, and reassign subtasks to another node upon a failure so as to maintain availability of the network.

### (Supplementary 2)

The system according to supplementary 1,
wherein the processor is configured to
assign, to each node, a communication identifier and communication endpoint information used for direct communication with another node, establish a connection between the nodes based on the communication identifier and the communication endpoint information, cause each node to periodically transmit a state notification message including at least a liveness state and a resource state of the node, monitor the liveness state and the resource state of other nodes based on the state notification message, and provide a monitoring frequency and a monitoring result to a task allocation process that determines allocation of the subtasks.

### (Supplementary 3)

The system according to supplementary 1,
wherein the processor is configured to
analyze an internal computation structure of the generative AI model and the processing content indicated by the prompt sentence, divide the processing content into a plurality of subtasks including a conclusion-presentation subtask and a detailed-explanation subtask, and add, to the modified prompt sentence, constraint conditions corresponding to the emotion metadata including at least one of a condition to present a conclusion first, a condition to suppress use of technical terms, and a condition to limit a number of reason explanations, and acquire, as the resource information, computation resource information, storage resource information, communication resource information, and power resource information of each node, calculate a scheduling evaluation value for each subtask based on the resource information and the emotion priority value, and dynamically allocate each of the plurality of subtasks to the nodes according to the scheduling evaluation value.

### Application Example 2

### (Supplementary 1)

A system comprising a processor,
wherein the processor is configured to function as a plurality of nodes connected via a communication network and to construct a network in which each node is capable of mutually exchanging data so that objective indicators and subjective indicators relating to a state of an urban space are obtainable,
wherein the processor is configured to receive, from a user terminal operated by a user, image information acquired via an imaging device, audio information acquired via an audio input device, location information acquired via a location information acquisition device, and subjective evaluation input information acquired via a user interface, to perform signal processing and feature extraction on the image information and the audio information, to convert the subjective evaluation input information into numerical data, to generate, on the basis of the processed image information, the processed audio information, and the numerical subjective evaluation input information, an emotion index representing an emotional state of the user, and to associate the emotion index with infrastructure identification information of urban infrastructure on the basis of the location information,
wherein the processor is configured to collect urban state data comprising traffic information, environment information, energy information, and equipment operation information from detection devices and management devices disposed in the urban infrastructure, to store the urban state data in association with the emotion index in a time-space-correlated manner as integrated urban state data, and to generate, for each unit of the urban infrastructure, an integrated view including objective indicators based on the urban state data and subjective indicators based on the emotion index,
wherein the processor is configured to generate, on the basis of the integrated urban state data, analysis tasks for respective units of the urban infrastructure including at least one of intersection-based units, building-based units, and area-based units, to calculate, for each analysis task, a priority representing at least one of importance and urgency on the basis of the objective indicators and the subjective indicators, and to generate task information including task identification information, target infrastructure identification information, a task type, and the priority,
wherein the processor is configured to obtain resource usage information of computation resources from a plurality of nodes, to perform task scheduling processing on the basis of the priority and the resource usage information, and to dynamically allocate each of the analysis tasks to a corresponding one of the nodes so that the analysis tasks generated by the processor are distributed to the plurality of nodes,
wherein the processor is configured to cause each of the nodes, in accordance with an allocated analysis task, to execute data computation including at least one of traffic flow analysis, energy consumption analysis, and environment evaluation, using the integrated urban state data as input, to generate a task result as an analysis result, and to receive the task result from each of the nodes,
wherein the processor is configured to generate, on the basis of the integrated urban state data and the task result, a prompt sentence to be input to a generative AI model, the generating including extracting description elements including the target infrastructure identification information, objective indicator values corresponding to the urban infrastructure, emotion index values corresponding to the urban infrastructure, and an optimization objective, and constructing, on the basis of predetermined sentence generation rules or templates, a prompt sentence represented in a natural language,
wherein the processor is configured to input the prompt sentence generated by the processor into the generative AI model, to obtain proposal information including a control proposal relating to at least one of signal control, lighting control, and air-conditioning control from the generative AI model, to extract, from the proposal information, specific control parameters for each control target, to represent the control parameters as structured data, to convert the structured data into a control command interpretable by an infrastructure control device of the urban infrastructure, and to transmit the control command to the infrastructure control device so as to control operation of the urban infrastructure,
wherein the processor is configured to perform encryption when transmitting and receiving the emotion index and the urban state data, to perform anonymization of user identification information and access control so as to ensure security and privacy, to replicate and store the integrated urban state data, the emotion index, and the task result in a plurality of storage devices or a plurality of nodes, and to execute at least one of backup processing and failover processing so as to recover data from backup data or replica data upon occurrence of a failure and ensure availability of the network, and
wherein the processor is configured, by executing the functions of emotion recognition, urban state integration, task generation, load distribution, task execution, prompt generation, and infrastructure control in combination, to perform in an integrated manner task priority control using the emotion index, automatic generation of the prompt sentence for the generative AI model, and control of the urban infrastructure based on an output of the generative AI model.

### (Supplementary 2)

The system according to supplementary 1,
wherein the processor is configured, as an emotion recognition function, to execute, on the user terminal, lightweight inference of a deep learning model using the image information and the audio information to calculate a facial emotion vector and an audio emotion score on the terminal side, to execute, on a server side, natural language processing using a natural language processing model to calculate a text emotion score from a text comment included in the subjective evaluation input information, and to generate, by weighting and integrating emotion scores based on a plurality of modalities including the facial emotion vector, the audio emotion score, the text emotion score, and the subjective evaluation input information, an emotion metric including at least one of an anger index, a dissatisfaction index, a stress index, and a satisfaction index as the emotion index.

### (Supplementary 3)

The system according to supplementary 1,
wherein the processor is configured, as the prompt generation function, to use, for each analysis task, a task type, the target infrastructure identification information, the objective indicator values, and the emotion metric obtained from the task generation and task execution, to automatically construct, by using at least one of a template engine and a sentence composition rule, the prompt sentence that instructs the generative AI model to generate the control proposal for the urban infrastructure, and to explicitly include, in the prompt sentence, a description of improvement requirements based on the emotion index of the user and a description of objective constraint conditions based on the objective indicators.

What is claimed is:

1. A system comprising:
circuitry configured to:
construct, via a communication interface coupled to a packet-switched network, a communication topology in which a plurality of information processing devices function as nodes that are mutually connected on the basis of address information and connection information assigned to each node;
receive, from a client terminal via the packet-switched network, a processing request comprising a prompt sentence for a generative information processing model, analyze input information included in the processing request, and generate a task graph representing a plurality of subtasks and dependency relationships among the plurality of subtasks;
collect resource state information periodically transmitted from each node via the packet-switched network, the resource state information comprising computation resource usage, memory resource usage, and communication quality data, calculate a load index for each node on the basis of the resource state information, and determine an allocation destination node for each of the plurality of subtasks on the basis of the load index;
transmit, via the packet-switched network, subtask data to the allocation destination nodes, receive partial processing result data from the nodes, determine an integration order on the basis of order information and temporal information included in the partial processing result data, and combine the partial processing result data according to the integration order to generate integrated intermediate information;
generate final-generation instruction information comprising the prompt sentence and constraint conditions on the basis of the integrated intermediate information, input the final-generation instruction information into the generative information processing model, and receive final output information composed of natural language information or structured information from the generative information processing model;
apply encryption processing and authentication processing to data transmitted among the plurality of nodes via the packet-switched network, monitor states of the plurality of nodes on the basis of periodic state notification information, detect a node failure, and reassign subtask data assigned to a failed node to another node; and
transmit the final output information to the client terminal via the packet-switched network.

2. The system according to claim 1, wherein the circuitry is configured to assign to each node an Internet Protocol address and a port number for direct communication with other nodes, and to cause each node to periodically transmit a state notification message comprising at least a liveness state and a resource state to enable the circuitry to monitor availability of the plurality of nodes.

3. The system according to claim 2, wherein the circuitry is configured to determine the liveness state of each node on the basis of the periodic state notification messages, and to provide the liveness state to a task allocation process that determines allocation and reassignment of the subtask data.

4. The system according to claim 3, wherein the circuitry is configured to replicate and hold at least one of the input information and the integrated intermediate information in a plurality of nodes or a plurality of storage devices, and to reassign the subtask data and partial processing result data assigned to a failed node to another node holding the replicated information.

5. The system according to claim 1, wherein the circuitry is configured to analyze a computational processing structure of the generative information processing model, divide the processing into the plurality of subtasks on the basis of processing dependencies in the computational processing structure, and store the plurality of subtasks in a task storage region for distribution to the plurality of nodes.

6. The system according to claim 5, wherein the circuitry is configured to cause the plurality of nodes to acquire subtask data from the task storage region in response to acquisition requests from the plurality of nodes, and to dynamically assign the subtask data by using at least one of a round-robin method and a resource-based allocation method on the basis of the load index.

7. The system according to claim 6, wherein the circuitry is configured to divide the input information included in the processing request into a plurality of information units according to a type and a scale of the input information, and to generate partial task information defining partial processing contents for each of the plurality of information units.

8. The system according to claim 1, wherein the circuitry is configured to generate internal instruction information that defines a processing type and an output format on the basis of the prompt sentence, store the internal instruction information in association with the processing request, and include the output format in the final-generation instruction information transmitted to the generative information processing model.

9. The system according to claim 8, wherein the circuitry is configured to generate the final-generation instruction information comprising the prompt sentence, the output format, and the constraint conditions on the basis of both the prompt sentence and the integrated intermediate information, and to cause the generative information processing model to generate the final output information composed of at least one of natural language information and structured information.

10. The system according to claim 1, wherein the circuitry is configured to receive, from the client terminal via the packet-switched network, an additional prompt sentence, and to reuse at least one of the integrated intermediate information and the final output information to perform at least one of regeneration processing and modified generation processing without requiring retransmission of the input information.

11. The system according to claim 1, wherein the circuitry is configured to apply encryption processing and decryption processing to data and results that are distributed and processed among the plurality of nodes, and to authenticate each node and each client terminal on the basis of authentication information to ensure confidentiality and integrity of information on communication paths and in storage regions.

12. The system according to claim 1, wherein the resource state information further comprises a power remaining amount of each node, and the circuitry is configured to calculate the load index on the basis of the computation resource usage, the memory resource usage, the communication quality data, and the power remaining amount.

13. The system according to claim 1, wherein the circuitry is configured to receive, from the client terminal, emotion metadata indicating an emotional state of a user, and to generate a modified prompt sentence for input to the generative information processing model on the basis of the prompt sentence and the emotion metadata.

14. The system according to claim 13, wherein the circuitry is configured to calculate an emotion priority value on the basis of the emotion metadata, and to determine the allocation destination node for each of the plurality of subtasks on the basis of both the resource state information and the emotion priority value so that a subtask having a higher priority is assigned to a node having lower latency.

15. The system according to claim 14, wherein the circuitry is configured to control a structure of the final output information on the basis of the emotion metadata by arranging at least a conclusion part, a reason-explanation part, and a detailed-explanation part in an order and with an information amount that depend on the emotion metadata.

16. The system according to claim 1, wherein the circuitry is configured to treat the integrated intermediate information as pre-processing result information comprising at least one of summary information, detection result information, and feature quantity information, and to execute output generation processing by the generative information processing model using both the final-generation instruction information and the pre-processing result information.

17. The system according to claim 1, wherein the circuitry is configured to cause the plurality of nodes to execute the subtask data by using a lightweight inference engine or a deep learning framework installed in each node, and to collect partial processing results generated by executing computational processing corresponding to the subtask data on local information processing resources of the plurality of nodes.

18. A system comprising:
a communication interface coupled to a packet-switched network;
a processor;
a random access memory; and
a non-volatile storage device storing a processing program, a generative information processing model, and a task allocation program, wherein the processor executes the processing program loaded into the random access memory to:
construct a communication topology in which a plurality of information processing devices function as nodes that are mutually connected via the packet-switched network on the basis of address information and connection information;
receive, from a client terminal via the communication interface, a processing request comprising a prompt sentence, analyze a computational processing structure of the generative information processing model, and generate a task graph representing a plurality of subtasks and dependency relationships among the plurality of subtasks;
collect resource state information from each node via the communication interface, calculate a load index for each node, and dynamically assign the plurality of subtasks to the nodes on the basis of the load index;
receive partial processing result data from the nodes, combine the partial processing result data according to an integration order to generate integrated intermediate information, generate final-generation instruction information on the basis of the prompt sentence and the integrated intermediate information, and receive final output information from the generative information processing model;
apply encryption processing and authentication processing to data transmitted among the plurality of nodes, monitor states of the plurality of nodes, detect a node failure, and reassign subtask data to another node; and
transmit the final output information to the client terminal via the communication interface.

19. The system according to claim 18, wherein the processor is further configured to receive emotion metadata from the client terminal, calculate an emotion priority value on the basis of the emotion metadata, determine allocation destination nodes on the basis of both the resource state information and the emotion priority value, and control a structure of the final output information on the basis of the emotion metadata.

20. A method performed by circuitry of a system, the method comprising:
constructing, via a communication interface coupled to a packet-switched network, a communication topology in which a plurality of information processing devices function as nodes that are mutually connected on the basis of address information and connection information assigned to each node;
receiving, from a client terminal via the packet-switched network, a processing request comprising a prompt sentence for a generative information processing model, analyzing input information included in the processing request, and generating a task graph representing a plurality of subtasks and dependency relationships among the plurality of subtasks;
collecting resource state information from each node via the packet-switched network, calculating a load index for each node on the basis of the resource state information, and determining an allocation destination node for each of the plurality of subtasks on the basis of the load index;
transmitting subtask data to the allocation destination nodes, receiving partial processing result data from the nodes, and combining the partial processing result data according to an integration order to generate integrated intermediate information;
generating final-generation instruction information comprising the prompt sentence and constraint conditions on the basis of the integrated intermediate information, inputting the final-generation instruction information into the generative information processing model, and receiving final output information from the generative information processing model;
applying encryption processing and authentication processing to data transmitted among the plurality of nodes, monitoring states of the plurality of nodes, detecting a node failure, and reassigning subtask data assigned to a failed node to another node; and
transmitting the final output information to the client terminal via the packet-switched network.
